(19) United States
(12) Patent Application Publication
(10) Pub. No.: US 2002/0116691 A1
(43) Pub. Date: Aug. 22, 2002

(54) Semi-physical modeling of HEMT high frequency noise equivalent circuit models

(75) Inventor: Roger S. Tsai, Torrance, CA (US)

Correspondence Address: Patent Counsel, TRW, Inc., Building E2/6051, One Space Park, Redondo Beach, CA, 90278, US

(73) Assignee: TRW, Inc.

(21) Appl. No.: 09/840,529

(22) Filed: Apr. 23, 2001

Related U.S. Application Data
(60) Provisional application No. 60/200,290, filed on Apr. 28, 2000.
(60) Provisional application No. 60/200,307, filed on Apr. 28, 2000.
(60) Provisional application No. 60/200,810, filed on Apr. 28, 2000.
(60) Provisional application No. 60/200,648, filed on Apr. 28, 2000.
(60) Provisional application No. 60/200,622, filed on Apr. 28, 2000.
(60) Provisional application No. 60/200,302, filed on Apr. 28, 2000.

(51) Int. Cl. G06F 17/50

(52) U.S. Cl. 716/4

(57) ABSTRACT

A semi-physical device model that can represent known physical device characteristics as well as measured noise characteristics accurately. The semi-physical device model utilizes analytical expressions to model the fundamental charge of the electric field structure of a HEMT's internal structure. The expressions are based on device physics but are empirical in form. As such, the model is able to maintain physical dependencies with good fidelity while retaining relatively accurate measured-to-model noise characteristics. The semi-physical model also provides model elements for a FET noise equivalent circuit model. In particular, the noise generator model elements are derived from a current/voltage perturbation analysis of the intrinsic charge and electric fields as modeled within the device by the semi-physical HEMT model. The simulated noise model elements represent a relatively accurate physical equipment description of the physical FET. Since the model elements are derived from an intrinsic charge model, the RF performance can be predicted at an arbitrary bias point.

### BACKGROUND OF THE INVENTION

1. Field of the Invention

The present invention relates to a method for modeling semiconductor devices and more particularly to a method for modeling semiconductor devices, such as field effect transistors (FET) and high electron mobility transistors (HEMT) for relatively accurately determining the physical device characteristics and noise characteristics to enable the high frequency performance of the device to be forecasted.

2. Description of the Prior Art

HEMT technology provides unparalleled, high-performance characteristics at high frequencies (microwave to millimeter wave). As such, HEMTs are used in various RF applications. In order to accurately forecast the performance of such devices it is necessary accurately model the effect of the components physical structure on its high frequency noise characteristic. Thus, it is necessary to know how physical changes to the device will effect device performance in order to determine what process changes may be acceptable to improve RF product yield and which may be unacceptable which decrease RF product yield.

Physical changes in such devices are known to occur as a result of various uncontrolled process events, manufacturing equipment changes or intentional process enhancement. Currently three methods for modeling the small signal characteristics of HEMT devices are known: equivalent circuit modeling; physical device simulation; and analytical physical device modeling.

Equivalent circuit modeling utilizes networks of linear electrical elements to model the small signal performance of the device. Such models are known to include linear noise sources for modeling noise generating mechanisms within the device. In the case of HEMT devices, a typical small signal and noise equivalent circuit topology is shown with FIG. 1. This equivalent circuit model is known to accurately model measured S-parameters (small signal characteristics) of HEMT devices up to 120 GHz and noise performance in circuit applications up to 190 GHz.

Unfortunately, there is little correlation between the topology of the equivalent circuit and the physical structure of the device. The rough correlation of each equivalent circuit element to a location and function within a typical HEMT structure is shown in FIG. 2. The noise generating mechanisms of Ign and Idn represent noise generation in the gate and drain respectively. The location of these physical noise generating processes roughly overlap the location of the transconductance Gm current source as shown in FIG. 2. As such, such small signals and noise models serve as crude interpretations of the actual physical operation and structure of a real device and do not provide an adequate basis with which to predict the effect of physical changes on small signal and noise performance.

As mentioned above, the noise characteristics can also be simulated directly from physical device simulators. Such physical device simulators utilize the comprehensive knowledge about material characteristics and basic device physics to simulate the actual physical operation and structure of HEMT devices. Such simulation for noise characteristics are known to be based upon Monte Carlo approaches. Since this method uses the physical structure to simulate performance, the correspondence between simulated noise performance and the devices physical characteristics are relatively strong. However, the ability of the device simulator to accurately model real, measured noise characteristics is relatively inaccurate.

As such, an alternate method is known for modeling real, measured characteristics known as analytical physical device modeling. This method involves the use of analytical expressions that model the basic device physics within a device. This approach uses expressions that are strictly based on the device physics alone. More particularly, in this method, a current/voltage perturbation analysis is applied to the analytically modeled intrinsic charge and current control expressions to derive fundamental noise generating mechanisms. Unfortunately, such purely analytically-based physics expressions are unable to model known critical physical phenomena that occur within a HEMT device such as, quantized energy states within an active channel and non-stationary carrier transport. As a result the ability of such analytical physical device models is relatively worse than other models in accurately modeling measured small signal and noise characteristics.

Other methods are known for modeling the small signal and noise characteristics of a HEMT device. Examples of these methods are disclosed in: The Noise Properties of High Electron Mobility Transistors,” by T. Brookes, IEEE Trans. Electron Devices, Vol. ED-33, No. 1, January 1986 and “A Noise Model for High Electron Mobility Transistors,” by Anwar, et al., IEEE Trans Electron Devices, Vol. 41, No. 11, November 1994. The methodology utilized in these approaches derive representations of noise generating sources following a current/voltage perturbation analysis procedure, for example, as set forth in “Noise Characteristics of Gallium Arsenide Field Effect Transistors,” by H. Statz, et al., IEEE Trans. Electron Devices, Vol. ED-21, No. 9, September 1974 (“the Statz et al reference”); and “Gate Noise and Field Effect Transistors at Moderately High Frequencies,” by A. Van der Ziel, Porc. IEEE, Vol. 51, March 1963.

The first mentioned reference utilizes the noise equivalent circuit model illustrated in FIG. 1 along with analytical physical model for MESFET small signal and noise characteristics. The Statz et al reference builds on the Van der Ziel reference and utilizes an example of current/voltage perturbation analysis used to generate equivalent circuit noise parameters. In particular, the Statz et al reference involves describing the physical origin FET noise as originating from three mechanisms: enhanced Johnson noise; diffusion noise; and electronic response of gate charge to drain charge fluctuations known as “gate breathing”.

Johnson noise manifests itself as current fluctuations in the linear conducting region of a FET's channel, referred herein as Region 1 for simplicity. Region 1 is in the region where Ohm's law still applies, i.e. the electric field is low enough where linear channel mobility still governs carrier transport. The physical location of Region 1 in a HEMT is shown schematically in FIG. 3. The Statz, et al. reference quantifies how current fluctuations in Region 1 appear as amplified voltage fluctuations after traversing through the saturated region of the FET, shown as Region 2 in FIG. 4. This total noise generating mechanism is known as enhanced Johnson noise.

Diffusion noise manifests itself as the spontaneous generation of dipole layers within Region 2. These dipoles layers are generated at a fixed rate and drift from their original point of generation to the boundary of Region 2 closest to the drain contact as generally shown in FIG. 4. To preserve DC continuity, the fluctuating fields and potentials within Region 2 must be nullified by the voltage fluctuations on the drain. As such, electrical noise is generated from the diffusion of these dipoles through Region 2.

“Gate breathing” originates from the fact that the gate is capacitively coupled to the channel for all FET-like devices. Charge fluctuations that occur within the channel consequently induce noise charges on the gate. Because these charges are time dependent, noise displacement currents flow into the gate. The physical origin for gate noise is illustrated in FIG. 3.

As such, there is a need for a relatively accurate method for relating known high frequency physical and noise characteristics of a HEMT device. Specifically accurate methods are needed for producing small signal and noise models that are consistent for: measured to model accuracy; physical properties; periphery scaling and bias dependence.

### SUMMARY OF THE INVENTION

Briefly the present invention relates to a semi-physical device model that can represent known physical device characteristics as well as measured noise characteristics accurately. The semi-physical device model utilizes analytical expressions to model the fundamental charge of the electric field structure of a HEMT's internal structure. The expressions are based on device physics but are empirical in form. As such, the model is able to maintain physical dependencies with good fidelity while retaining relatively accurate measured-to-modeled noise characteristics. The semi-physical model also provides model elements for a FET noise equivalent circuit model. In particular, the noise generator model elements are derived from a current/voltage perturbation analysis of the intrinsic charge and electric fields as modeled within the device by the semi-physical HEMT model. The simulated noise model elements represent a relatively accurate physical equivalent description of noise generating mechanisms within the physical FET. Since the model elements are derived from an intrinsic charge model, the RF performance can be predicted at an arbitrary bias point.

### DESCRIPTION OF THE DRAWINGS

These and other advantages of the present invention will be readily understood with reference to the following specification and attached drawings wherein:

FIG. 1 an exemplary small signal and noise equivalent circuit model for a HEMT device.

FIG. 2 is a cross sectional view illustrating a rough translation of a physical location of each of the equivalent circuit elements in the small signal and noise equivalent circuit model illustrated in FIG. 1.

FIG. 3 is a diagram illustrating the enhanced Johnson noise and gate breathing noise generating mechanisms in a HEMT.

FIG. 4 is a diagram of the diffusion noise generating mechanism in a HEMT.

FIG. 5 is a HEMT device embedded in a microstrip environment to facilitate on wafer testing.

FIG. 6 is a Smith chart which compares the measured vs. modeled S-parameters S11, S12 and S22 up to 50 GHz.

FIG. 7 is a magnitude-angle plot comparing the measured vs. modeled values for the S-parameters S21 up to 50 GHz.

FIG. 8 is a Smith chart comparing the semiphysical and noise equivalent circuit modeled Γopt up to 50 GHz.

FIG. 9 is a frequency response plot comparing the semiphysical and noise equivalent circuit modeled NFmin up to 50 GHz.

FIG. 10 is a comparison of the measured and modeled noise figure using the semiphysical noise model and the noise equivalent circuit model.

FIG. 11 is schematic diagram of an exemplary small signal equivalent circuit model for a HEMT device.

FIG. 12 is an example of a relatively accurate measured-to-model I-V characteristics using the semi-physical modeling method in accordance with the present invention.

FIG. 13 is a elevational view illustrating an epi stack for an exemplary HEMT.

FIG. 14 is a cross-sectional view of a HEMT for the exemplary epi stack illustrated in FIG. 13.

FIG. 15 is a blown up diagram of the cross-sectional parameters pertaining to the T-gate geometry for the exemplary epi stack illustrated in FIG. 13.

FIG. 16 is a diagram of an electric conductance model used in the semi-physical example.

FIG. 17 is a Smith chart illustrating the measured vs modeled S-parameters S11, S12 and S22 simulated in accordance with the method in accordance with the present invention.

FIG. 18 is similar to FIG. 17 and illustrates the measured vs. modeled values for the S21 parameter.

FIG. 19 is similar to FIG. 17 but for the S12 S-parameter.

FIG. 20 represents an exemplary S-parameter microscope in accordance with the present invention.

FIG. 21 illustrates the internal and external regions of an exemplary HEMT device.

FIG. 22 is similar to FIG. 20 but illustrates the approximate locations of the model elements in the HEMT FET device illustrated is FIG. 20.

FIG. 23 is a schematic diagram of a common source FET equivalent circuit model.

FIG. 24 is an illustration of specific application of the S-parameter microscope illustrated in FIG. 20.

FIG. 25 is similar to FIG. 20 which demonstrates the inability of known systems to accurately predict the internal charge and electrical field structure of a semiconductor device.

FIG. 26 is a plan view of a four-fingered, 200 μm GaAs HEMT device.

FIG. 27 is a graphical illustration illustrating the measured drain-to-source current I_{ds} as a function of drain-to-source voltage Vds for the sample FET device illustrated in FIG. 26.

FIG. 28 is a graphical illustration illustrating the drain-to-source current I_{ds} and transconductance Gₘ as a function of the gate-to-source voltage V_{gs} of the sample FET device illustrated in FIG. 26.

FIG. 29 is a Smith chart illustrating the measured S11, S12 and S22 parameters from frequencies of 0.05 to 40.0 GHZ for the FET device illustrated in FIG. 26.

FIG. 30 is a graphical illustration of the magnitude as a function of angle for the S21 S-parameter for frequencies of 0.05 to 40 GHz for the exemplary FET illustrated in FIG. 26.

FIG. 31 is a graphical illustration of a charge control map of the charge and electric field distribution in the on mesa source access region shown with Rₛ as a function bias in accordance with the present invention.

FIG. 32 is a graphical illustration of a charge control map of charge and electric field distribution in the on-mesa drain access region shown with R_{d} as a function of bias in accordance with the present invention.

FIG. 33 is a graphical illustration of a charge control map for the non-quasi static majority carrier transport, shown with Rᵢ as a function of bias in accordance with the present invention.

FIG. 34 is a graphical illustration of a charge control map for gate modulated charge and distribution under the gate, shown with Cgs and Cgt as function of bias in accordance with the present invention.

FIG. 35 is a plan view of an exemplary π-FET with two gate fingers.

FIG. 36 is a plan view of a π-FET with four gate fingers.

FIG. 37 is an illustration of a π-FET parasitic model in accordance with the present invention.

FIG. 38 is an illustration of an off-mesa parasitic model for a π-FET in accordance with the present invention.

FIG. 39 is an illustration of an interconnect and boundary parasitic model in accordance with the present invention for the π-FET with four gate fingers as illustrated in FIG. 36.

FIG. 40 is an illustration of an inter-electrode parasitic model in accordance with the present invention.

FIG. 41 is a schematic diagram of the inter-electrode parasitic model illustrated in FIG. 40.

FIG. 42 is an illustration of an on-mesa parasitic model in accordance with the present invention.

FIG. 43 is a schematic diagram of the on-mesa parasitic model illustrated in FIG. 42.

FIG. 44 is an illustration of an intrinsic model in accordance with the present invention.

FIG. 45 is a schematic diagram of the intrinsic model illustrated in FIG. 44.

FIG. 46A is an exemplary device layout of a π-FET with four gate fingers.

FIG. 46B is an equivalent circuit model for the π-FET illustrated in FIG. 46A.

FIG. 47 is a single finger unit device cell intrinsic model in accordance with the present invention.

FIG. 48 is similar to FIG. 47 and illustrates the first level of embedding in accordance with the present invention.

FIG. 49 is similar to FIG. 48 and illustrates the second level of embedding in accordance with the present invention.

FIG. 50 is an equivalent circuit model of the π-FET illustrated in FIG. 46A in accordance with the present invention.

FIG. 51 is similar to FIG. 49 and illustrates the third level of embedding in accordance with the present invention.

FIG. 52 is similar to FIG. 49 and illustrates the fourth level of embedding in accordance with the present invention.

FIG. 53 is similar to FIG. 49 and illustrates the fifth level of embedding in accordance with the present invention.

FIGS. 54A and 54B is a flow chart of a parameter extraction modeling algorithm that forms a part of the present invention.

FIGS. 55 and 56 represent the error metric in accordance with the present invention.

FIG. 57A is a Smith chart illustrating the measured versus the initial model solutions for the S11, S12 and S22 S-parameters from frequencies from 0.05 to 40.0 GHz.

FIG. 57B is a graphical illustration of angle versus magnitude for the initially modeled S-parameter S21 from frequencies of 0.05 to 40 GHz.

FIG. 58A is a Smith chart illustrating the measured versus simulated S-parameters S11, S12 and S22 for frequencies 0.05 to 40 GHz for the first extraction optimization cycle.

FIG. 58B is a graphical illustration of magnitude as a function of angle for the measure and first optimized model S-21 parameter for frequencies 0.05 to 40 GHz for the first optimization cycle.

FIG. 59A is a Smith chart illustrating the measure as a function of the final model solution for S-parameters S11, S12 and S22 for frequencies 0.05 to 40 GHz for the final solution.

FIG. 59B is a graphical illustrations of the magnitude as a function of an angle for S-parameter S21 for the final model solution from frequency 0.05 to 40 GHz.

FIG. 60 is a graphical illustration of the semi-physically modeled vs measured small signal Gm.

FIG. 61 is a graphical illustration of the semi-physically simulated bias dependence of the small-signal output conductance Rds.

FIG. 62 is a graphical illustration of the semi-physically simulated bias dependence of the small signal gate-source and gate-drain capacitance Cgs and Cgd.

FIG. 63 is a graphical illustration of the semi-physically simulated bias-dependence of the small signal gate source charging resistance Ri.

FIG. 64 is a graphical illustration of the semi-physical bias dependence of the small signal source and drain resistance Rs and Rd.

FIG. 65 is a graphical illustration of the measured vs modeled bias dependent gain at 23.5 Ghz for a K-band MMIC amplifier.

FIGS. 66A and 66B are graphical illustrations of the extracted parameters from measured device I-V's for process control monitor testing.

FIG. 67 is a graphical illustration of the measured vs semi-physically simulated process variation for Gmpk and Vgspk.

FIG. 68 is a graphical illustration of the measured vs semi-physically simulated process variation for Idpk and Gmpk.

FIG. 69 is a graphical illustration of the measured vs semi-physically simulated process variation for Imax and Vpo.

FIG. 70 is a graphical illustration of the measured/extracted vs semi-physically simulated process variation for the small signal equivalent model Rds and Gm.

FIG. 71 is a graphical illustration of the measured/extracted vs semi-physically simulated process variation for the small signal equivalent model Cgs and Gm.

FIG. 72 is a graphical illustration of the measured vs semi-physically simulated physical dependence for Imax as a function of physical gate length.

FIG. 73 is a graphical illustration of the measured/extracted model vs semi-physically simulated physical dependence for Rds as a function of physical recess undercut width.

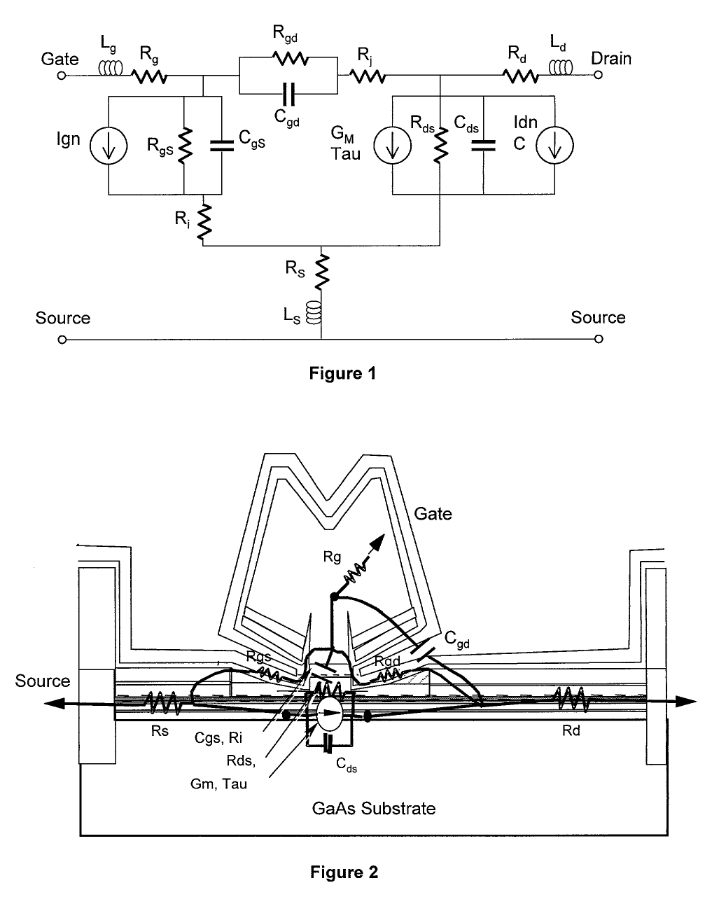

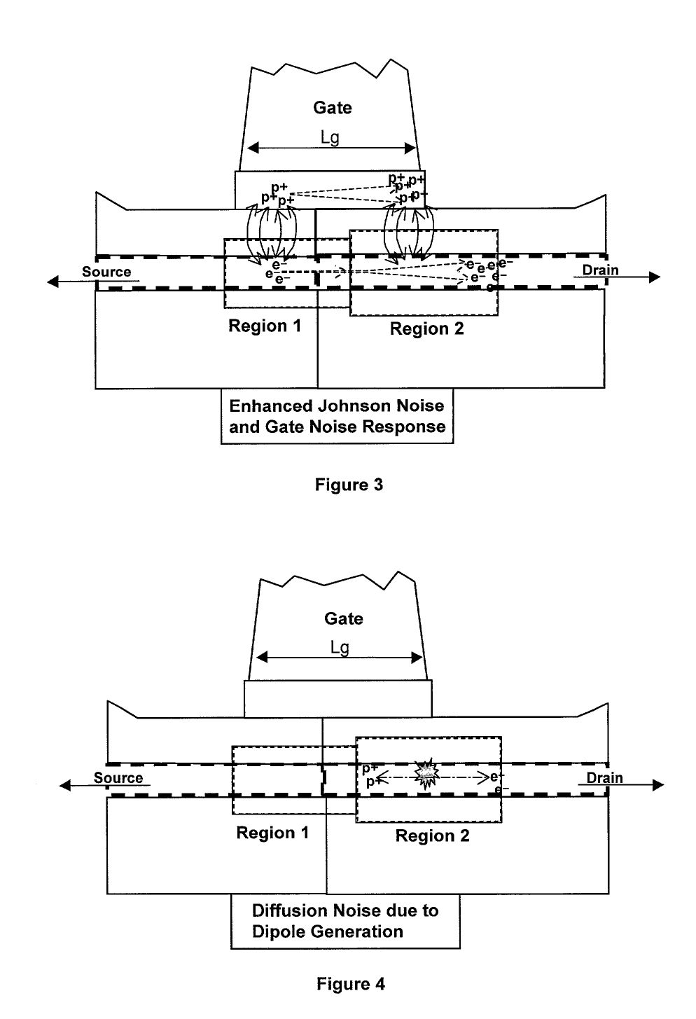

### DETAILED DESCRIPTION

The present invention relates to a semi-physical device model that represents both the physical device characteristics and measured noise characteristics, which can be used to simulate RF performance through physically-based device models. The semi-physical model is an analytical model based upon empirical expressions that model the physics of HEMT operation, hence the terminology “semi-physical”. The model incorporates real process parameters, such as gate length recess etch depth, recess undercut dimensions, passivation nitrite thickness, and the like. By using empirical expressions, the semi-physical model is able to maintain relatively good measured to model accuracy while accounting for the effects of process variations on the device performance.

In accordance with the present invention, the semi-physical model provides model elements for the standard small signal and noise equivalent and circuit model for FET, as generally shown in FIG. 1. The model elements are derived either through small signal excitation analysis or voltage/current perturbation analysis.

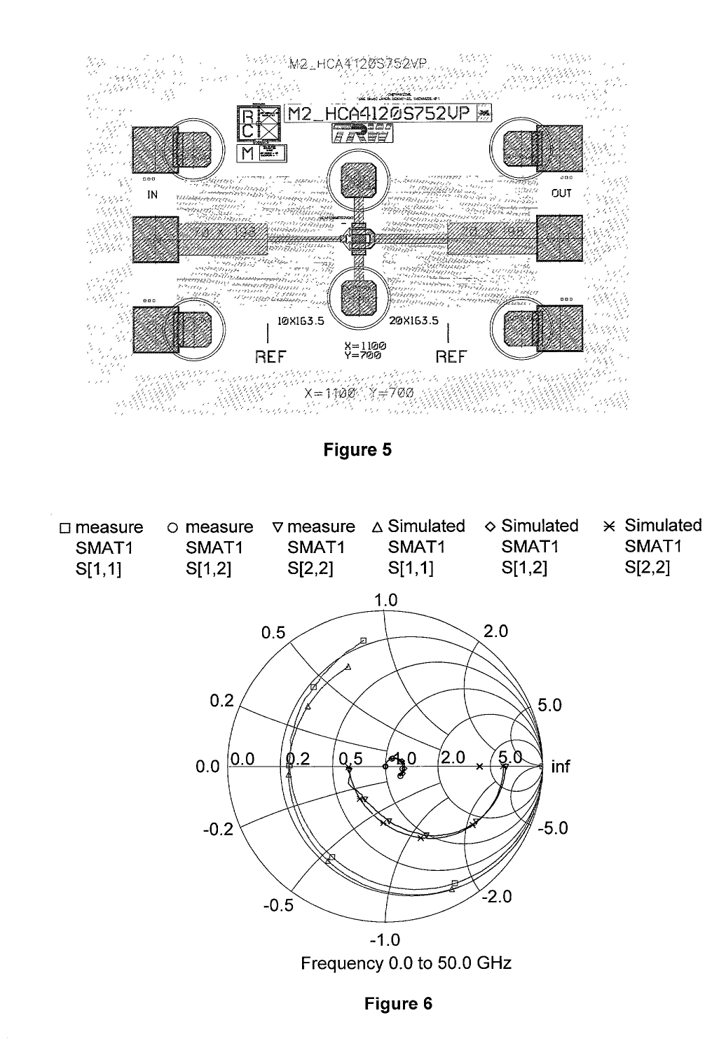

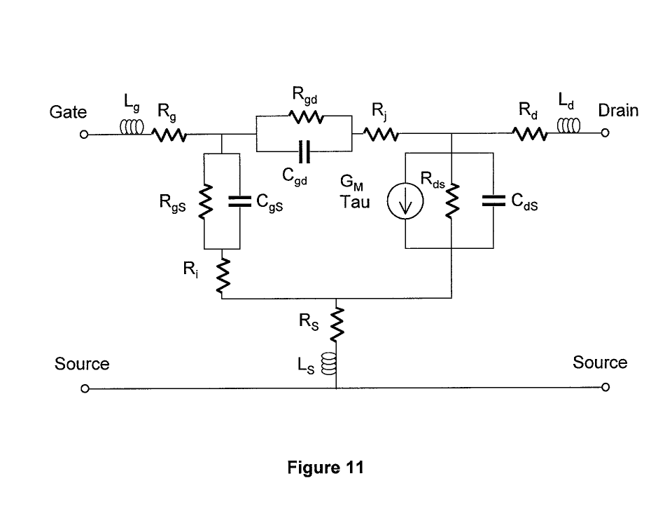

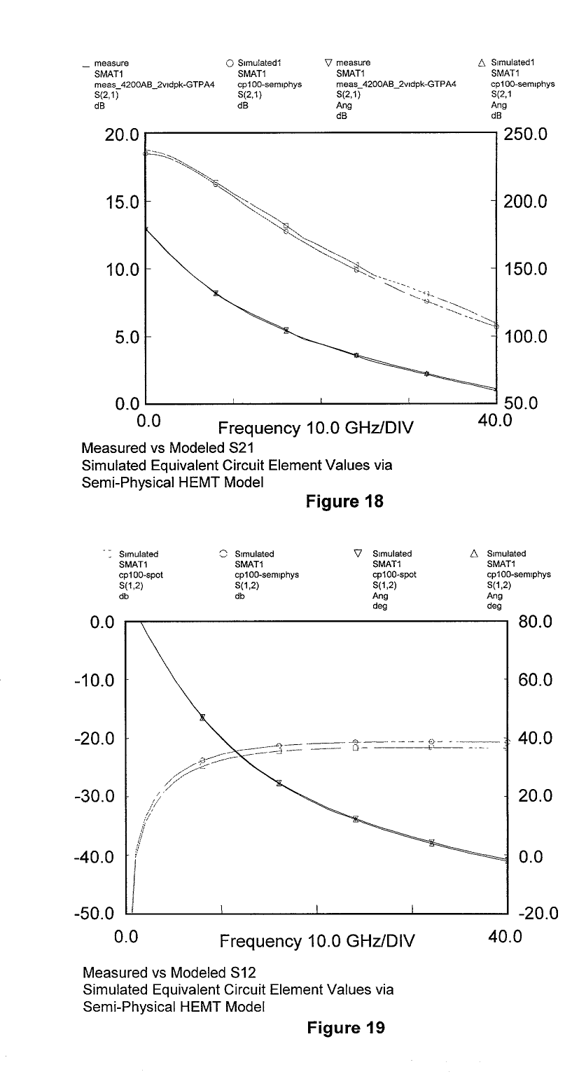

Model elements that pertain to the small signal model (everything except Ign, Idn and C) are derived from a small signal excitation analysis of intrinsic charge and electric fields. The method for implementing the semi-physical model is illustrated in 20-59 small signal excitation analysis is described below and illustrated in FIGS. 11-19. The model elements that pertain to the noise model (Ign, Idn and C) are derived from a current/voltage perturbation analysis following similar steps as set forth in the Statz, et al. reference discussed above. The noise model elements are discussed in connection with FIGS. 5-10.

### SEMI-PHYSICAL MODELING FOR PHYSICAL NOISE MODELING

The general methodology is set forth in the Statz, et al. reference discussed above for current/voltage perturbation analysis to generate analytical physical expressions for the noise model elements as set forth below:

The following equations relate to the current/voltage perturbation analysis:

| Total Drain Noise Equivalent Conductance | Gdn | [S] | | = g_{dn} + W_{g}/[ R_{DREC} G_{daccdiv}] | |
|---|---|---|---|---|---|
| Total Gate Noise Equivalent Conductance | Ggn | [KS/GHz²] | | = G_{gn}′/f² | |
| Sum Gate Noise Equivalent Conductance | Ggn′ | [kS] | | = g_{gn}f² + G_{gn0}W_{g} | |
| Drain Noise Equivalent Conductance | gdn | [S] | | = \|i²_{d}\| / (4k_{B}T_{amb}) | |
| Gate Noise Equivalent Conductance | ggn | [KS/GHz²] | | = \|i²_{g}\| / (4k_{B}T_{amb} f²) | |
| RMS Drain Noise Current | \|i²_{d}\| | [pA²/Hz] | | = \|i²_{d1}\| + \|i²_{d2}\| | |
| RMS Gate Noise Current | \|i²_{g}\| | [pA²/Hz] | | = \|i²_{g1}\| | |
| RMS Region \| Drain Noise Current | \|i²_{d1}\| | [pA²/Hz] | | = \|v²_{d1}\| g_{chn}² | |
| RMS Region ∥ Drain Noise Current | \|i²_{d2}\| | [pA²/Hz] | | = \|v²_{d2}\| r_{d}² | |
| | | | | = 4 k_{B}TₑV_{LL} exp [ 2In(Nₛ′/Nₚ′) + | |
| | | | | In(\|(Nₛ′² + Nₘₐₓ²)/(Nₚ′² + Nₘₐₓ²)\|) ] * cosh[πX_{SAT}/(2a)]² / | |
| RMS Region \| Drain Noise Voltage | \|V²_{d1}\| | [pV²/Hz] | | \|_{ds} | |
| | | | | = 32q²Nₚa³D sin²[πb/(2a)] { exp(πX_{SAT}/a) − | |
| | | | | 4exp(πX_{SAT}/a) + 3 + πX_{SAT}/a} / | |
| RMS Region ∥ Drain Noise Voltage | \|V²_{d2}\| | [pV²/Hz] | | { D_{div}b ²π⁵Vₛ²_{ξchan}²W_{g}} | |
| RMS Gate Noise Current 1 | \|i²_{g1}\| | [pA²/Hz] | | = dW₁ { q_{ω}dQₛₐₜM_{N}L₁W_{g}N_{ggn} / V_{LL}}² | |
| Intrinsic Region \|Linear Noise Conductance | g_{chin} | [S] | | = (q Nₚ μₐᵥₑ Wg) / L₁*G_{chdiv} | |
| | | | | = 1 / { [g_{chi} + 2g_{chiλ}V_{ds}]/[ 1 + (V_{ds}/Vₛₐₜₑ)^{m}]^{1/m} − | |
| | | | | V_{ds}^{(m - 1)}/(Vₛₐₜₛ^{m}) * (g_{chi}V_{ds} + g_{chi}V_{dsλ}²) / | |
| Intrinsic Region ∥ Saturated Output Resistance | r_{d} | [Ω] | | [1 + (V_{ds}/Vₛₐₜₑ)^{m}]^{(1/m + 1)}} | |
| Effective Electron Temperature | Tₑ | [° C.] | | = T_{amb} + 10 In {[1 + 0.0001*(F_{CHSAT}/F_{S})²]} | |
| | | | | = _{δ}V_{L} * { 1 + (V_{LX} − V_{SAcc})/(2_{δ}V_{L}) + | |
| Intrinsic Voltage across the Region \| | V_{LL} | [V] | | sqrt [ _{δ}² + ((V_{LX} − V_{SAcc})/(2_{δ}V_{L}) − 1)² ] } | |
| Ideal Sheet Charge @ end of Region \| | Np′ | [cm⁻²] | | = 2 Nₒ In [1 + exp((V_{gt} − V_{LX})/ (η Vₜₕ))] | |
| | a | [A] | | = d_{iB} + _{Δ}dᵢ | |
| | b | [m] | | = H_{chan} | |
| Sheet Charge @ end of Region \| | Np | [cm⁻²] | = | Nₚ′ / | [1 + (Nₚ′/Nₘₐₓ)^{γ})]^{1/γ} |

| | | | |
|---|---|---|---|
| Dielectric Permitivity of the Channel Layer | _{ξ}_{_{chan}} | [F/m] | |
| Dipole Generation Rate Division Factor | D_{div} | [ ] | |
| Saturation Region Electric Field | F_{CHSAT} | [V/_{μ}m] | = V_{CHSAT} / X_{SAT} { 1 − tanh [100*(Vₛₐₜₑ − V_{ds})] } |
| | | | = Vₜₕ * { 1 + (V_{ds} − V_{DSAT} − V_{DAcc} − V_{SAcc} − V_{LX})/(2Vₜₕ) + |
| | | | sqrt [_{δ}² + ((V_{ds} + V_{DSAT} − V_{DAcc} − V_{SAcc} − |
| | | | V_{LX})/(2Vₜₕ) − 1)²] } * |
| Channel Voltage drop over Saturation Region | V_{CHSAT} | [V] | { 1 − tanh [100*(Vₛₐₜₑ − V_{ds})] }/2 |
| Channel Voltage @ Saturation point | V_{LX} | [V] | = Fₛ * Xₛ |
| | | | = { L₁ sqrt( \|i²_{d1}\|/Aₛₐₜ² )(1/2 − I_{gΓ}) / |
| | dW₁ | [pV²/Hz] | [q_{μave}Nₛ(2 − N^{γ}/GAMMA) ] }² |
| Induced “Breathing” Charge | dQₛₐₜ | [(cm⁻²)] | = _{Δ}i_{d1}L₂/ (vₛqW_{g}L₂) |
| | | | = 1 + (GAMMA^{1/}^{_{γ}}− 1) / |
| | M_{N} | [ ] | {(dᵢ + _{Δ}dᵢ)M_{shKpar} V _{gte} / [ dᵢ + _{Δ}dᵢ − d_{iT}/TCF ]} |
| | Aₛₐₜ | [ ] | = cosh [πX_{SAT})/(2a)] |
| | | | = q_{μave}NₛW_{g} / { P_{ggn}L₁V_{ds}(2 − N^{γ}/GAMMA) * |
| | | | exp[In(Nₛ′/Nₚ′) + In\|(Nₘₐₓ² + Nₛ′²)/(Nₘₐₓ² + Nₚ′²)\|/2 * |
| | Ig_{Γ} | [ ] | cosh(^{π}L₂/a) } |
| | GAMMA | [ ] | = (1 + N^{γ)} |
| | N | [ ] | = N₃′/Nₘₐₓ |
| | _{Δ}i_{d1} | [pA/sqrt(Hz)] | = sqrt( \|i²_{d1}\| Aₛₐₜ² ) |
| Gate Noise Perturbation Polarity | P_{ggn} | [ ] | |

1) Apply current/voltage perturbation analysis to the analytically modeled intrinsic charge and conduction in the linear conducting region of the FET's channel (Region 1):

a) Apply current perturbation analysis to the current-control expression for drain current in Region 1.

b) Find a relationship governing the magnitude of potential fluctuation as a function of position within Region 1, and magnitude of the current perturbation.

c) Apply constraint forcing expression above to be consistent with voltage fluctuation boundary conditions at the boundary of Region 1 and the saturated electron transport region of the FET's channel (Region 2).

d) Solve for final voltage fluctuation expression at the end of Region 1.

e) From 1d find the final RMS expression for noise voltage generation seen at the drain terminal, after amplification factors of Region 2 are applied to 1d.

2) Apply current/voltage perturbation analysis to derive the noise voltage generated at the drain due to dipole generation within the saturated region (Region 2):

a) Find an expression for the potential and field of a dipole layer at any point Region 2.

b) Match potential and field boundary conditions at the beginning of Region 2 to yield a more exact expression for potential perturbation as a function of position in Region 2.

c) Incorporate non-quasistactic nature of the dipole drift by substituting in saturated drift velocity with time-dependence of the induced potential perturbation.

d) Calculate the spectral density of the induced noise voltage by taking the Fourier transform of the expression in 1c.

e) From 1d find the final RMS expression for noise voltage generation seen at the drain terminal, after multiplying by two (for positive and negative current induced by the dipole) and integrating over Region2.

3) Apply current/voltage perturbation analysis to derive the noise current generated on the gate due to capacitive coupling with the channel (Regions 1 and 2):

a) Find an expression for induced charge in Region 1 from 1b above.

b) Add to 3a, the induced non-quasistatic charge in Region 2, which is equal to the magnitude of the total drain current fluctuation multipled by Region 2's length divided by saturated velocity.

c) Take the mean square of the charge fluctuation given in 3b

d) Find total mean square on the gate by integrating 3c over Region 1 and Region 2.

e) Find total gate noise current by multiplying 3d by ω², where ω=2πf and f is frequency.

4) Calculate correlation coefficient, C.

a) Multiply 3b with the conjugate of 1b expressed for current perturbation, to obtain Δq*i_{d}.

b) Multiply 4a by ω to obtain i_{g}*i_{d}.

c) Find time average of 4b

d) Find correlation coefficient per standard definition, applying 4c, 3e and sum of 1e and 2e in noise current form.

In accordance with the present invention, the derivation of the semi-physical model for equivalent noise sources is similar to the methodology as set forth in the Statz, et al. reference with the following differences. First, in the previous analytical models, all analysis solutions are determined by solving analytical equations based solely on the device physics whereas the method in accordance with the present invention semi-physical expressions are used. The semi-physical expressions not only model the known physics of device operation but also contain a degree of freedom in the form of empirical expressions and terms. This freedom allows the semi-physical method to compensate for unknown or over-simplified physical expressions in order to achieve relatively accurate measured-to-model fitting characteristics. As such, the application of the known analytical noise models to a new method of expression provides relatively accurate noise modeling that is physically significant. More specifically, the inaccuracies in known noise models is due to the fact that the analytical expressions for the device physics within the FET do not capture all of the physics that actually occur. As a result, the calculated current control and charge boundaries (i.e. between Regions 1 and 2) are not accurately modeled, thus leading to further inaccuracies in the calculated noise performance since the semi-physical approach in accordance with the present invention is not based solely on the device physics, the semi-physical model in accordance with the present invention is able to compensate for such inaccuracies. More specifically, the semi-physical model utilizes empirical terms to correct the prediction of the physical part in order to achieve better agreement with actual measured data. In this way, a relatively more accurate quantitative description of the intrinsic device operation is obtained thus providing relatively more accurate noise modeling results. By applying the methodology of the Statz, et al. reference to the semi-physically modeled intrinsic charge conduction and charge boundaries, the semi-physical expressions for noise generating mechanisms in accordance with the present invention are suitable for use in the noise equivalent circuit illustrated in FIG. 1.

In addition, a semi-physical model for the intrinsic FET and a small signal performance is performed as set forth below. However, in addition to the charge boundary terms set forth in the semi-physical model and small signal excitation analysis outlined below additional boundary term must be generate for use in the noise model derivation set forth in the Statz, et al. reference as follows:

| | | | |
|---|---|---|---|
| | | | = _{δ}X { 1 + [L_{geff} − _{Δ}Lₛ − Xₛ − L_{g} + X_{satREF}]/(2 _{δ}X) |
| | | | + sqrt (_{δ}² + ([L_{geff} − _{Δ}Lₛ − Xₛ − L_{g} + X_{satREF}]/(2 _{δ}X) − 1)² |
| Length of the Saturated Region, Region 2, under the Gate | X_{SAT} | [_{μ}m] | } |
| Length of the Linear Region, Region 1 | L₁ | [_{μ}m] | = L_{geff} − X_{SAT} |
| | | | = _{δ}X { 1 + [L_{gs} − L₁]/(2 _{δ}X) |
| Total Length of the Saturated Region, Region 2 | L₂ | [_{μ}m] | + sqrt ( _{δ}² + ([L_{gs} − L₁]/(2 _{δ}X) − 1)² } |
| Initial Starting length of Saturated Region | X_{satREF} | [_{μ}m] | |
| Effective Debye Length | _{δ}X | [_{μ}m] | |

Subsequently, the current/voltage perturbation analysis outlined above is performed on the appropriate semi-physical model expressions to obtain semi-physical expressions for the noise generating mechanisms. When this method is applied to the semi-physical device model as discussed below accurate noise equivalent circuit models are generated.

As an example, a four fingered 120 μm total gate periphery device was measured for S-parameters from 0 to 50 GHz and noise parameters from 26-40 GHz. The device cell was laid out as a typical PiFET layout. In addition, the device cell was embedded into a microstrip to facilitate on-wafer testing of the device, as generally illustrated in FIG. 5.

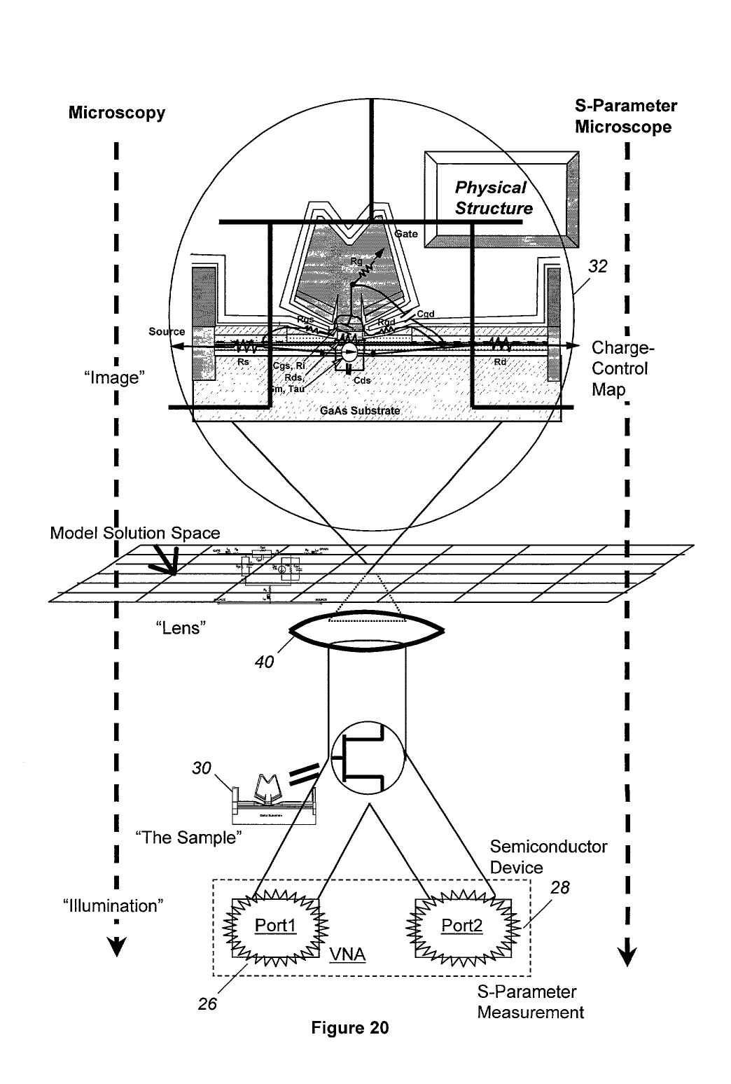

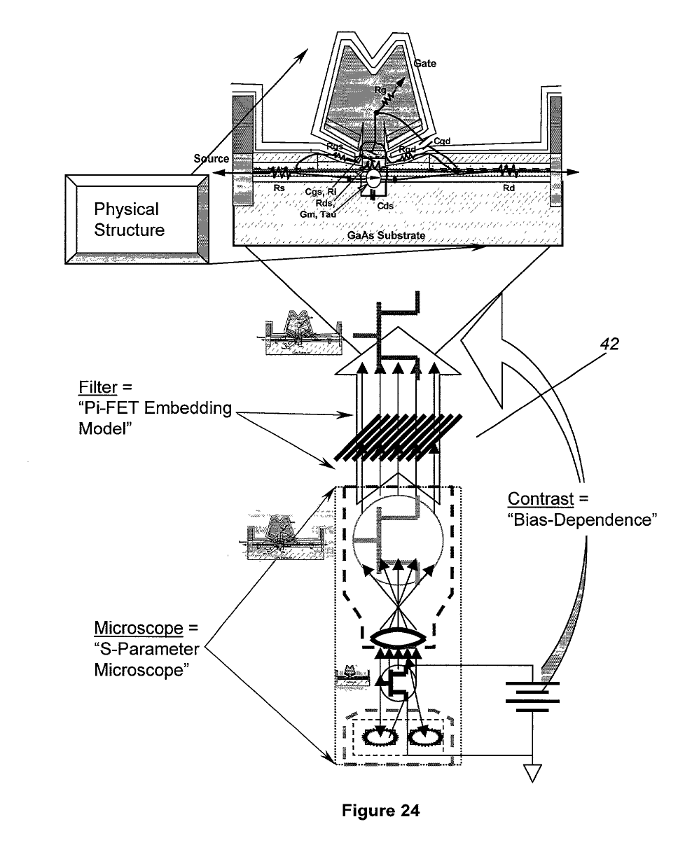

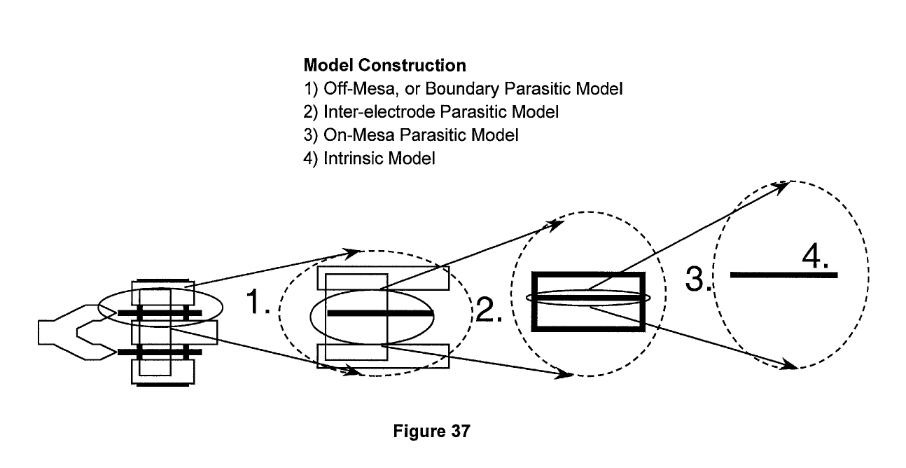

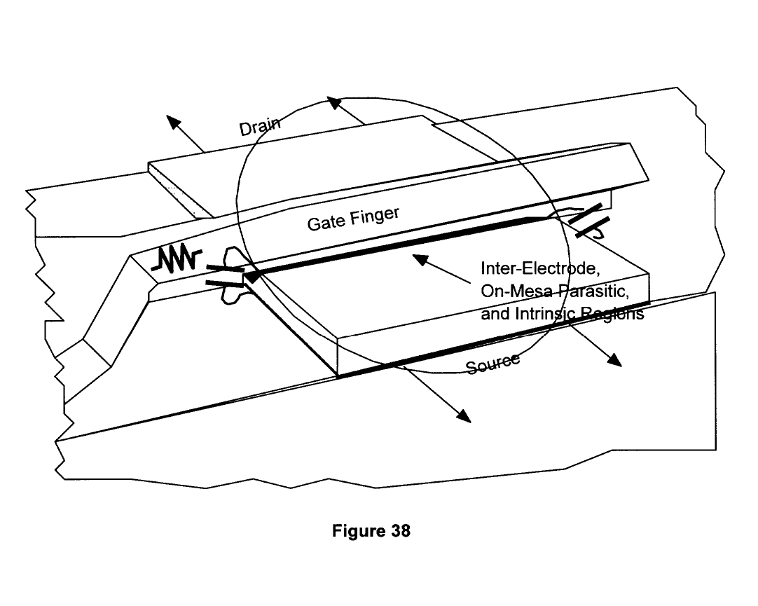

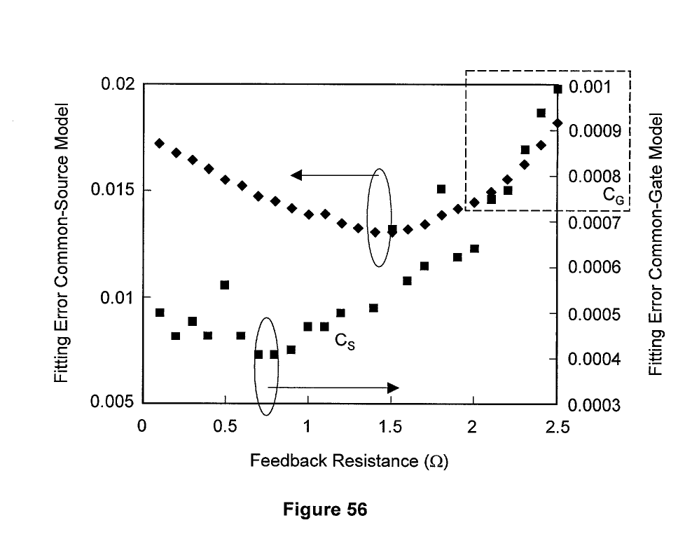

Applying the semi-physical modeling method, a relatively accurate model for the intrinsic FET is derived. By utilizing the parasitic embedding model for PiFET's discussed below and illustrated in FIGS. 20-59, a full small signal equivalent circuit model for the four fingered HCA HEMT is reconstructed from one fingered, intrinsic model of the unit device cell is generated with the semi-physical small signal modeling approach. Subsequently, noise equivalent circuit models for the one fingered intrinsic model were derived. Final small signal noise equivalent circuit parameters that were derived are identified in Table 1 which lists the values for each parameter.

TABLE 1
Semi-physically Modeled Small-signal and Noise Equivalent
Circuit Model Terms for the Sample Device

| Equivalent | | |
|---|---|---|
| Circuit | | |
| Element | Units | Value |
| Rg | [Ω] | 1.044 |
| Rs | [Ω] | 2.142 |
| Rd | [Ω] | 5.669 |
| Rdn | [Ω] | 1.359 |
| Lg | [nH] | 0.018 |
| Ls | [nH] | 0 |
| Ld | [nH] | 0.012 |
| Rgs | [Ω] | 5.56E + 10 |
| Rgd | [Ω] | 5.56E + 10 |
| Cgs | [pF] | 0.112 |
| Cdg | [pF] | 0.014 |
| Cds | [pF] | 0.018 |
| Rds | [Ω] | 301.644 |
| Gm | [mS] | 63.192 |
| Tau | [pS] | 0.330 |
| Ri | [Ω] | 4.341 |
| Rj | [Ω] | 3.974 |
| gdn | [S] | 0.072 |
| ggn | [kS/GHz] | 3.777E − 03 |
| C | [ ] | 7.497E − 01 |

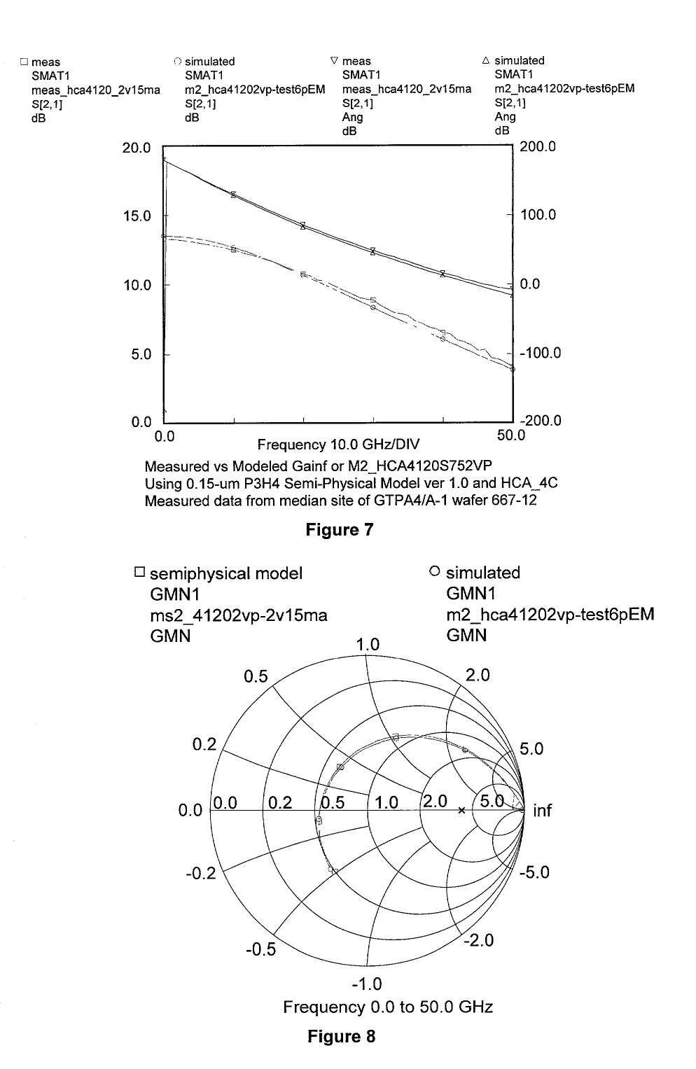

The resulting semi-physical modeling equivalent circuit yields relatively accurate measured-to-model results for both small signal and noise performance of the measured device. For example, FIGS. 6 and 7 show the measured-to-model comparisons for measured small signal S-parameters. In particular, FIG. 6 illustrates a Smith chart comparing three of the four S-parameters is terms of measured-to-model characteristics. FIG. 8 illustrates the final parameter in terms of magnitude and angle. In all cases, the equivalent circuit model derived through the semi-physical model methods provides relatively accurate results.

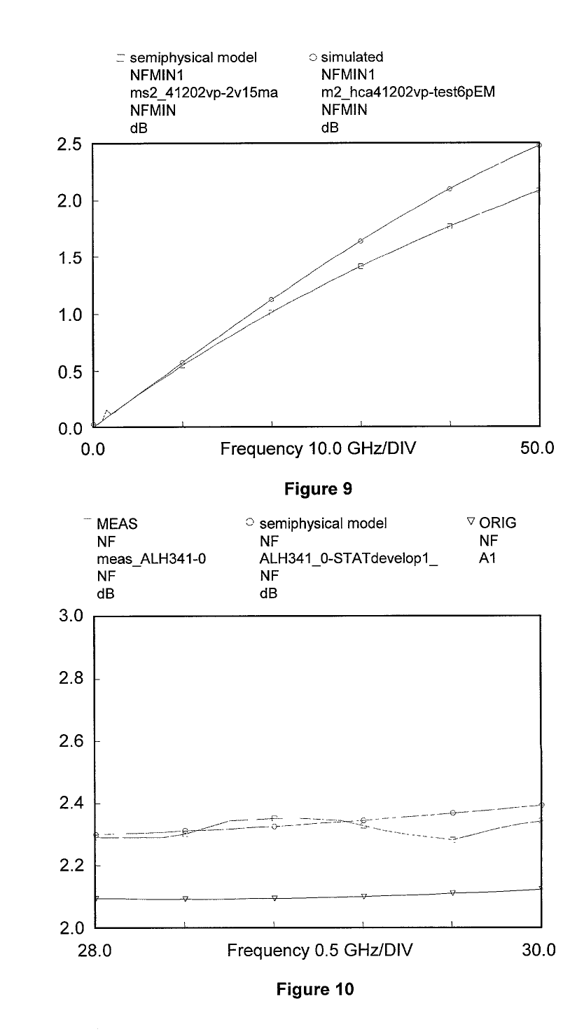

FIGS. 8 and 9 illustrate comparisons for the noise parameters as modeled using the semi-physical approach and also a known small signal noise equivalent circuit presently used for the design of low noise circuits. A comparison is derived directly from a measured set of noise parameter data. In particular, FIG. 8 illustrates a Smith chart comparing the optimum noise matching impedance Γopt. FIG. 9 illustrates the minimum noise figure, NFmin in terms of a frequency response plot. In the case of Γopt, the simulated results of the semi-physically modeled noise equivalent circuit model almost exactly matches that of the previous noise equivalent noise circuit model.

In the case of NFmin, the differences are relatively significant, however, the semi-physically modeled results are relatively more accurate as demonstrated in FIG. 10 which illustrates the measured-to-model noise figure for a K-band MMIC (microwave monolithic integration circuit) low noise amplifier illustrated in FIG. 10. As expected, the previous noise model predicts a much lower noise figure than it actually measured because it models NFmin as being lower.

### SEMI-PHYSICAL MODEL

The semi-physical model provides model elements for the standard small signal equivalent circuit model or FET as illustrated in FIG. 11. However, unlike conventional methods, the model elements are derived from small signal excitation analysis of the intrinsic charge and electric fields within the device. As such, the simulated small signal model elements represent a relatively accurate physical equivalent circuit description of a physical FET.

The general methodology for the semi-physical modeling of intrinsic charge, electrical conductance and electrical field is as set forth below. First, the relationships between the conduction band offsets, electrical permitivities and material composition for the various materials in the epi stack are determined. These relationships can be performed analytically or by fitting simulated data from physical simulators. Subsequently, the basic electron transport characteristics in any of the applicable bulk materials in the epi stack are determined. Once the electron transport characteristics are determined, the undeleted linear channel mobility is determined either through material characterization or physical simulation. Subsequently, the Schottky barrier height value or expressions are determined. Once the Schottky barrier height value is determined, the semi-physical equations are constructed modeling the following characteristics:

Fundamental-charge control physics for a sheet charge in the active channel as controlled by the gate terminal voltage.

Average centroid partitioning of the sheet charge within the active channel width.

Position of charge positioning boundaries as a function of gate, drain and source terminal voltages.

Bias dependence of linear channel mobility and surface depleted region.

Bias dependence of the velocity saturating electric field in the channel.

Saturated electron velocity.

Electrical conductance with the linear region of the channel under the gate.

Electrical conductance within the source and drain access regions.

Once the semi-physical equations are determined, the empirical terms of the semi-physical modeling equations are adjusted to fit the model I-V (current/voltage) characteristics against measured values. Subsequently, the empirical terms are interactively adjusted to achieve a simultaneous fit of measured C-V (capacitance-voltage) and IV characteristics. Lastly, the empirical modeling terms are fixed for future use.

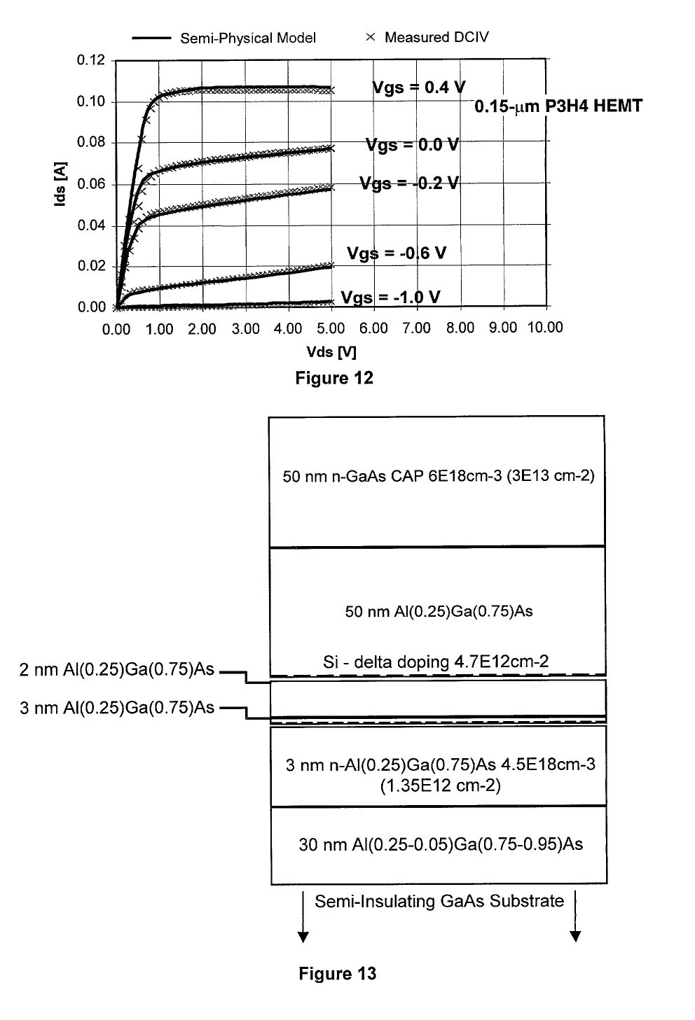

By constructing a comprehensive set of semi-physical equations that cover all of the physical phenomenon as mentioned above, the physical operating mechanisms within a HEMT device can be relatively accurately determined. FIG. 12 illustrates a set of relatively accurate measured-to-modeled I-V characteristics for a HEMT using the semi-physical modeling discussed herein. In particular, FIG. 12 illustrates the drain-to-source current I_{ds} as a function of the drain-to-source voltage V_{ds} for various gate biases, for example, from 0.4V to −1.0V. As shown in FIG. 12, solid lines are used to represent the semi-physical model while the Xs are used to represent measured values. As shown in FIG. 12, a close relationship exists between the measured values and the modeled parameters.

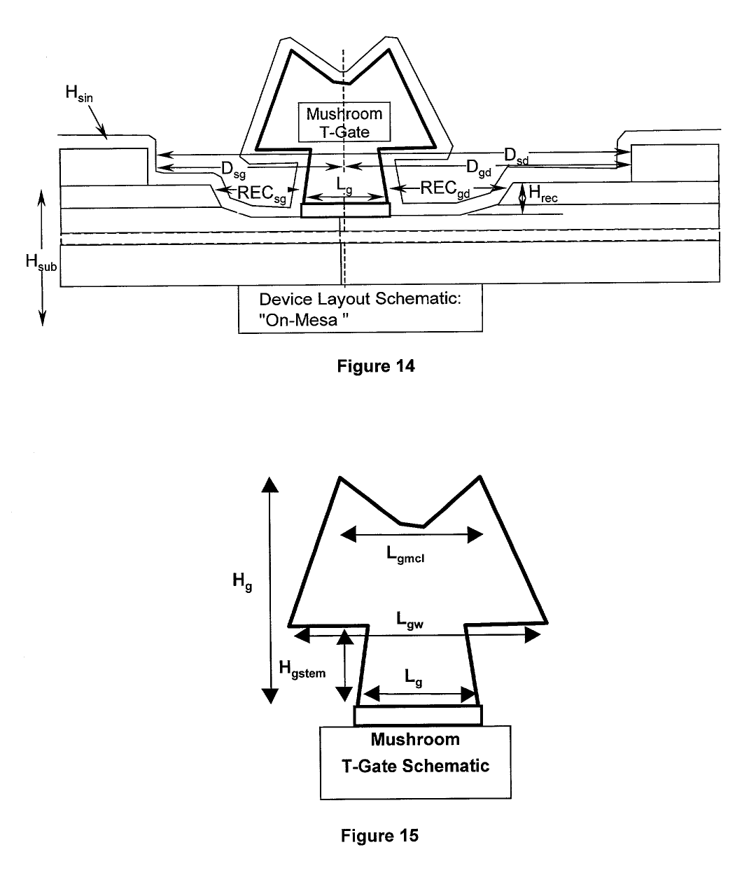

An example of semi-physical modeling for physical device operation in accordance with the present invention is provided below. The example utilizes an exemplary device as illustrated in FIGS. 13 and 14. Table 2 represents exemplary values for the physical cross-section dimension parameters in the model. FIG. 15 relates to a blown up T-gate characteristic which is correlated to the parameters identified in Table 2.

TABLE 2
Values for the Physical Parameters Input
into Device Cross Section

| Layout Parameter | | Units | Value |
|---|---|---|---|
| Gate Length | Lg | [μₘ] | 0.150 |
| Wing Length | Lgw | [μₘ] | 0.520 |
| Gate Mushroom Crown Length | Lgmcl | [μₘ] | 0.200 |
| Total Gate Height | Hg | [μₘ] | 0.650 |
| Gate Stem Height | Hgstem | [μₘ] | 0.300 |
| Gate Sag Height | Hgsag | [μₘ] | 0.100 |
| Gate Cross-Sectional Area | GateArea | [μₘ²] | 0.187 |
| Max Cross-Sectional Area | MaxArea | [μₘ²] | 0.364 |
| Total Gate Periph | Wg | [μₘ] | 200.000 |
| # Fingers | N | [ ] | 4.000 |
| Source-Drain Spacing | Dsd | [μₘ] | 1.800 |
| Gate-Source Spacing | Dsg | [μₘ] | 0.700 |
| Gate-Drain Spacing | Dgd | [μₘ] | 1.100 |
| Gate-Source Recess | RECsg | [μₘ] | 0.160 |
| Gate-Drain Recess | RECgd | [μₘ] | 0.240 |
| Recess Etch Depth | Hrec | [A] | 780.000 |
| SiN Thickness | Hsin | [A] | 750.000 |
| Gatefeed-Mesa Spacing | Dgfm | [μₘ] | 2.000 |
| Gateend-Mesa Overlap | Dgem | [μₘ] | 2.000 |
| Finger-Finger Spacing Thru Drain | Dffd | [μₘ] | 16.500 |
| Finger-Finger Spacing Thru Source | Dffs | [μₘ] | 13.500 |
| Source Airbridge Inset? | AB? | [ ] | P |
| Source Airbridge inset | Dsabin | [μₘ] | 28.000 |
| Source Airbridge Height | Hsab | [μₘ] | 3.500 |
| Source-Gate Airbridge Clearance | Hgsab | [μₘ] | 1.640 |
| Source Pad Width | Ws | [μₘ] | 12.000 |
| Drain Pad Width | Wd | [μₘ] | 14.000 |
| Substrate Thickness | Hsub | [μₘ] | 100.000 |

As mentioned above, the semi-physical modeling of the intrinsic charge and electric field within the HEMT device is initiated by determining the relationships between the conduction band offset, electrical permitivities and material composition for the various materials in the epi stack. Material composition related band offset and electrical permitivity relationships may be obtained from various references, such as “Physics of Semiconductor Devices,” by Michael Shur, Prentice Hall, Englewood Cliffs, N.J. 1990. The basic electron transport characteristics, for example, for the linear mobility of electron carriers in the bulk GaAs cap layer may be determined to be 1350 cm²/Vs, available from “Physics of Semiconductor Devices”, supra. The linear mobility of electron carriers in the undeleted channels is assumed to be 5500 cm²/Vs. This value may be measured by Hall effect samples which have epi stacks grown identically to the stack in the example, except for some differences in the GaAs cap layer. The Schottky barrier height is assumed to be 1.051 volts, which is typical of platinum metal on a AlGaAs material.

The following equations represent the semi-physical analytical expressions to model the charge control and centroid position in the sample.

| | | | |
|---|---|---|---|
| | | | = Nₛ′ / |
| Empirical Charge Control Expression | Nₛ | [cm⁻²] | [1 = (Nₛ′/Nₘₐₓ)^{γ})]^{1/γ} |
| Ideal Charge Control with Filling Law | Nₛ′ | [cm⁻²] | = 2 Nₒ In [1 + exp(V_{gt} / (η Vₜₕ))] |
| Ideal Charge Control | Nₒ | [cm⁻²] | = _{ξi} η Vₜₕ / [2 q (dᵢ + Δdᵢ) 10000] |
| | | | = (Nₘₐₓ₀ + N_{maxL} V_{ds}^{nnmax} |
| Maximum Channel Charge | Nₘₐₓ | [cm⁻²] | H_{chan} / H_{chanREF}) |
| Initial Gate-Channel Voltage | V_{gt} | [V] | = V_{gs} − Φ_{b} − ΔE_{C} − V_{TO} − σV_{ds} |
| Threshold Voltage | V_{TO} | [V] | = Φ_{b} − ΔE_{C} − V_{T} |
| Doping Threshold Voltage | V_{T} | [V] | = q N_{sdelta} d_{δ} 10000 / _{ξi} |
| | | | = {(H_{space} + H_{bar} + H_{fdope} + H_{cap}) − H_{rec}} / |
| Gate-to-Channel Spacing | dᵢ | [m] | (10¹⁰) |

note that the expression for di can be changed for different epi-stacks

| | | | |
|---|---|---|---|
| | | | = H_{chan} [ 1 − d_{iK}*V_{gts}/H_{chanREF} − |
| Movement of Sheet Carrier Centroid | _{Δ}dᵢ | [m] | d_{iL} * V_{ds}/H_{chanREF}] |
| Empirical Charge Control Shaping Parameter | γ | [ ] | |
| Semi-Physical Subthreshold Populating Rate | η | [ ] | |
| Dielectric Permitivity of the Barrier Layer | _{ξ}_{ᵢ} | [F/m] | |
| The thermal voltage | Vₜₕ | [V] | = K_{B}T_{amb} / q |
| Ambient Temperature | T_{amb} | [K] | |
| Fixed Emprical Maximum Sheet Charge | Nₘₐₓ₀ | [cm⁻²] | |
| Vds Dependent Emprical Maximum Sheet Charge | N_{maxL} | [cm⁻²] | |
| Vds Dependent Emprical Nmax shaping term | n_{Nmax} | [ ] | |
| Channel Layer Thickness | H_{chan} | [A] | |
| Reference Channel Layer Thickness | H_{chanREF} | [A] | |

(Channel Thickness for the sample for which the model was first denved)

| | | |
|---|---|---|
| Schottky Barrier Height | Φ_{B} | [V] |
| Conduction Band Offset between Channel and Barrier | _{Δ}E_{C} | [V] |
| Front Delta Doping | N_{Sdelta} | [cm⁻²] |

note that this expression can be modified for non-delta doped epi-stacks

| | | | |
|---|---|---|---|
| Gate-to-Front Delta Doping Spacing | dδ | [m] | = {(H_{bar} + H_{fdope} + H_{cap}) − H_{rec}} / (10¹⁰) |
| Barrier Thickness between front doping and channel | H_{space} | [A] | |
| Barrier Layer Thickness before front doping layer | H_{bar} | [A] | |
| Front Doping layer thickness | H_{fdope} | [A] | |
| Cap layer thickness | H_{cap} | [A] | |
| Empirical Drain-Induced Barrier-Lowering Term | σ | [ ] | |
| Sheet Charge Position Gate Bias Factor | d_{iK} | [A/V] | |
| Sheet Charge Position Drain Bias Factor | d_{iL} | [A/V] | |
| | | | = Vₜₕ [1 + V_{gt}/2Vₜₕ + |
| Effective Gate Voltage | V_{gte} | [V] | sqrt(^{δ}^{²} + (V_{gt}/2Vₜₕ − 1)²] |
| Empirical Transition Width Parameter | δ | [ ] | |

As used herein, Ns represents the model sheet carrier concentration within the active channel. Ns′ represents the ideal charge control law and is modeled as a semi-physical representative of the actual density of state filling rate for energy states within the channel v. gate voltage. The gate-to-channel voltage used for the charge control,

Vgt, is a function of the Schottky barrier height, conduction band offsets and doping in the epi stack as is known in the art.

The following equations represent the semi-physical expression used to model the position of regional charge boundaries within the HEMT device. These expressions govern how to partition the model charge between the influence of different terminals.

| | | | |
|---|---|---|---|
| Effective Gate Length | L_{geff} | [_{μ}m] | = L_{g} + _{Δ}Lₛ + _{Δ}L_{d} |
| Gate-Source Control Region | L_{gs} | [_{μ}m] | = L_{g}/2 + _{Δ}Lₛ + X_{D1} |
| Source-Side Effective Gate Length Extension | _{Δ}Lₛ | [_{μ}m] | = _{Δ}L_{sO} + _{Δ}L_{K} * V_{gte} |
| Drain-Side Effective Gate Length Extension | _{Δ}L_{d} | [_{μ}m] | = _{Δ}L_{dO} + _{Δ}L_{K} * _{Δ}L_{L} * V_{dse2} |
| Gate-Drain Control Region | L_{gd} | [_{μ}m] | = (L_{g}/2 + _{Δ}L_{d}) * { tanh [10(L_{g}/2 − X_{D1})] + 1 } / 2 |
| | | | = X_{DL} V_{ds} M_{XdL}/ |
| | | | { M_{XdK} V_{gte}*(1 + [X_{DL}V_{ds}M_{XdL}/ |
| Bias Dependent Extension of the Saturated Transport Region | X_{D1} | [_{μ}m] | (M_{XdK}V_{gte}(L_{g}/2 + REC_{gd}))]^{m}}^{1/m} |
| Empirical Drain-Saturated Transport Boundary Factor | X_{DL} | [_{μ}m] | = L_{g} V_{ds} / { 2 [ 1 + (V_{ds}/Vₛₐₜₑₙ)^{m}]^{(1/m)}} |
| | | | = X_{sO} { M_{Xs} [ 1/(1 + (V_{ds}/Vₛₐₜₙ)^{m})^{(1/m)} − |
| | | | V_{ds}m (V_{ds}/Vₛₐₜₙ)^{(m 1)}/{ |
| | | | Vₛₐₜₙm[1 + (V_{ds}/Vₛₐₜₙ)^{m}]^{(1/m + 1)}}] |
| Position of the Boundary between Regions 1 and 2 | Xₛ | [_{μ}m] | V_{ds} M_{XsL} + V_{gte}M_{XsK} } |

Note: Region 1 denotes the linear region, while Region 2 denotes the saturated region of the channel

| | | | |
|---|---|---|---|
| Empirical Effective Gate Length Extension Gate Bias Factor | _{Δ}L_{K} | [_{μ}m/V] | |
| Empirical Effective Gate Length Extension Drain Bias Factor | _{Δ}L_{L} | [_{μ}m/V] | |
| Effective Drain-Source Voltage Control-2 | V_{dse2} | [V] | = V_{ds} / [1 + (V_{ds}/Vₛₐₜₙ)^{m}]^{1/m} |
| Rough, Intrinsic Saturation Voltage | Vₛₐₜₙ | [V] | = Iₛₐₜ/g_{chi} |
| | | | = g_{chi} V_{gte} / |
| Rough, Intrinsic Saturation Current Level | Iₛₐₜ | [A] | [1 + g_{chi}Rₛ + sqrt(1 + 2g_{chi}Rₛ + (V_{gte}/V_{L})²)] |
| Intrinsic Conductance of the Linear Region, Under the Gate | g_{chi} | [S] | = (q Nₛ μₐᵥₑ Wg) / Lg |
| Rough Intrinsic Saturation Voltage Level | V_{L} | [V] | = Fₛ * L_{g} |
| Empirical Knee Shaping Parameter | m | [ ] | |
| Empirical Region 2 extension Drain Bias Factor | M_{XdL} | [ ] | |
| Empirical Region 2 extension Gate Bias Factor | M_{XdK} | [ ] | |
| Fine Intrinsic Saturation Voltage | Vₛₐₜₑₙ | [V] | = I _{satcom}/g _{chi} |
| | | | = g_{chi} V_{gte} V_{L} * [ − V_{L}(A + g_{chi}Rₛ) + |
| | | | sqrt(V_{L}²(A + g_{chi}Rₛ)² + V_{gte}² − (g_{chi}RₛV_{L})²)] / |
| Fine Intrinsic Saturation Current Level | I_{satcom} | [A] | [V_{gte}² ( 1 − g_{chi}Rₛ(V_{L}V_{gte})²)] |
| Saturation Region Length Ratio | A | [ ] | = Xₛ / L_{geff} |
| Initial Starting position for Region1 & 2 Boundary | X_{sO} | [_{μ}m ] | = Lg / 2 |
| Region1 & 2 Boundary Bias Factor | M_{Xs} | [ ] | |
| Region1 & 2 Boundary Drain Bias Factor | M_{XsL} | [ ] | |
| Region1 & 2 Boundary Drain Bias Factor | M_{XsK} | [ ] | |

The following equation represents the semi-physical expressions used to model the bias dependence of linear channel mobility in depleted regions.

| | | | |
|---|---|---|---|
| Depleted Channel Mobility | μₐᵥₑ | [cm²/V*s] | = μ_{dchan} + μ_{dK*}V_{gte} |
| Fixed Depleted Channel Mobility | μ_{dchan} | [cm²/V*s] | |
| Depleted Channel Mobility Gate Bias Factor | μ_{dK} | [cm²/V²*s] | |

The following equations are the semi-physical expressions used to model the bias dependence of saturating electric field and saturation velocity.

| | | | |
|---|---|---|---|
| | | | = Vₛ / |
| Saturating Electric Field | F_{S} | [V_{/μ}m] | [(μₛₐₜ + μ_{satK}V_{gte}) 10000] |
| Fixed Saturating Channel Mobility | μₛₐₜ | [cm²/V*s] | |
| Saturating Channel Mobility Gate Bias Factor | μ_{satK} | [cm²/V²*s] | |
| Saturation Velocity | Vₛ | [cm/s] | |

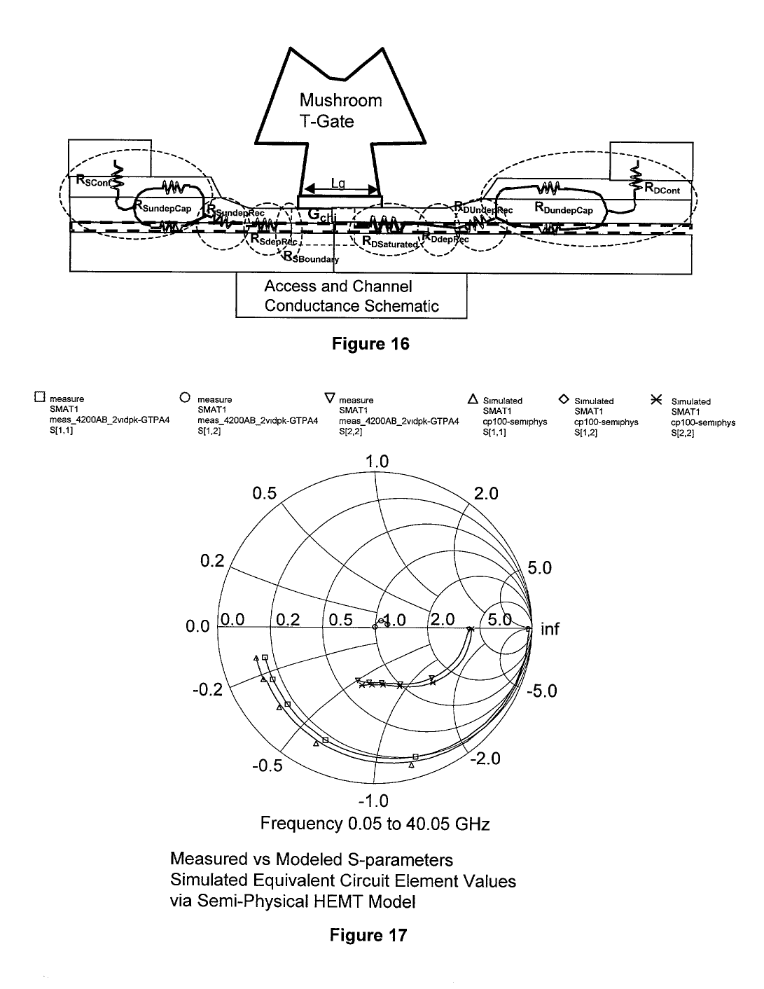

FIG. 16 is a schematically illustrates how electrical conductance in the source and drain access regions are modeled in the example.

The following equations describe the semi-physical model for the source access region conductance:

| | | | |
|---|---|---|---|
| Source Access Resistance | Rₛ | [Ω] | = ( R_{SundepCap} + R_{SAccess} + R_{SBoundary} ) / W_{g} |
| | | | = R_{cont}/RF_{rconF} + |
| Source Access Resistance Channel and Cap | R _{S undepCap} | [Ω*_{μ}m] | R_{SH}[ D_{sg} − (REC_{sg} + L_{g}/2)] |
| | | | = R_{SdepRec}^{ON} * MRₛ*tanh{[ KC_{fK} * ( |
| | | | V_{gs} − VC_{fOn} + V_{ds}*MC_{fL} )] + 1 } / 2 * { V_{gs} |
| | | | / 2 *[1 − tanh( KR_{sK} (V_{gs} − VR_{sOn}))]}* } tanh [ |
| | | | KR_{sSat} (V_{ds} − VR_{sKnee})] + 1 } / 2 + R_{SundepRec} * { tanh[ |
| Source Access Resistance Recess and Undepleted Cap | R_{SAccess} | [Ω*_{μ}m] | KR_{sK} (V_{gs} − VR_{sOn})] + 1} / 2 |
| | | | = R_{SdepRec}^{ON} * MRₛ * tanh {] KR_{sK}*V_{gs} + KR_{sL}*V_{ds} + |
| | | | VR_{sOff} ] + 1 } / 2 * {(1 + V_{ds}MR_{sL})*MR_{sK}*[1 − |
| | | | tanh(KR_{sSat}(V_{ds} − VR_{sKnee}))]/ [ 2*(1 + [V_{gs}/((1 + |
| Source Access Resistance Crowding resistance due to conductance | R_{SBoundary} | [Ω*_{μ}m] | V_{ds}MR_{sL})]^{_{γ}}^{Rs})^{(1/}^{_{γ}}^{Rs)}] } |
| mismatch | | | |
| Resistance of the Source Recess Access region at high on-state | R _{S depRec}^{ON} | [Ω*_{μ}m] | = R_{SHdep} ( REC_{sg} ) |
| bias (Vₒₙ) | | | |
| Resistance of the Undepleted Source Recess Access region | R _{S undepRec} | [Ω*_{μ}m] | = R_{SHundep} ( REC_{sg} ) |
| Uncapped, Fully Depleted Sheet Resistance | R_{SHdep} | [Ω/sq] | = 1 / (q Nₘₐₓ μₐᵥₑ) |
| Capped, Undepleted Sheet Resistance | R_{SH} | [Ω/sq] | = 1 / ( 1/R_{SHCap} = 1/ R_{SHundep}) |
| Uncapped, Undepleted Sheet Resistance | R_{SHundep} | [Ω/sq] | = F_{surfUndep} / (q Nₘₐₓμ_{undchan}) |
| Cap Sheet Resistance | R_{SHCap} | [Ω/sq] | = 1 / [q N_{sCap}μ_{cap}( H_{cap} − H_{capEtch} )] |
| Surface Depletion Factor | F_{surfUndep} | [ ] | |
| High On-state bias' Diode Turn-on voltage | V_{ON} | [V] | = Φ_{b} − ΔE_{C} − ΔE_{f} |
| Ohmic Contact Resistance | R_{cont} | [Ω*_{μ}m] | |
| RF Ohmic Contact Resistance Reduction Factor | RF_{rconF} | [ ] | |
| Source Access Resistance Bias Modification Factor | MRₛ | [ ] | |
| Cf-Vds Bias Modification Factor | MC_{fL} | [ ] | |
| Rs-Vds Bias Modification Factor | MR_{sL} | [ ] | |
| Rs-Vgs Bias Modification Factor | MR_{sK} | [ ] | |
| Cf-Vga Swith point to On-state | VC_{fOn} | [ ] | |
| Cf-Vga Bias Expansion Factor | KC_{fK} | [ ] | |
| Rs-Vgs Swith point to On-state | VR_{sOn} | [ ] | |
| Rs-Vgs Swith point to Off-state | VR_{SOff} | [ ] | |
| Rs-Vds Swith point from Off-On transition | VR_{SKnee} | [ ] | |
| Rs-Vds Bias Expansion Factor | KR_{sL} | [ ] | |
| Rs-Vgs Bias Expansion Factor | KR_{sK} | [ ] | |
| Rs-Vds Bias Expansion Factor @ Rs Saturation | KR_{sSat} | [ ] | |
| Rs Bias Shaping Factor | _{γ}Rₛ | [ ] | |

The following equations describe the drain access region conductance:

| | | | |
|---|---|---|---|
| Source Access Resistance | R_{S} | [Ω] | = ( R_{SundepCap} + R_{SAccess} + R_{SBoundary} ) |
| | | | = R_{cont}/RF_{rconF} + |
| Source Access Resistance: Channel and Cap | R _{S undepcap} | [Ω*_{μ}m] | R_{SH}[ D_{sg} − (REC_{sg} + L_{g}/2)] |
| | | | = R_{SdepRec}^{ON} * MRₛ*tanh{[ KC_{fK} * ( |
| | | | V_{gs} − VC_{fOn} + V_{ds}*MC_{fL} )]+ 1 } / 2 * { V_{gs} |
| | | | / 2 *[1 − tanh( KR_{sK} (V_{gs} − VR_{sOn}))]☆ { tanh] |
| | | | KR_{sSat} (V_{ds} − VR_{sKnee})] +1 } / 2 + R_{SundepRec} * { tanh[ |
| Source Access Resistance: Recess and Undepleted Cap | R_{SAccess} | [Ω*_{μ}m] | KR_{sK} (V_{gs} − VR_{sOn})] + 1} / 2 |
| | | | = R_{MR}ₛ * tanh }] KR_{sK}*V_{gs} + KR_{sL}*V_{ds} + |
| | | | VR_{sOff} } +1 } / 2 {(1 + V_{ds}MR_{sL})*MR_{sK}*[1 − |
| | | | tanh(KR_{sSat}(V_{ds} − VR_{sKnee}))]/ [ 2*(1 + [V_{gs}/((1 + |
| Source Access Resistance: Crowding resistance due to conductance | R_{SBoundary} | [Ω*_{μm]} | V_{ds}MR_{sL})*MR_{sK})]^{_{γ}}^{Rs})] } |
| mismatch | | | |
| Resistance of the Source Recess Access region at high on-state bias | R _{S depRec}^{ON} | [Ωμm] | = R_{SHdep} ( REC_{sg} ) |
| (Vₒₙ) | | | |
| Resistance of the Undepleted Source Recess Access region | R _{S undepRec} | [Ω*_{μ}m] | = R_{SHundep} ( REC_{sg} ) |
| Uncapped, Fully Depleted Sheet Resistance | R_{SHdep} | [Ω/sq] | = 1 / (q Nₘₐₓμₐᵥₑ) |
| Capped, Undepleted Sheet Resistance | R_{SH} | [Ω/sq] | = 1 / ( 1/R_{SHCap} + 1/ R_{SHundep}) |
| Uncapped, Undepleted Sheet Resistance | R_{SHundep} | [Ω/sq] | = F_{surfUndep}/ (q Nₘₐₓμ_{undchan}) |
| Cap Sheet Resistance | R_{SHCap} | [Ω/sq] | = 1 / [q N_{sCap} μ_{cap}( H_{cap} − H_{capEtch} ) ] |
| Surfece Depletion Factor | F_{surfUndep} | [ ] | |
| High On-state bias: Diode Turn-on voltage | V_{ON} | [V] | = Φ_{b} − ΔE_{C} − ΔE_{f} |
| Ohmic Contact Resistance | R_{cont} | [Ω*_{μ}m] | |
| RF Ohmic Contact Resistance Reduction Factor | RF_{rconF} | [ ] | |
| Source Access Resistance Bias Modification Factor | MRₛ | [ ] | |
| Cf-Vds Bias Modification Factor | MC_{fL} | [ ] | |
| Rs-Vds Bias Modification Factor | MR_{sL} | [ ] | |
| Rs-Vgs Bias Modification Factor | MR_{sK} | [ ] | |
| Cf-Vgs Swith point to On-state | VC_{fOn} | [ ] | |
| Cf-Vgs Bias Expansion Factor | KC_{fK} | [ ] | |
| Rs-Vgs Swith point to On-state | VR_{SOn} | [ ] | |
| Rs-Vgs Swith point to Off-state | VR_{SOff} | [ ] | |
| Rs-Vds Swith point from Off-On transition | VR_{SKnee} | [ ] | |
| Rs-Vds Bias Expansion Factor | KR_{sL} | [ ] | |
| Rs-Vgs Bias Expansion Factor | KR_{sK} | [ ] | |
| Rs-Vds Bias Expansion Factor @ Rs Saturation | KR_{sSat} | [ ] | |
| Rs Bias Shaping Factor | _{γ}Rₛ | [ ] | |

### SEMI-PHYSICAL DETERMINATION OF SMALL-SIGNAL EQUIVALENT CIRCUITS

To derive values for the familiar small signal equivalent circuit as shown in FIG. 11, a small signal excitation analysis must be applied to the semi-physically modeled physical expressions. The method of applying such an analysis is as follows:

1) Gate Terminal Voltage Excitation

a) Apply a small +/− voltage delta around the desired bias condition, across the gate-source terminals.

b) Equivalent circuit element Gm=delta(Ids)/delta (Vgs′) where delta (Vgs′) is mostly the applied voltage deltas, but also subtracting out that voltage which is dropped across the gate source access region, shown as RsCont, RsundepCap, RsundepRec, ResdepRec, and RsBoundary in FIG. 16, above.

c) Equivalent circuit element Cgs and Cgd takes the form of delta(Nsn)/delta(Vgs)*Lgn, where delta (Nsn) is the appropriate charge control expression, and Lgn is the gate source or gate drain charge partitioning boundary length.

d) Equivalent circuit element Ri=Lgs/(Cgschannel*vs) where Cgs channel is the portion of gate source capacitance attributed to the channel only, and vs is the saturated electron velocity.

2) Drain Terminal Voltage Excitation

a) Apply a small +/− voltage delta around te same bias condition as in 1, but the delta is applied across drain source terminals.

b) Equivalent circuit element Rds=1/{delta(Ids)/delta(Vds′)} where Vds′ is mostly the applied voltage deltas, but also subtracting out voltage which is dropped over both the gate source and gate drain access regions.

c) Equivalent circuit element Cds is taken to be the sum of the appropriate fringing capacitance Semi-Physical models, or can take the form of delta(Nsd)/delta(Vds′)*Xsat, were Nsd is the charge control expression for charge accumulation between the appropriate source and drain charge boundaries, and Xsat is the length of the saturated region, if in saturation.

3) On-mesa Parasitic Elements: The equivalent circuit elements, Rs and Rd are expressed by the appropriate electrical conduction models of the source and drain access regions.

The RF performance can be predicted at an arbitrary bias point.

Table 4 represents a comparison of the values for a high frequency equivalent circuit model derived from equivalent circuit model extraction from and semi-physical modeling for the sample illustrated in Table 3.

TABLE 3
Comparison of Modeled Equivalent Circuit Results for Semi-physical
Modeling Method, and Equivalent Circuit Model Extraction

| | | |
|---|---|---|
| Intrinsic Equivalent | Equivalent | Semi-Physical |
| Circuit Parameter | Circuit Model | Device Model |

| | | | | |
|---|---|---|---|---|
| Cgs | 0.227745 | pF | 0.182 | pF |
| Rgs | 64242 | Ω | infinite | Ω |
| Cgd | 0.017019 | pF | 0.020 | pF |
| Rgd | 133450 | Ω | infinite | Ω |
| Cds | 0.047544 | pF | 0.033 | pF |
| Rds | 160.1791 | Ω | 178.1 | Ω |
| Gm | 135.7568 | mS | 124 | mS |
| Ri | 3.034 | Ω | 2.553 | Ω |
| Tau | 0.443867 | pS | 0.33 | pS |

The results of the semi-physical modeling method produce a small-signal equivalent circuit values which are relatively more accurate than the physical device simulator in this case. Furthermore, given the differences in the parasitic embedding, treatment of the two approaches, the results given in Table 3 yield much closer results than a comparison of equivalent circuit values.

Table 4 lists the values of parasitic elements used in the model derivations. An important difference between the extracted equivalent circuit model and the semi-physically derived one is the use of Cpg and Cpd to model the effect of launch capacitance for the tested structure. This difference leads to the results of the extracted model results being slightly off from the optimum physically significant solution.

TABLE 4
Comparison of Modeled “Parasitic” Equivalent Circuit Results for
Semi-physical Modeling Method, and Equivalent
Circuit Model Extraction

| | | |
|---|---|---|
| Extrinsic Equivalent | Equivalent | Semi-Physical |
| Circuit Parameter | Circuit Model | Device Model |

| | | | | |
|---|---|---|---|---|
| Rg | 1.678 | Ω | 1.7 | Ω |
| Lg | 0.029314 | nH | 0.03 | nH |
| Rs | 1.7 | Ω | 1.21 | Ω |
| Ls | 0.002104 | nH | 0.003 | nH |
| Rd | 3.309899 | Ω | 5.07 | Ω |
| Ld | 0.031671 | nH | 0.02 | nH |
| Cpg | 0 | pF | 0.02 | pF |
| Cpd | 0 | pF | 0.01 | pF |

As shown in FIGS. 17, 18 and 19, the modeled results that are simulated using the semi-physically derived equivalent circuit model very accurately replicate the measured high frequency, S-parameter data.

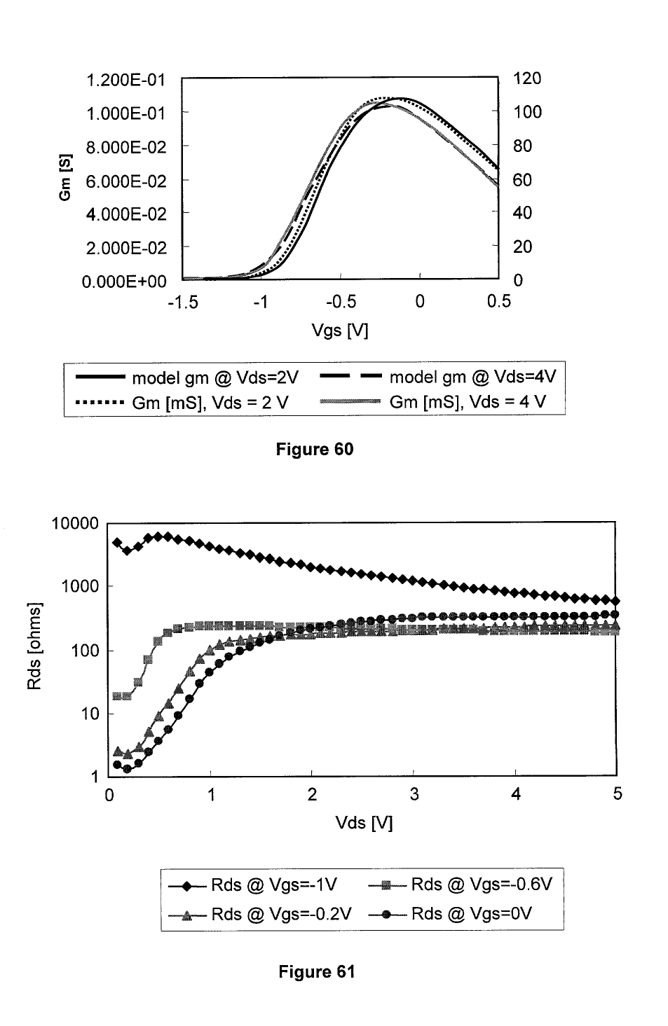

The following equations represent the small-signal excitation derivation of small-signal equivalent circuit modeled Gm. FIG. 60. illustrates the semi-physically simulated bias equations of the small signal Gm compared to measured data.

| | | | |
|---|---|---|---|
| | | | = g_{ch} V_{ds} (1 = _{γ V}_{ds}) / |
| Semi-Physically Modeled Drain-Source Current Control | I_{ds} | [A] | [1 + (V_{ds}/V_{safe})^{m}]^{1/m} |
| Small-Signal Deterimination of equiv. Circuit Gm value | g_{mRF} | [S] | = dI_{ds} / d ( V_{gs} − V_{sAcc} ) |
| | | | = I_{dsW} * (R_{SundepCap} + R_{SAccess} + R_{SBoundary} + |
| Source-Access voltage drop | V_{SAcc} | [V] | R_{probeS}/W_{g}) |
| Fine Extrinsic Saturation Voltage | Vₛₐₜₑ | [V] | = I_{satcom}/g_{ch} |
| | | | = g_{chi}/ |
| Extrinsic Conductance of the Linear Region, Under the gate | g_{ch} | [S] | [1 + g_{chi} (Rₛ + R_{d})] |
| Intrinsic Conductance of the Linear Region, Under the gate | g_{ch} | [S] | = (q Nₛ μₐᵥₑ W_{g}) / L_{g} |

The following equations represent the small-signal excitation derivation of Rds. FIG. 61 illustrates the semi-physically simulated bias-dependence of the small-signal Rds.

| | | | |
|---|---|---|---|
| Small-Signal Deterimination of equiv. Circuit Rds value | R_{ds} | [Ω] | = 1 / g_{dsRF} |
| | | | = { dI_{ds} / d ( V− R_{probeD} * I_{ds} − V_{sAcc} − V_{dAcc} − V_{dSat} ) |
| | g_{dsRF} | [S] | } * r_{dsF} |
| | | | = I_{dsW} * (R_{DUndepCap} + R_{DUndepRec} + R_{DAccess} + |
| Drain-Access voltage drop | V_{DAcc} | [V] | R_{probeD}/W_{g} ) |
| Drain-Saturation Region voltage drop | V_{DSAT} | [V] | = I_{dsW} * ( R_{DSaturated} ) |
| External Test probe or lead resistance | R_{probeD} | [Ω] | |
| | | | = (RF_{rdsF} + 1) * |
| High Frequency conductance dispersion factor | r_{dsF} | [ ] | tanh( 10 * ═ V_{ds} − Vₜₕ ═ ) + 1 |
| High Frequency conductance dispersion | RF_{rdsF} | [ ] | |

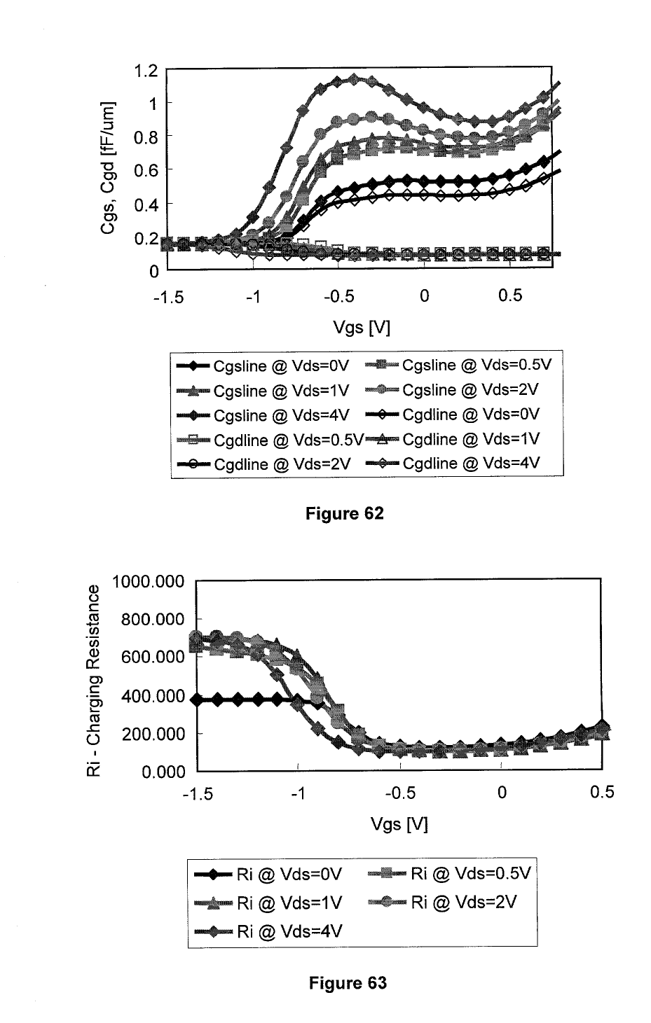

The following equations may be used for the small-signal excitation derivation of Cgs and Cgd. FIG. 62 illustrates the semi-physically simulated bias-dependence of the small-signal Cgs and Cgd.

| | | | |
|---|---|---|---|
| | | | = C_{gsf} + βC_{gcTot}L_{gs} |
| Small-Signal Deterimination of equiv. Circuit Cgs value | C_{gs} | [fF/_{μ}m] | {1 − [Vₛₐₜₑₙ − V_{dse})/(2*Vₛₐₜₑₙ − V_{dse})]²} |
| | | | = C_{gdf} + βC_{gcTot}L_{gd}* |
| | C_{gd} | [fF/_{μ}m] | {1 − [Vₛₐₜₑₙ/(2*Vₛₐₜₑₙ − V_{dse})]²} |
| Parasitic Gate-Source Fringing Capacitance | C_{gsf} | [fF/_{μ}m] | = Cg_{surf}C_{f-form1}SiNF + Cgsf_{Source} + Cgsf_{Pad} |
| Parasitic Gate-Source Fringing Capacitance | C_{gdf} | [fF/_{μ}m] | = Cg_{surf}C_{f-form1}SiNF + Cgdf_{Cap} + Cgdf_{Pad} |
| Total Specific Gate-Channel Capacitance | C_{gcTot} | [fF/_{μ}m²] | = C_{gc} + C_{gcdonor} |
| | | | = C_{gc}Msh_{Kchan}/ |
| Specific Gate-Channel Capacitance | C_{gc} | [fF/_{μ}m²] | {[1 + (Nₛ′/(N₀ + N_{max0c})^{γc})^{(1 + 1/γc)}]} |
| Effective Drain-Source Voltage Control | V_{dse} | [V] | = V_{ds}/[1 + (V_{ds}/Vₛₐₜₑₙ)^{m}]^{1/m} |
| Specific Gate-Donor Layer Accumulation Capacitance | C_{gcdonor} | [fF/_{μ}m²] | = qdN_{sDonor}/dV_{gs} |
| Ideal Specific Gate-Channel Capacitance | C_{gc} | [fF/_{μ}m²] | = qdNₛ′/dV_{gs} |
| | | | = (Nₛ′+ Nₛ)*(dᵢ + Δdᵢ)Msh_{Kpar}*V_{gte}/ |
| Empirical Parasitic Donor Charge Control Expression | N_{sDonor} | [cm⁻²] | (d₁ + Δd₁) |
| Fringing capacitance to surface of source-access region | C_{gsurf} | [fF/_{μ}m] | |
| Empirical Fringing capacitance-bias shaping expression | C_{f-form1} | [] | = {1 − tanh[KC_{fK}(V_{gs} − VC_{fOn} + V_{ds}MC_{fL})]}/2 |
| Fringing capacitance to source-access region | C_{gsfSource} | [fF/_{μ}m] | |
| Fringing capacitance to source metal pads | C_{gsfPad} | [fF/_{μ}m] | |
| Fringing capacitance to drain-access Capped Region | C_{gdfCap} | [fF/_{μ}m] | |
| Fringing capacitance to drain metal pads | C_{gdfPad} | [fF/_{μ}m] | |
| Dielectric Coating Thickness Factor | SiNF | [] | |
| Specific Gate-Channel Capacitance Bias ModificationFactor | Msh_{Kcahn} | [] | |
| Donor Charge Bias ModificationFactor | Msh_{Kpar} | [] | |
| Empirical Specific Charge Control Shaping Parameter | _{γ}C | [] | |

The following equations are involved in the small-signal excitation derivation of Ri. FIG. 63, which follows, shows the semi-physically simulated bias-dependence of the small-signal Ri.

| | | | |
|---|---|---|---|
| Gate-Source Non-quasistatic charging resistance | R_{icharge} | [Ω*_{μ}m] | = L_{gs2}W_{g}/[C_{gsChan}W_{g}vₛ] |
| | | | = C_{gsf} + βC_{gc}L_{gs}* |
| Gate-Channel Source Capacitance | C_{gsChan} | [fF/_{μ}m] | {1 − [(Vₛₐₜₑₙ − V_{dse})/(2*Vₛₐₜₑₙ − V_{dse})]²} |

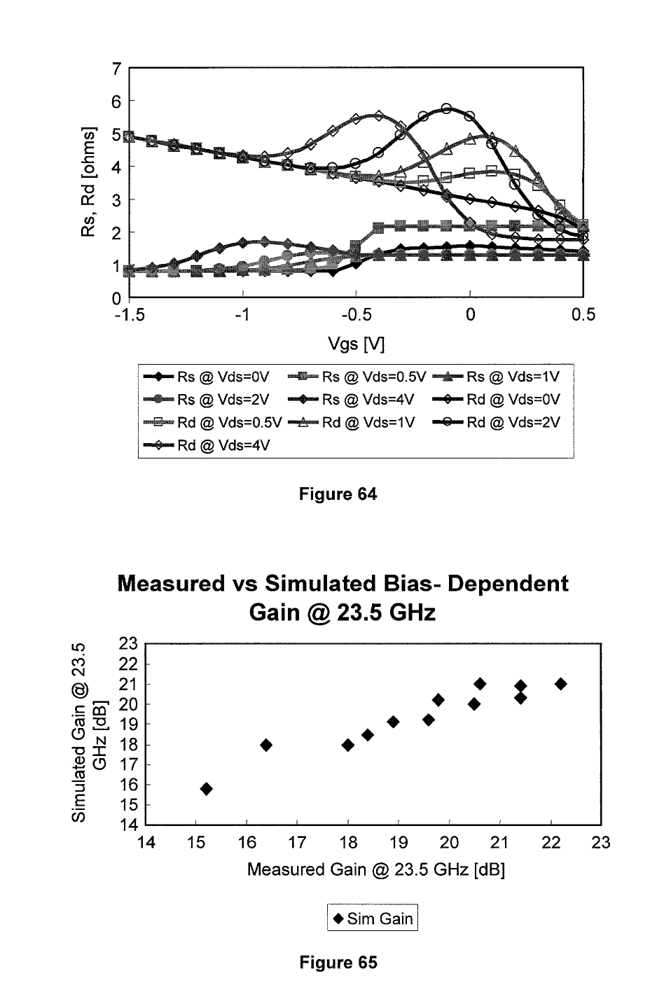

FIG. 64 shows the semi-physically simulated bias-dependence of the on-mesa parasitic access resistances, Rs and Rd.

### EXAMPLE OF SEMI-PHYSICAL MODEL AND BIAS-DEPENDENCE SMALL-SIGNAL SOURCE AND DRAIN RESISTANCE, RS AND RD

The following example verifies how the semi-physical small-signal device model is able to provide accurate projections for bias-dependent small-signal performance. In this example, the same semi-physical device model as used in the previous examples was used because the example MMIC circuit was fabricated utilizing the same HEMT device technology.

In this example, the bias-dependence small-signal gain and noise performance of a two-stage balanced K-band MMIC LNA amplifier is replicated through microwave circuit simulation using small signal and noise equivalent circuits that were generated by the semi-physical model. The results of the measured and modeled results are shown below in Table 5. As seen from these results, the semi-physical device model was able to accurately simulate the measured bias-dependent performance, even though the bias variation was quite wide.

TABLE 5
Measured vs. Modeled Gain NF and Gain @ 23.5 Ghz for K-band
MMIC LNA at Difference Bias Conditions

| | Measured | Predicted | Measured | Predicted |
|---|---|---|---|---|
| | Gain | Gain | NF | NF |
| Bias Condition | @ 23.5 GHz | @ 23.5 GHz | @ 23.5 GHz | @ 23.5 GHz |
| Vds = 0.5 V | 15.2 dB | 15.8 dB | 2.97 dB | 2.77 dB |
| 112 mA/mm | | | | |
| Vds = 1.0 V | 20.6 dB | 21.0 dB | 2.29 dB | 2.20 dB |
| 112 mA/mm | | | | |
| Vds = 2.0 V | 19.8 dB | 20.2 dB | 2.25 dB | 2.15 dB |
| 112 mA/mm | | | | |
| Vds = 3.0 V | 18.9 dB | 19.1 dB | 2.30 dB | 2.11 dB |
| 112 mA/mm | | | | |
| Vds = 3.5 V | 18.4 dB | 18.5 dB | 2.34 dB | 2.18 dB |
| 112 mA/mm | | | | |
| Vds = 4.0 V | 18.0 dB | 18.0 dB | 2.37 dB | 2.27 dB |
| 112 mA/mm | | | | |
| Vds = 2.0 V | 16.4 dB | 18.0 dB | 2.45 dB | 2.21 dB |
| 56 mA/mm | | | | |
| Vds = 2.0 V | 21.4 dB | 20.9 dB | 2.38 dB | 2.21 dB |
| 170 mA/mm | | | | |
| Vds = 2.0 V | 22.2 dB | 21.0 dB | 2.65 dB | 2.6 dB |
| 225 mA/mm | | | | |
| Vds = 3.0 V | 21.4 dB | 20.3 dB | 2.71 dB | 2.61 dB |
| 225 mA/mm | | | | |
| Vds = 3.0 V | 20.5 dB | 20.0 dB | 2.42 dB | 2.22 dB |
| 170 mA/mm | | | | |
| Vds = 4.0 V | 19.6 dB | 19.2 dB | 2.50 dB | 2.29 dB |
| 170 mA/mm | | | | |

A plot of measured vs. modeled gain for the values listed in Table 3, above, is shown in FIG. 65.

### EXAMPLE OF SEMI-PHYSICAL MODEL ACCURATE PHYSICAL NATURE

The following example verifies how the semi-physical small-signal device model is able to provide accurate projections for physically dependent small-signal performance. In this example, the same semi-physical device model as used in the previous examples was used.

In this example, physical process variation was input into the semi-physical device model in terms of statistical variation about known averages, cross-correlation, and standard deviations. The goal of this exercise was to replicate the measured DC and small-signal device variation. The degree of accurate replication indicates the degree to which the semi-physical model is physically accurate.

Table 6 below lists the simulated, and known process variation that was used:

TABLE 6
Statistical Process Variation Model

| | | |
|---|---|---|
| Parameter | Nominal | Standard Dev. |

| | | | | |
|---|---|---|---|---|
| Gate Length | 0.15 | um | 0.01 | um |
| Gate-Source Recess | 0.16 | um | 0.015 | um |
| Gate-Drain Recess | 0.24 | um | 0.020 | um |
| Etch Depth | 780 | A | 25 | A |
| Pass. Nitride Thickness | 750 | A | 25 | A |
| Gate-Source Spacing | 0.7 | um | 0.1 | um |
| Source-Drain Spacing | 1.8 | um | 0.15 | um |

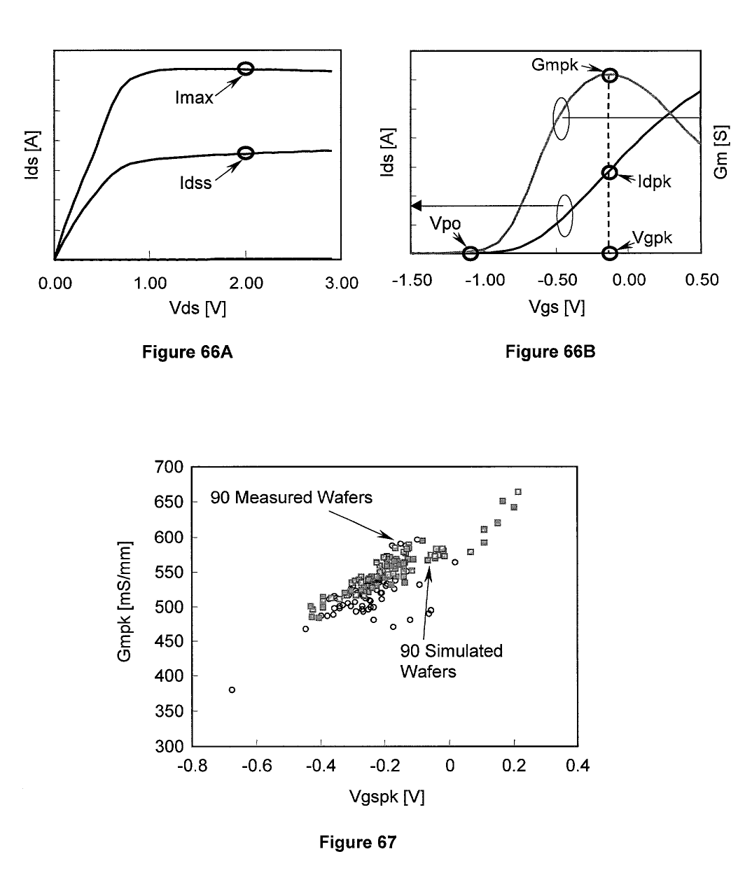

In the course of microelectronic component production, sample devices are tested in process in order to gain statistical process control monitor (PCM) data. FIGS. 66A and 66B show schematically the kind of data that is extracted and recorded from measured device I-V's during PCM testing.

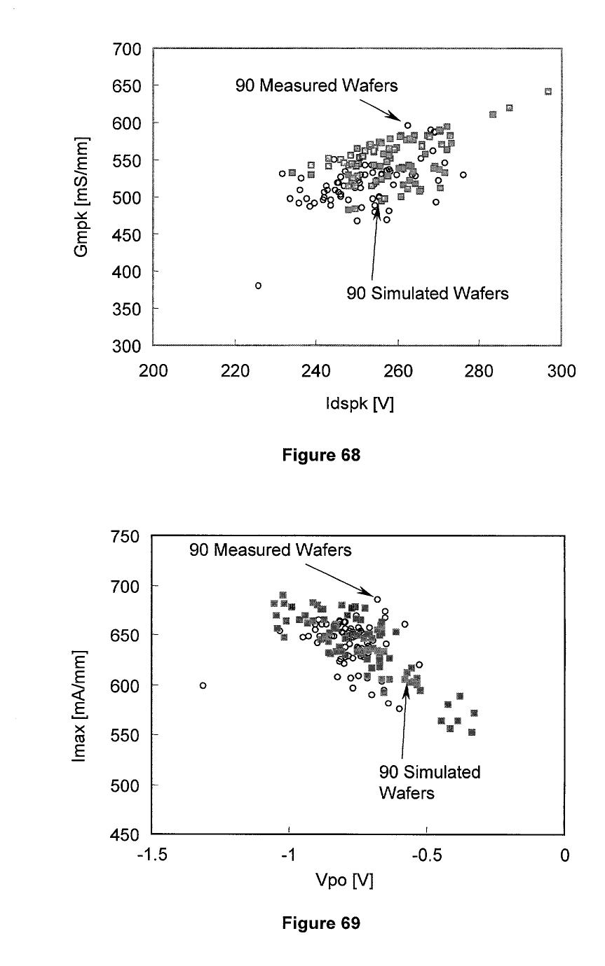

Since the semi-physical device model is able to simulate I-V's, it was able to simulate the variation of I-V's due to physical process variation. These I-V's were analyzed in the same fashion to extract the same parameters that are recorded for PCM testing. FIGS. 67, 68 and 69 show how accurately the simulated results match with measured process variation. FIG. 67 shows how the semi-physically simulated Vgpk and Gmpk match with actual production measurements. FIG. 68 shows how simulated Idpk and Gmpk match, also. Finally, FIG. 69 shows how simulated Imax and Vpo also match very well.

Small-signal S-parameter measurements are also taken in process for process control monitoring. These measurements are used to extract simple equivalent circuit models that fit the measured S-parameters. Since the semi-physical device model is able to simulate these equivalent circuit models, it was able to simulate the variation of model parameters due to physical process variation.

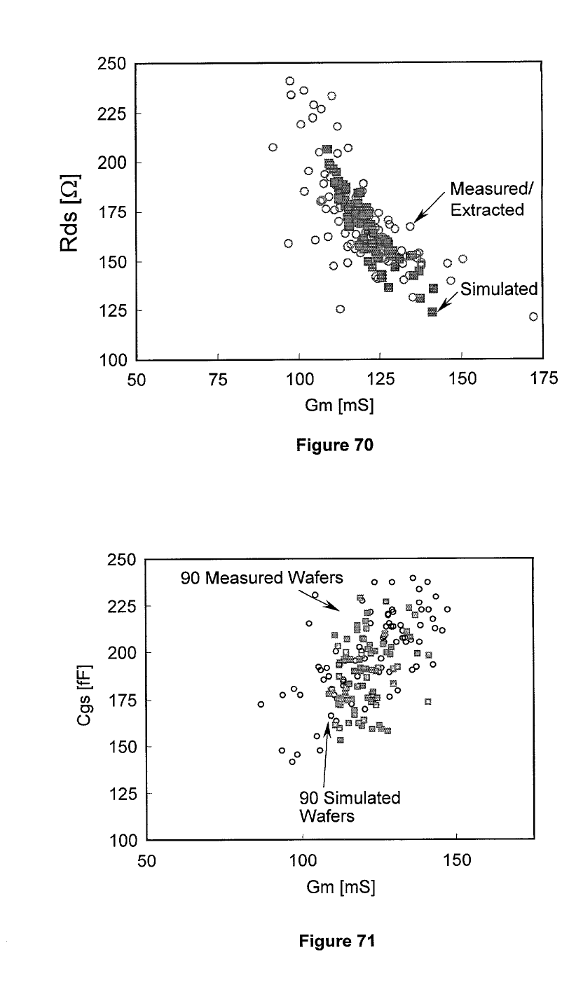

FIGS. 70 and 71 show how accurately the simulated results match with measured/extracted process variation for the small-signal model parameters. FIG. 70 shows how the semi-physically simulated Rds and Gm match very well with actual extracted model process variation

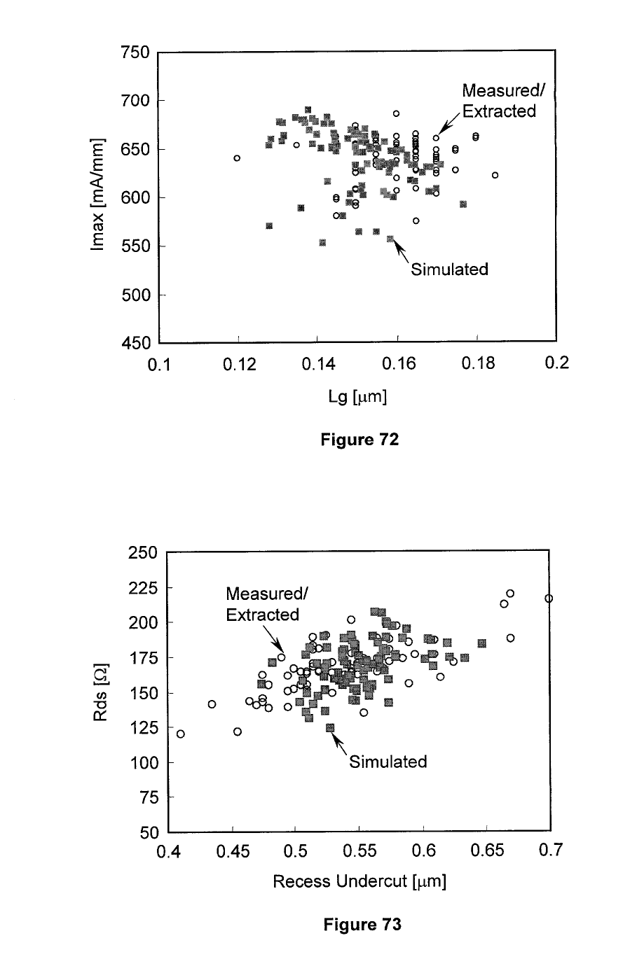

Finally, more direct and convincing evidence supporting the accurate, physical nature of the semi-physical model can be shown be comparing the dependence of simulated and measured performance to real physical variable. As shown in FIG. 72, the semi-physical model is able to very accurately reproduce the dependence of Imax upon gate length. In addition, the semi-physical model is also able to replicate physical dependence for high-frequency small-signal equivalent circuits. This is shown in FIG. 73, which shows that it is able to reproduce the dependence of Rds with Recess undercut width.

### S-PARAMETER MICROSCOPY

The S-parameter microscopy (SPM) method utilizes bias dependent S-parameter measurements as a form of microscopy to provide qualitative analysis of the internal charge and electrical field structure of the semiconductor device heretofore unknown. Pseudo images are gathered in the form of S-parameter measurements extracted as small signal models to form charge control maps. Although finite element device simulations have heretofore been used to calculate the internal charge/electric field of semiconductor devices, such methods are known to be relatively inaccurate. In accordance with the present invention, the S-parameter microscopy provides a relatively accurate method for determining the internal charge and electric field within a semiconductor device. With accurate modeling of the internal charge and electric field, all of the external electrical characteristics of semiconductor devices can be relatively accurately modeled including its high frequency performance. Thus, the system is suitable for making device technology models that enabled high frequency MMIC yield analysis forecasting and design for manufacturing analysis.

S-parameter microscopy is similar to other microscopy techniques in that SPM utilizes measurements of energy reflected to and from a sample to derive information. More particularly, SPM is based on transmitted and reflective microwave and millimeter wave electromagnetic power or S-parameters. As such, S-parameter microscopy is analogous to the combined operation of scanning and transmission electron microscopes (SEM and TEM). Scattered RF energy is analogous to the reflection and transmission of the electron beams in the SEM and TEMs. However, instead of using electron detectors as in the SEM and TEMs, reflectometers in a network analyzer are used in S-parameter microscopy to measure a signal. S-parameter microscopy is similar to other microscopy techniques in that both utilize; measurement of scattering phenomenon as data; include mechanisms to focus measurements for better resolution; and include mechanisms to contrast portions of the measurement to discriminate detail as shown in Table 7 below:

TABLE 7

| General Microscopes | S-Parameter Microscope |
|---|---|
| Measure of scattered energy | Measures S-Parameters |
| Mechanism for “focus” | Focuses by extraction of Unique |
| | equivalent circuit models |
| Mechanism for “contrast” | Contrasts by using bias dependence to |
| | finely discriminate the nature and |
| | location of charge/electric fields |

RESULT: Detailed “images” of device's internal charge and electric field structure.

Images as discussed herein, in connection with S-parameter microscopy do not relate to real images, but are used provide insight and qualitative detail regarding the internal operation of a device. More specifically, S-parameter microscopy does not provide visual images as in the case of traditional forms of microscopy. Rather, S-parameter microscopy images are more like maps which are computed and based on a non-intuitive set of measurements.

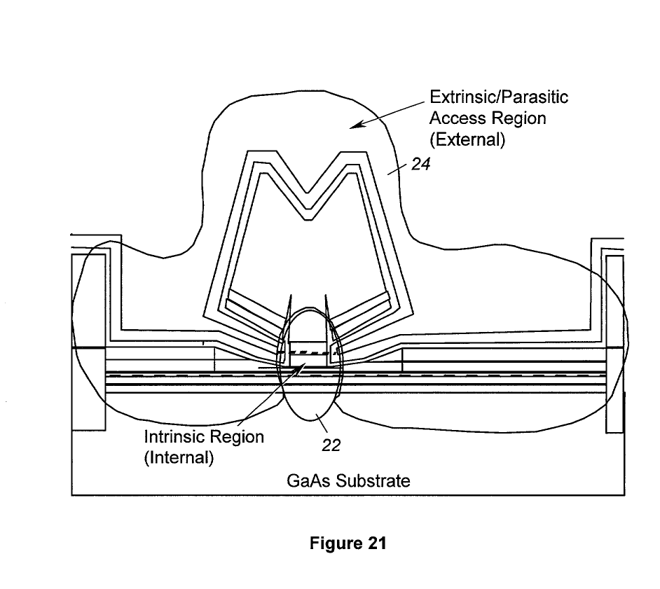

FIG. 20 illustrates a conceptual representation of an S-parameter microscope, generally identified with the reference numeral 20. The S-parameter microscope 20 is analogous to a microscope which combines the principles of SEM and TEM. Whereas SEM measures reflections and TEM measures transmissions, the 2-port S-parameter microscope 20 measures both reflective and transmitted power. As a result, data derived from the 2-port S-parameter microscope contains information about the intrinsic and extrinsic charge structure of a device. More particularly, as in known in the art, SEM provides relatively detailed images of the surface of a sample through reflected electrons while TEM provides images of the internal structure through transmitted electrons. The reflective signals are used to form the external details of a sample while transmitted electrons provide information about the interior structure of a device. In accordance with an important aspect of the invention, S-parameter microscopy utilizes a process of measuring reflective and transmitted signals to provide similar “images” of the charge structure of a semiconductor device. As used herein the internal and external electrical structure of a semiconductor device are commonly referred to as intrinsic device region and 22 and extrinsic parasitic access region 24 as shown in FIG. 21. Also contributing to the external electrical structure of the device are parasitic components associated with its electrodes and interconnects which are not shown. These are so-called device “layout parasitics”.

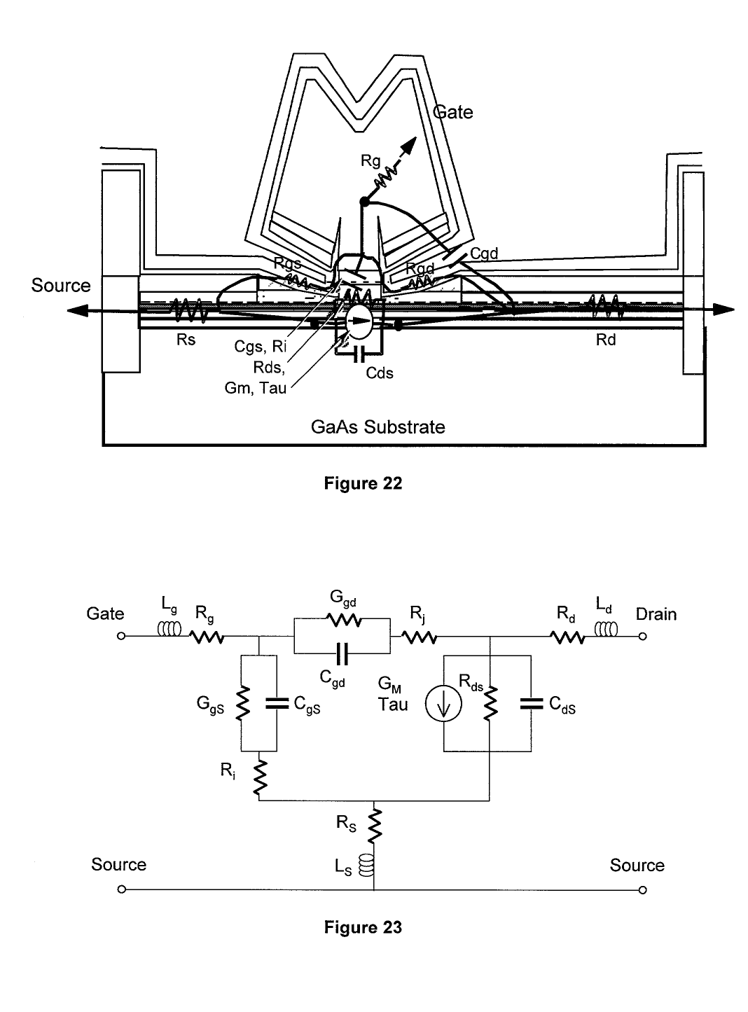

Referring to FIG. 20, the ports 26 and 28 are emulated by S-parameter measurements. The S-parameter measurements for a specific semiconductor device, generally identified with the reference number 30, are processed in accordance with the present invention to provide charge control maps, shown within the circle 32, analogous to images in other microscopy techniques. These charge control maps 32, as will be discussed in more detail below, are expressed in the form of equivalent circuit models. As shown in FIG. 22, linear circuit elements are used in the models to represent the magnitude and state of charge/electric fields inside the semiconductor device 30 or its so-called internal electrical structure. The position of the circuit elements within the model topology is roughly approximate the physical location within the device structure, hence the charge control map represents a diagram of the device's internal electrical structure, hence the above charge control map represents a diagram of the device's internal electrical structure.

The interpretation of the exact location of measured charge/electric fields within the semiconductor device is known to be ambiguous since an equivalent circuit model, for example, as illustrated in FIG. 23 with discrete linear elements, is used to represent the distributed structure of the charge/electric fields. Although there is no exact method for distinguishing the physical boundaries between measured quantities, bias dependence is used to clarify how the S-parameters should be discriminated, separated and contrasted. In particular, changing bias conditions is known to change the magnitude and shift boundaries between the charge and electric fields within the device. The changes are normally predictable and qualitatively well known in most technologies. As such, the charge control maps can readily be used as maps illustrating the characterization of physical changes in magnitude, location and separation of electric charge and electric fields.

Analogous to other forms of microscopy, the S-parameter microscope 20 in accordance with the present invention also emulates a lens, identified with the reference numeral 40 (FIG. 20). The lens 40 is simulated by a method for the extraction of a unique equivalent circuit model that also accurately simulates the measured S-parameter. More particularly, parameter extraction methods for equivalent circuit models that simulate S-parameters are relatively well known. However, when the only goal is accurately fitting measuring S-parameters, an infinite number of solutions exist for possible equivalent circuit parameter values. Thus, in accordance with an important aspect of the present invention, only a single unique solution is extracted which accurately describes the physical charge control map of the device. This method for unique extraction of equivalent circuit model parameters acts as a lens for focus the charge control map solution. As discussed and illustrated herein, the lens 40 is subsequently simulated by a filter that is based on an apparent layout parasitic embedding model. As discussed below, the layout parasitic embedding model consists of linear elements which simulate the effect of the device's electrodes and interconnects upon its external electrical characteristics. A Pi FET embedding model 42, as described below. This model effectively acts as a filter to remove the electrical structure of the extrinsic parasitic access contribution to the preliminary charge control map solution. The resultant filtered charge control map solution represents a clearer “image”, which shows only the electrical structure of the intrinsic device. This enhanced imaging is needed in order to achieve as accurate a view of the internal electric charge/field as possible. Unlike conventional extraction techniques as illustrated in FIG. 10, which can only extract equivalent non-unique circuit models and not the unique charge control map, the S-parameter microscope 20 in accordance with the present invention is able to relatively accurately model the internal electric charge/field structure within a semiconductor device.

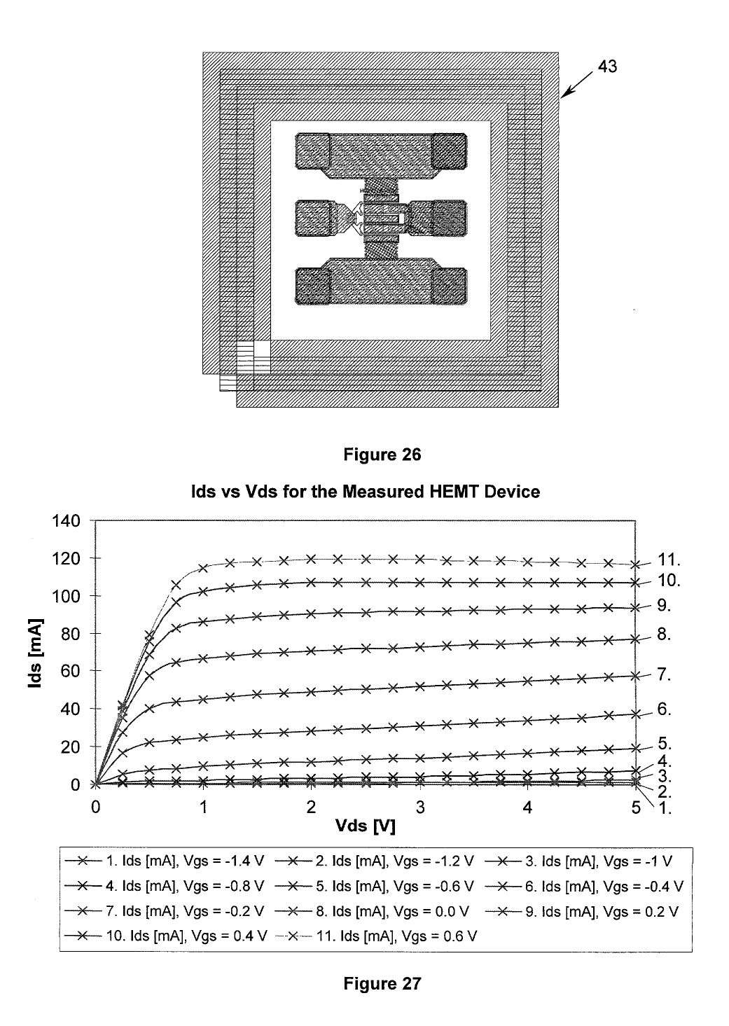

An exemplary application of the S-parameter microscope is illustrated in detail below. In this example, an exemplary GaAs HEMT device with four gate fingers and 200 μm total gate periphery formed in a Pi-FET layout as generally illustrated in FIG. 26 and identified with the reference numeral 43 is used. The GaAs HEMT 43 is adapted to be embedded in a 100-μm pitch coplanar test structure to facilitate on wafer S-parameter measurement.

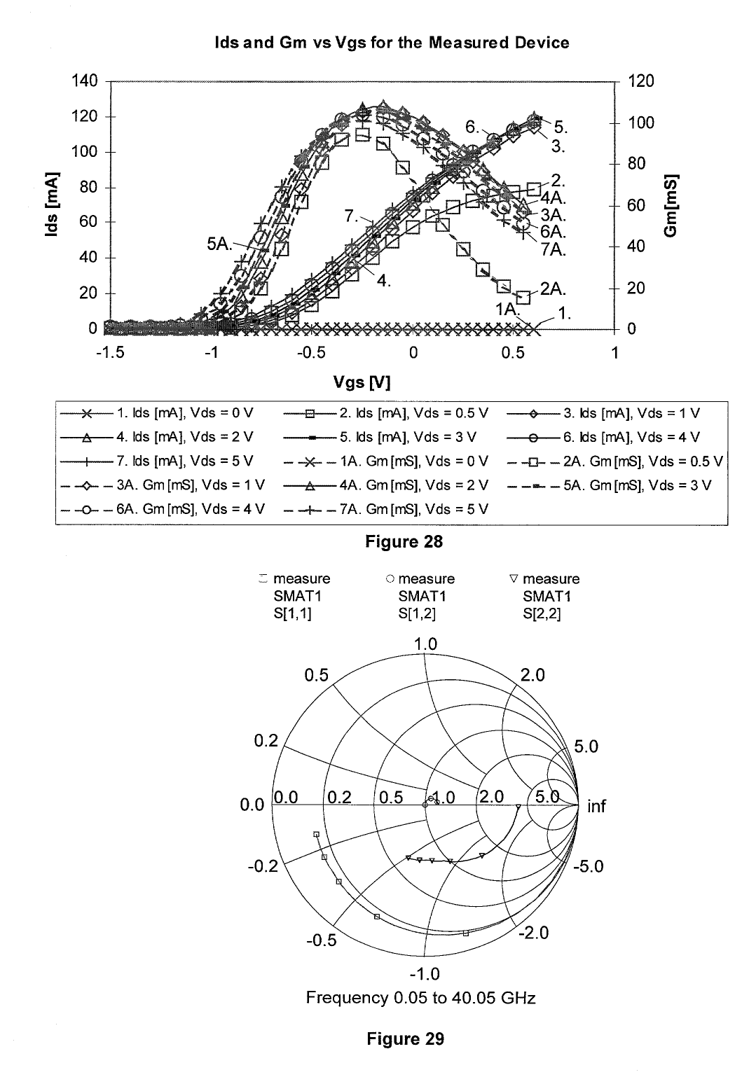

Initially, as illustrated in FIGS. 27 and 28, the I-V characteristics for the device are measured. In particular, the drain source current Ids is plotted as a function of drain-to-source voltage Vds at various gate voltages Vgs as shown in FIG. 27. FIG. 28 illustrates the drain-to-source current Ids as a function of gate voltage Vgs and transconductance Gm (i.e. the derivative of Ids with respect to Vgs) at different drain voltages Vds. These I-V characteristics are typical of HEMT devices and most semiconductor devices, which are one type of three-terminal semiconductor device technology.

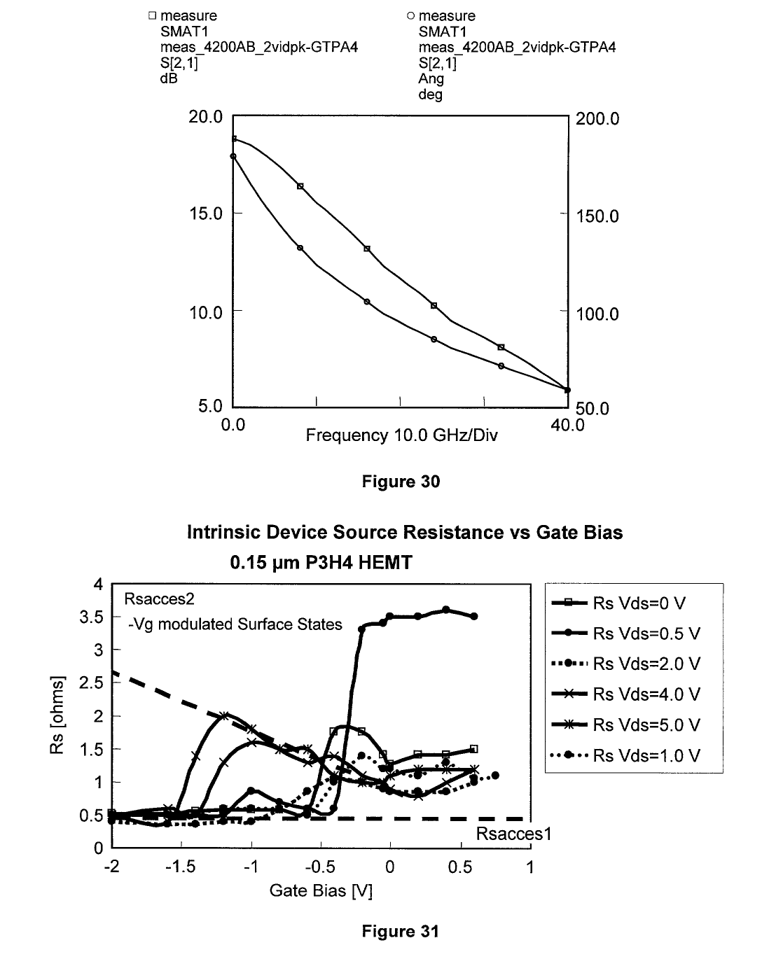

Table 8 shows the bias conditions in which S-parameters were measured. The S-parameters were measured from 0.05 to 40 GHz at each bias condition. FIG. 29 illustrates a Smith chart illustrating the measured S-parameters S11, S12 and S22 for frequencies from 0.05 to 40.0 GHz. FIG. 30 is a graphical illustration of magnitude as a function of angles for the measured S-parameter S21 for frequencies from 40.05 to 40.0 GHz.

TABLE 8
Measured S-parameter Bias Conditions

| Biases | Vds = | Vds = | Vds = | Vds = | Vds = | Vds = |
|---|---|---|---|---|---|---|
| Vgs | 0 V | 0.5 V | 1.0 V | 2.0 V | 4.0 V | 5.0 V |
| −1.6 V | Yes | Yes | Yes | Yes | Yes | Yes |
| −1.4 V | Yes | Yes | Yes | Yes | Yes | Yes |
| −1.2 V | Yes | Yes | Yes | Yes | Yes | Yes |
| −1 V | Yes | Yes | Yes | Yes | Yes | Yes |
| −0.8 V | Yes | Yes | Yes | Yes | Yes | Yes |
| −0.6 V | Yes | Yes | Yes | Yes | Yes | Yes |
| −0.4 V | Yes | Yes | Yes | Yes | Yes | Yes |
| −0.2 V | Yes | Yes | Yes | Yes | Yes | Yes |
| 0 V | Yes | Yes | Yes | Yes | Yes | Yes |
| 0.2 V | Yes | Yes | Yes | Yes | Yes | Yes |
| 0.4 V | Yes | Yes | Yes | Yes | Yes | Yes |
| 0.6 V | Yes | Yes | Yes | Yes | Yes | Yes |

Using the small signal model illustrated in FIG. 23, the extracted small signal equivalent circuit values are obtained as illustrated in Table 9 for each S-parameter at each bias condition, using the extraction method discussed below.

TABLE 9
Bias-dependent Small-signal Equivalent Circuit Models

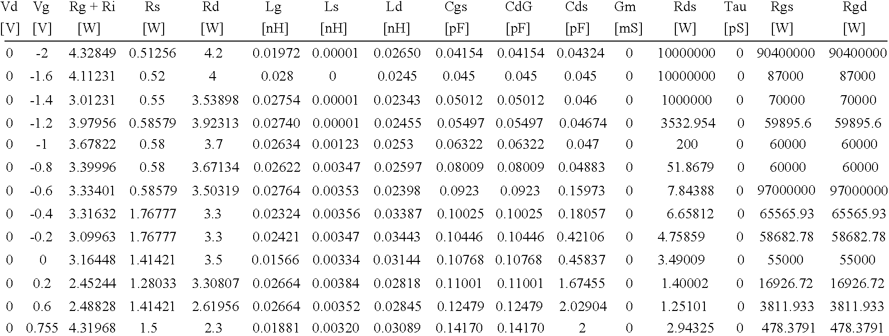

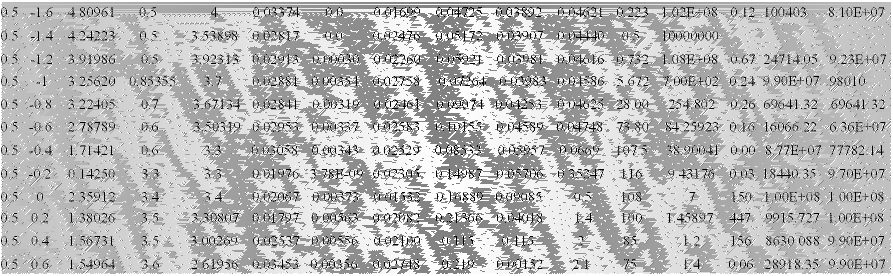

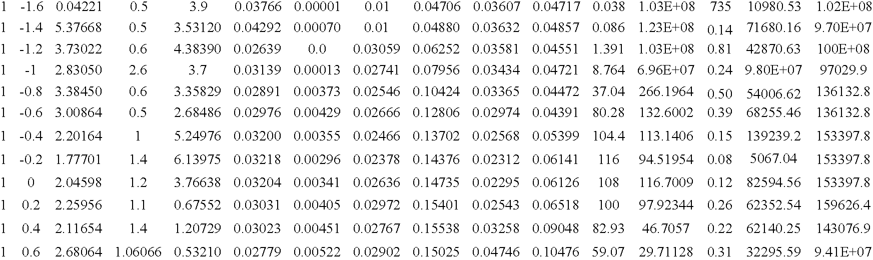

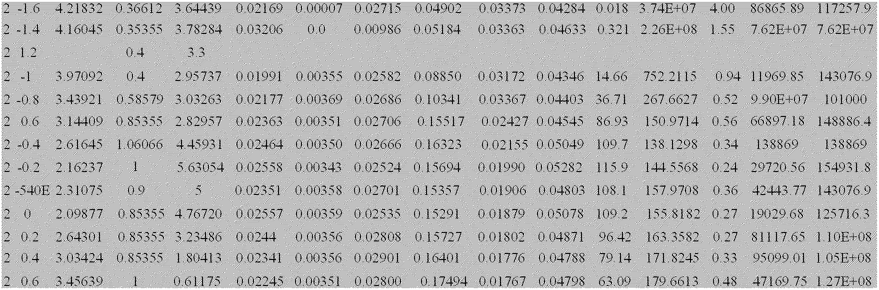

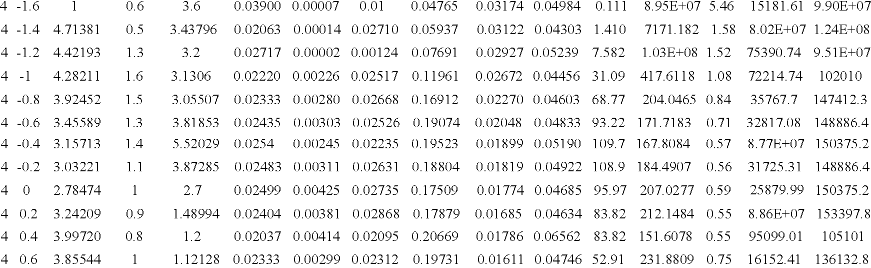

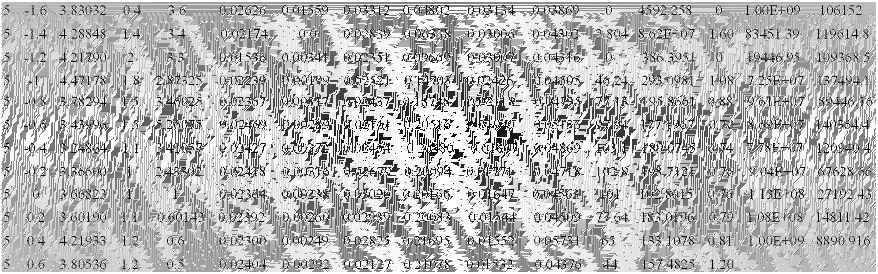

The values in Table 9 represent solutions that are close to the charge control map and represent physically significant solutions of the FET's electrical structure. However, the values represented in Table 9 contain the influence of external layout parasitics which are subtracted using a model for the embedding parasitics to obtain the most accurate charge control mapping to the intrinsic device characteristic. In particular, an embedding model is applied to filter the extracted equivalent circuit model values to obtain values more representative of the intrinsic device. In particular, in the exemplary embodiment, a PiFET embedding parasitic model is used to subtract capacitive contributions due to interelectrode and off-mesa layout parasitic influences. This filter essentially subtracts known quantities formed from the parameters Cgs, Cgd and Cds depending on the device layout involved. In this example, embedding of the inductive parameters is not necessary because these quantities are extrinsic and do not contribute to the charge control map of the intrinsic device.

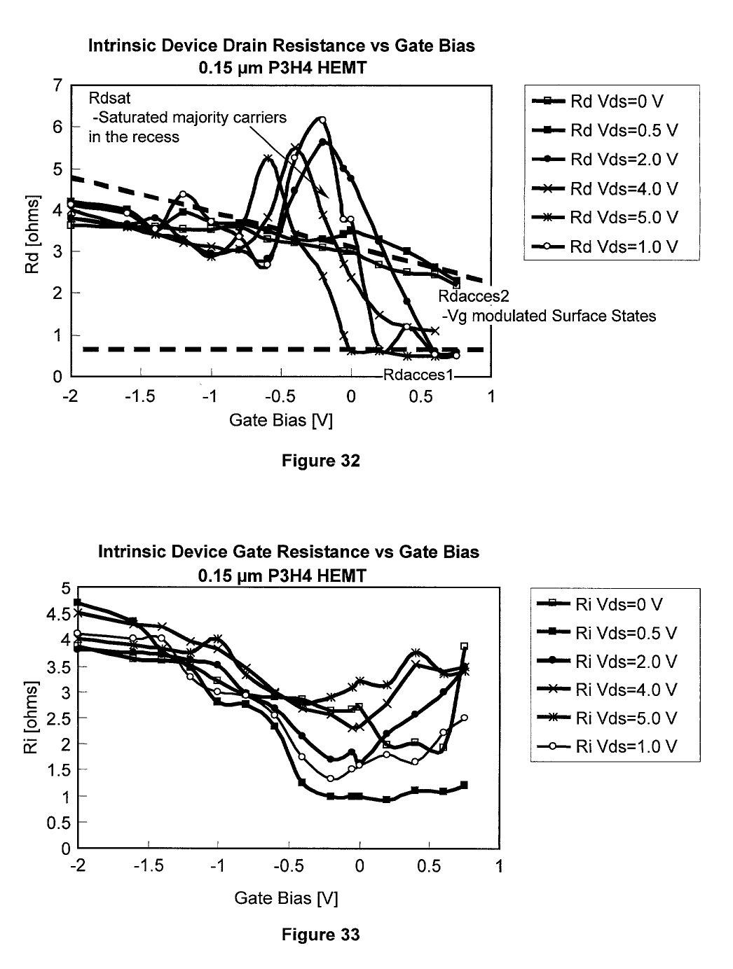

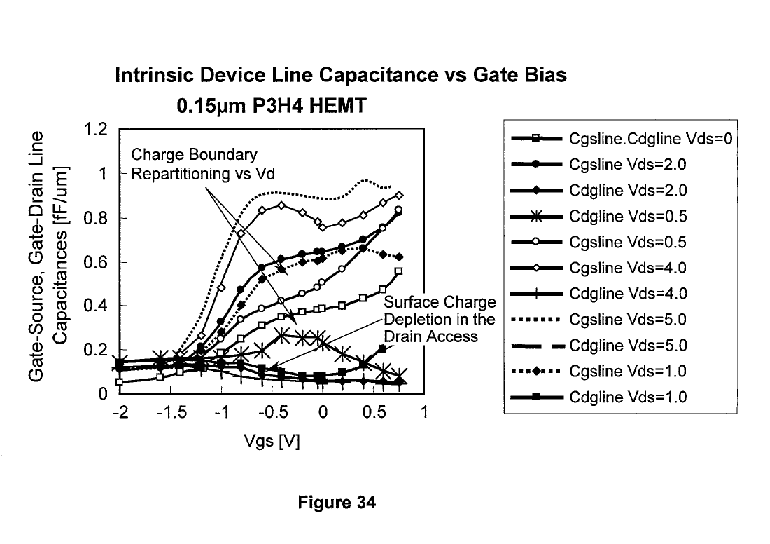

As discussed above, the lens with filter is used to generate unique charge control maps. In particular, FIGS. 31-34 illustrate the bias dependent charge control maps for the parameters RS, RD, RI, CGS and CGD as a function of bias. More particularly, FIG. 31 illustrates a charge control map of the charge and electric field distribution in the on-mesa source access region illustrated by the source resistance Rₛ as a function of bias. FIG. 32 illustrates a charge control map of the charge and electric field distribution in the on-mesa drain access region illustrated by the drain resistance R_{d} as a function of bias. FIG. 33 illustrates a charge control map for a non-quasistatic majority carrier transport illustrated by the intrinsic device charging resistance Rᵢ as a function of gate bias for different drain bias points. FIG. 34 illustrates a charge control map for gate modulated charge and distribution under the gate shown with the gate capacitance CGS and CGD as a function of bias.

### FILTER

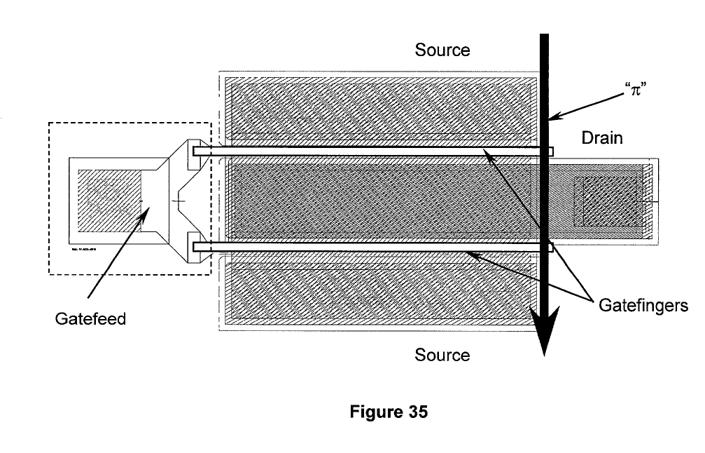

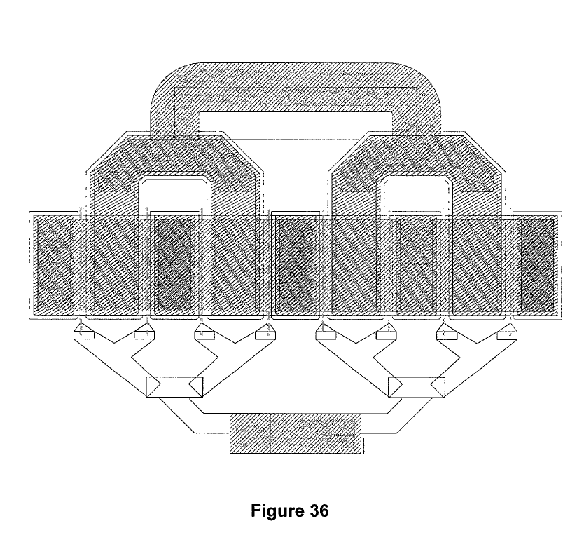

As mentioned above, the S-parameter microscope 20 utilizes a filter to provide a clearer charge control map for modeling the internal electric charge/field of a semiconductor device. Although the filter is illustrated in connection with the PiFET with multiple gate fingers, as illustrated in FIGS. 35 and 36, the principles of the invention are applicable to other semiconductor devices.

As illustrated in FIG. 35, PiFETs are devices in which the gate fingers and the edge of the active region resemble the greek letter π, as illustrated. Such PiFET layouts facilitate construction of multi fingered large periphery device cells, for example, as illustrated in FIG. 36. In accordance with an important aspect of the invention, the multi-finger semiconductor device is modeled as a combination of single finger device cells. Each single finger device cell is represented by a hierarchy of four models, which, in turn, are assembled together using models for interconnects to represent an arbitrary multifingered device cell, illustrated in FIG. 22. The four models are as follows: off mesa or boundary parasitic model; interelectrode parasitic model; on-mesa parasitic model and intrinsic model.

The off-mesa parasitic model is illustrated in FIG. 38. This model represents the parasitics that exist outside the active FET region for each gate finger. In this model, the fringing capacitance of each gate finger off the active device region as well as the off-mesa gate finger resistance is modeled.

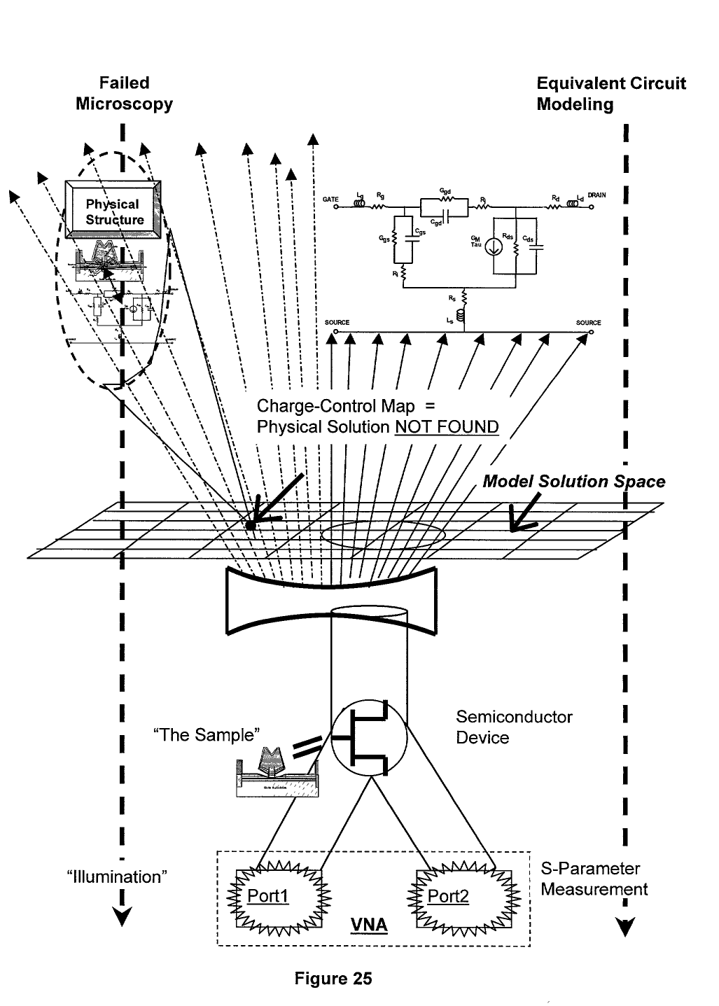

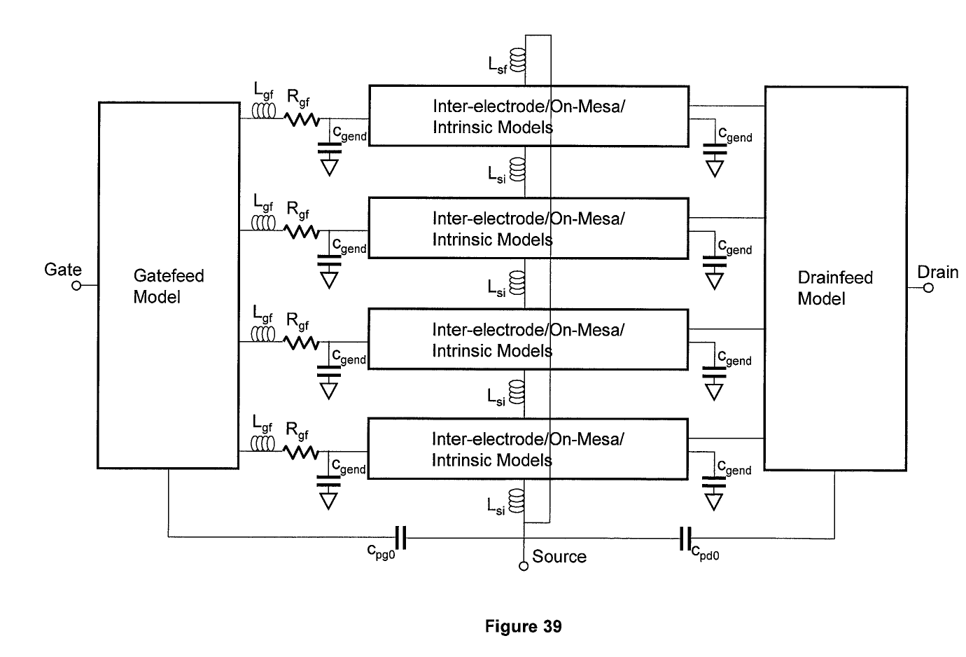

The interelectrode parasitic model and corresponding equivalent circuit are illustrated in FIGS. 39-41. This model represents parasitics between the metal electrodes along each gate finger. The following fringing capacitance parasitics are modeled for the gate-to-source air bridge; drain-to-source air bridge; gate-to-source ohmic; gate-to-drain ohmic and source-to-drain ohmic as generally illustrated in FIG. 25.

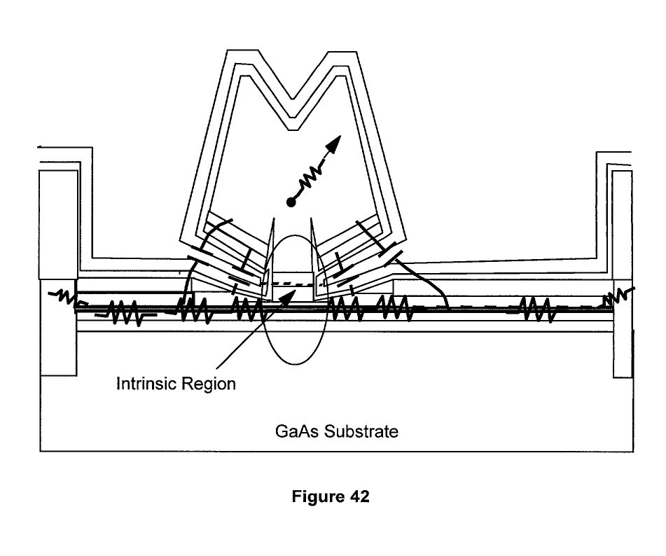

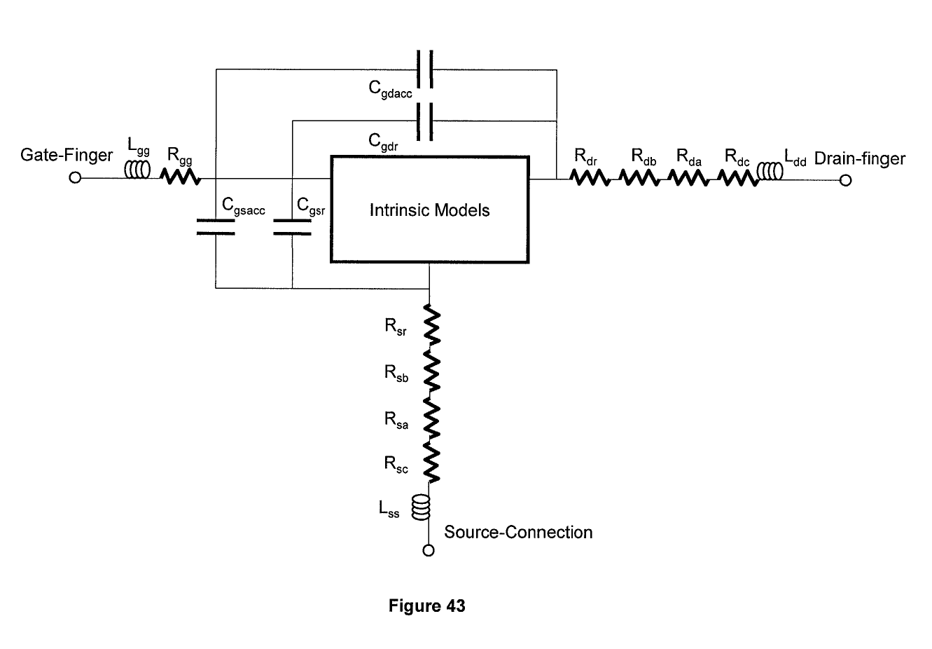

The on-mesa parasitic model and corresponding equivalent circuit are illustrated in FIGS. 42 and 43. This model represents that parasitics around the active FET region along each gate finger including various capacitance fringing parasitics and resistive parasitics. In particular, the gate-to-source side recess; gate-drain-side recess; gate-source access charge/doped cap; and gate-drain access charge/doped cap capacitance fringing parasitics are modeled. In addition, the gate metallization and ohmic contact resistive parasitics are modeled.

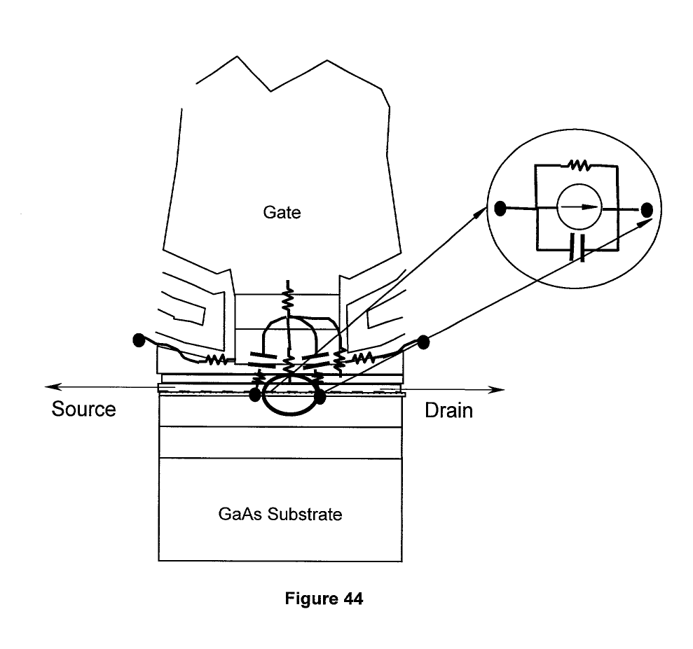

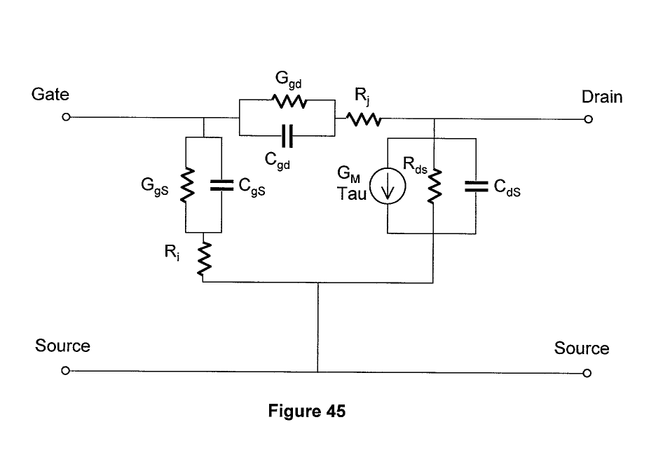

The intrinsic model and corresponding equivalent circuit are illustrated in FIGS. 44 and 45. The intrinsic model represents the physics that predominately determine the FET performance. In particular, the DC and current voltage response can be determined by physics based analytical equations for magnitude and location of intrinsic charge which are generally know in the art, for example, as disclosed in “Nonlinear Charge Control in AlGaAs/GaAs Modulator-Doped FETs”, by Hughes, et al, IEEE Trans. Electron Devices, Vol. ED-34, No.8, August 1987. The small signal model performance is modeled by taking a derivative of the appropriate charge or current control equations to derive various terms such as RI, RJ, RDS, RGS, RGD, GM, TAU, CGS, CDS and CGD. Such control equations are generally known in the art and disclosed in detail in the Hughes et al reference mentioned above, hereby incorporated by reference. The noise performance may be modeled by current or voltage perturbation analysis “Noise Characteristics of Gallium Arsenide Filed-Effect Transistors” by H. Statz, et al. IEEE-Trans. Electronic Devices, vol. ED-21, No. 9, September 1974 and “Gate Noise in Field Effect Transistors at moderately High Frequencies” by A. Van Der Ziel, Pro. IEEE, vol 51, March 1963.

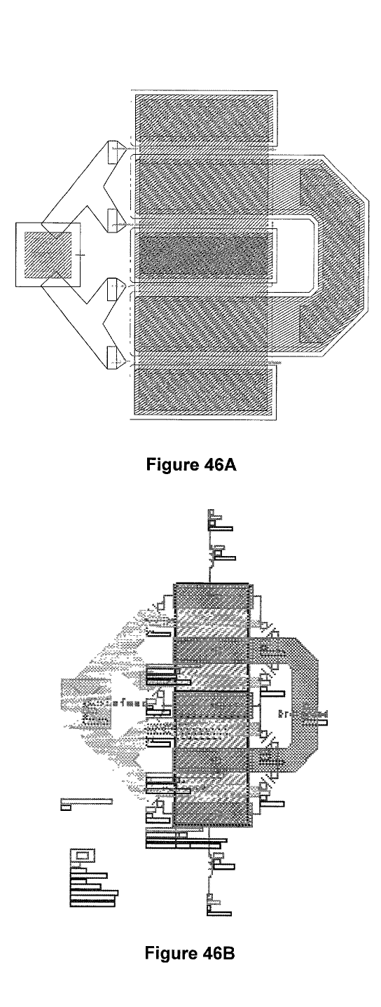

An example of a parasitic model for use with the S-parameter microscopy discussed above is illustrated in FIGS. 46A-53. Although a specific embodiment of a semiconductor device is illustrated and described, the principles of the present invention are applicable to various semiconductors device's. Referring to FIG. 46A, a Pi-FET is illustrated. As shown, the PiFET has four gate fingers. The four fingered Pi-FET is modeled in FIG. 46B. In particular, FIG. 46B illustrates an equivalent circuit model for Pi-FET illustrated in FIG. 46A as implemented by a known CAD program, for example, LIBRA 6.1 as manufactured by Agilent Technologies. As shown, the equivalent circuit models does not illustrate all of the equivalent circuit elements or network connections involved with implementing the parasitic embedding models, but rather demonstrates a finished product. The actual technical information regarding the construction of the network and its equivalent circuit elements are normally provided in schematic view.

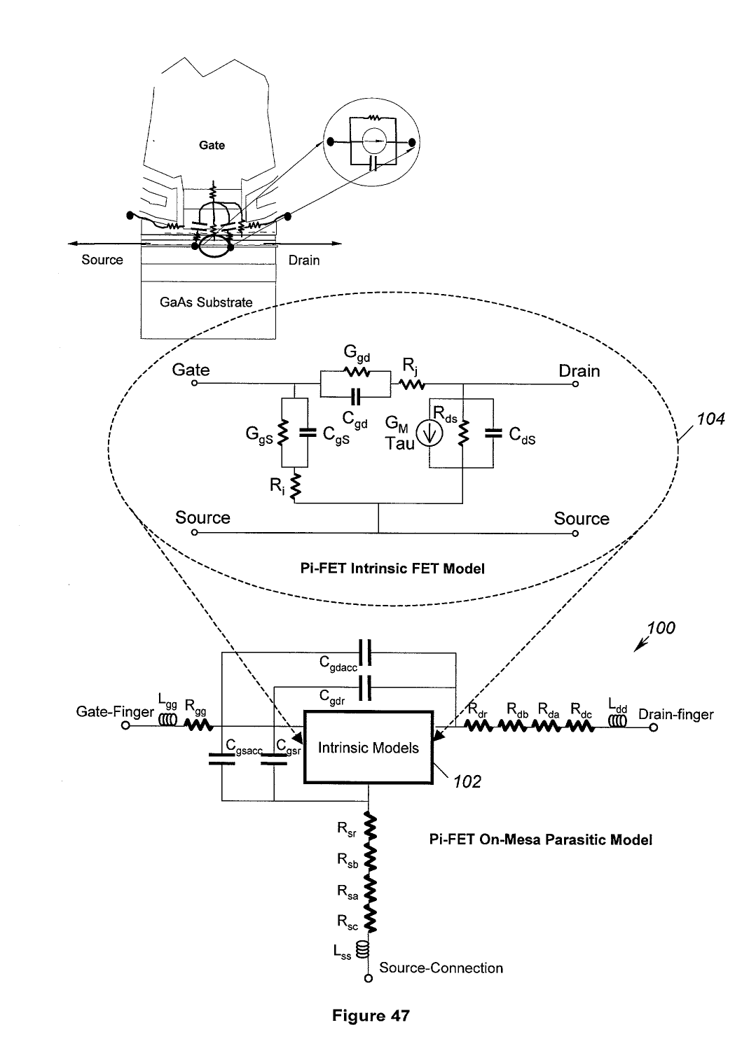

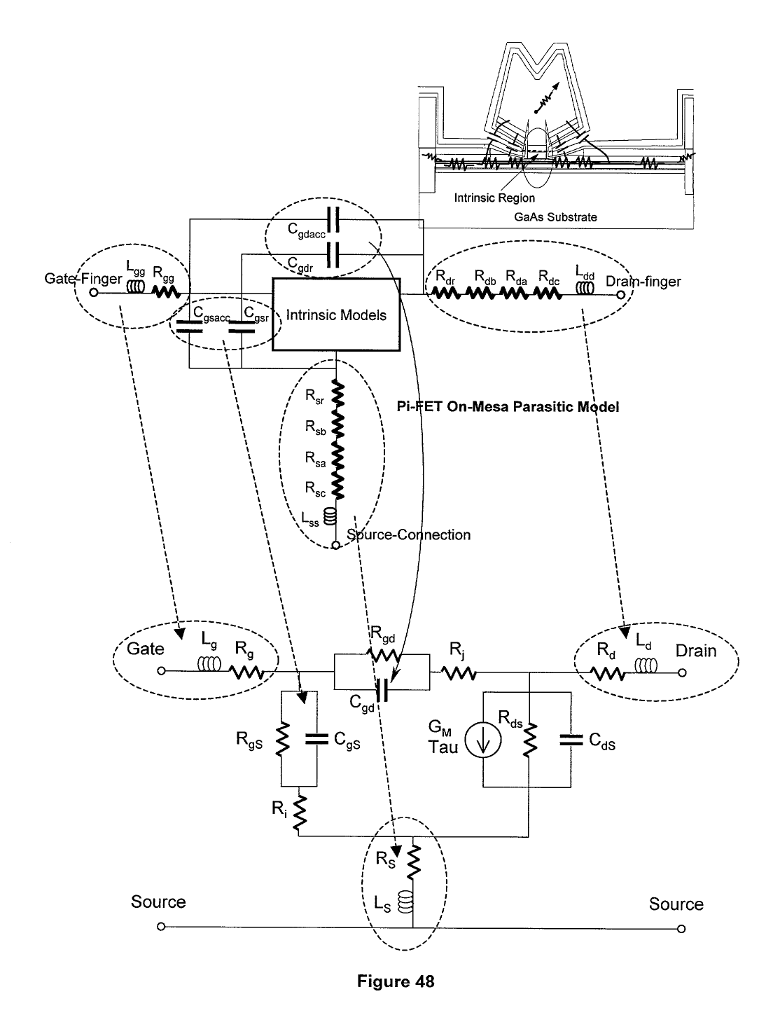

FIGS. 47-48 demonstrate the application of the parasitic model for use with the S-parameter microscopy. An important aspect of parasitic modeling relates to modeling of multi-gate fingered devices as single gate finger devices. As used herein, a single unit device cell refers to a device associated with a single gate finger. For example, a four fingered Pi-FET as illustrated in FIG. 46A is modeled as four unit device cells.

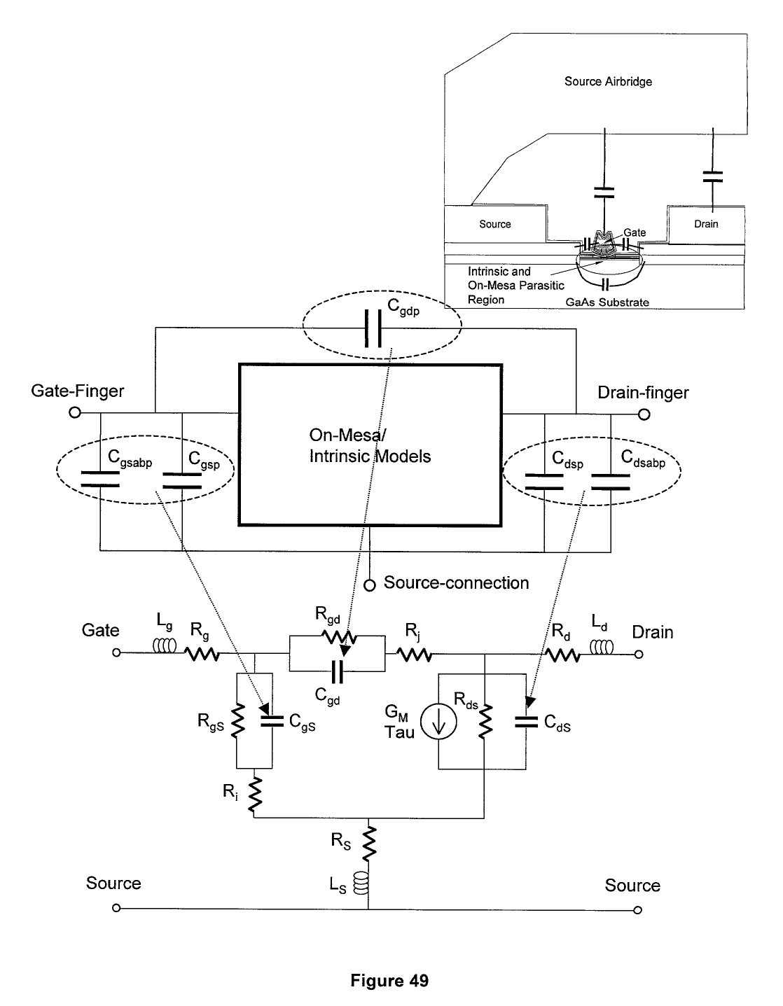

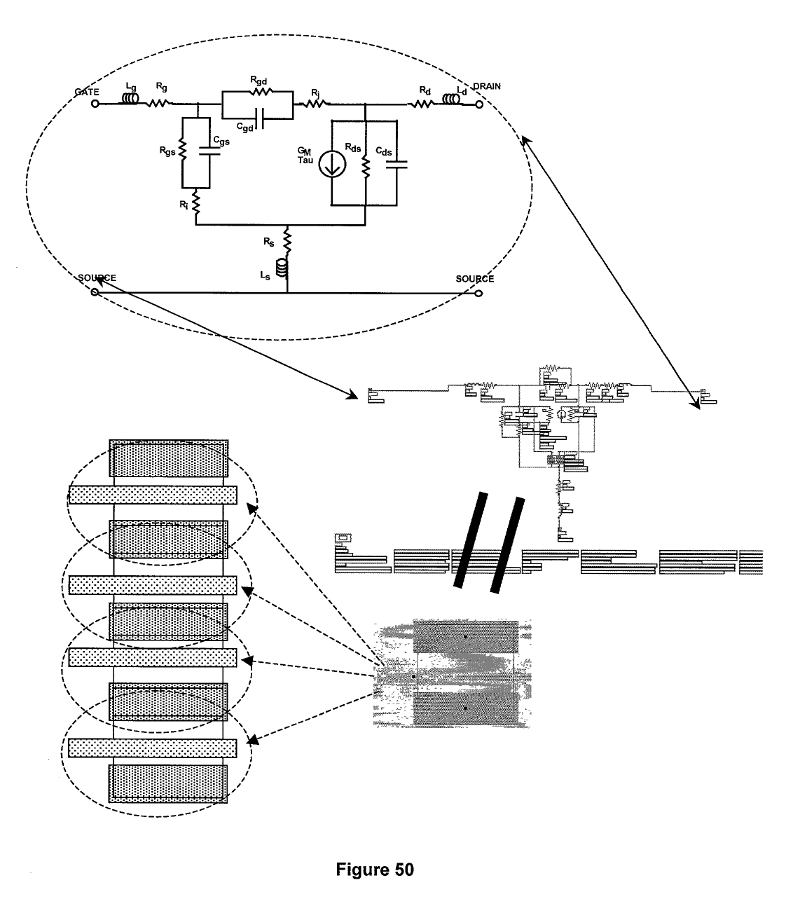

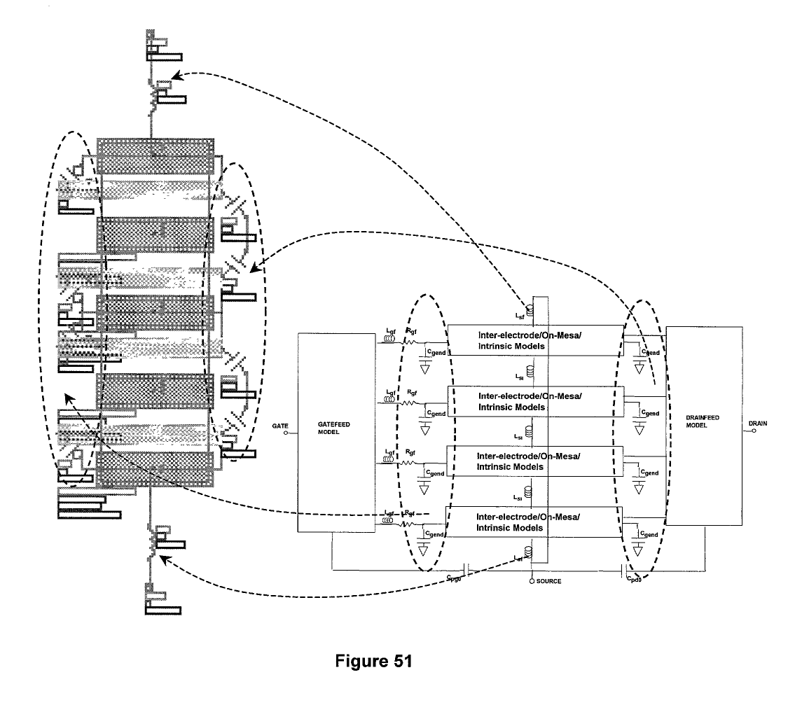

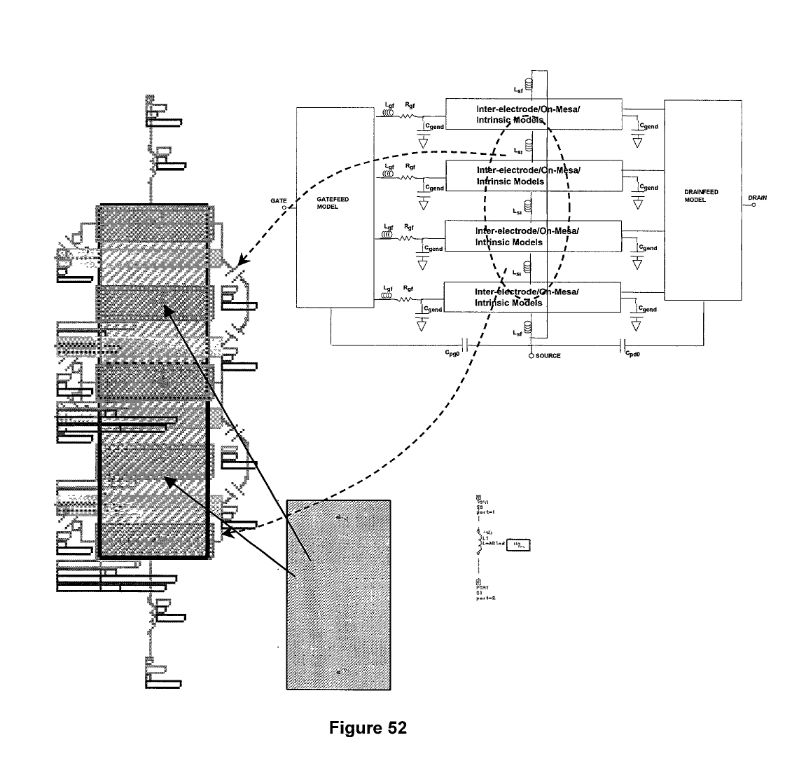

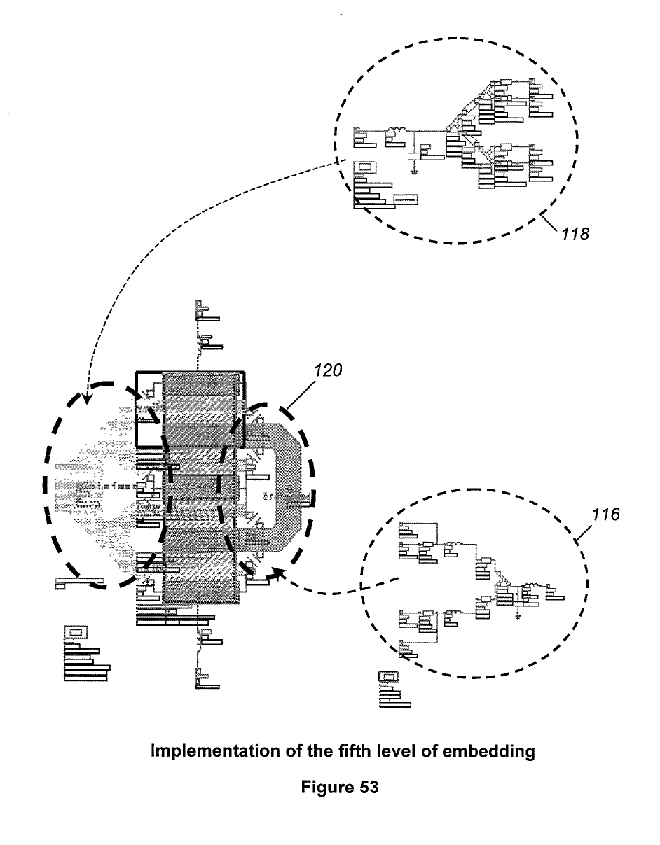

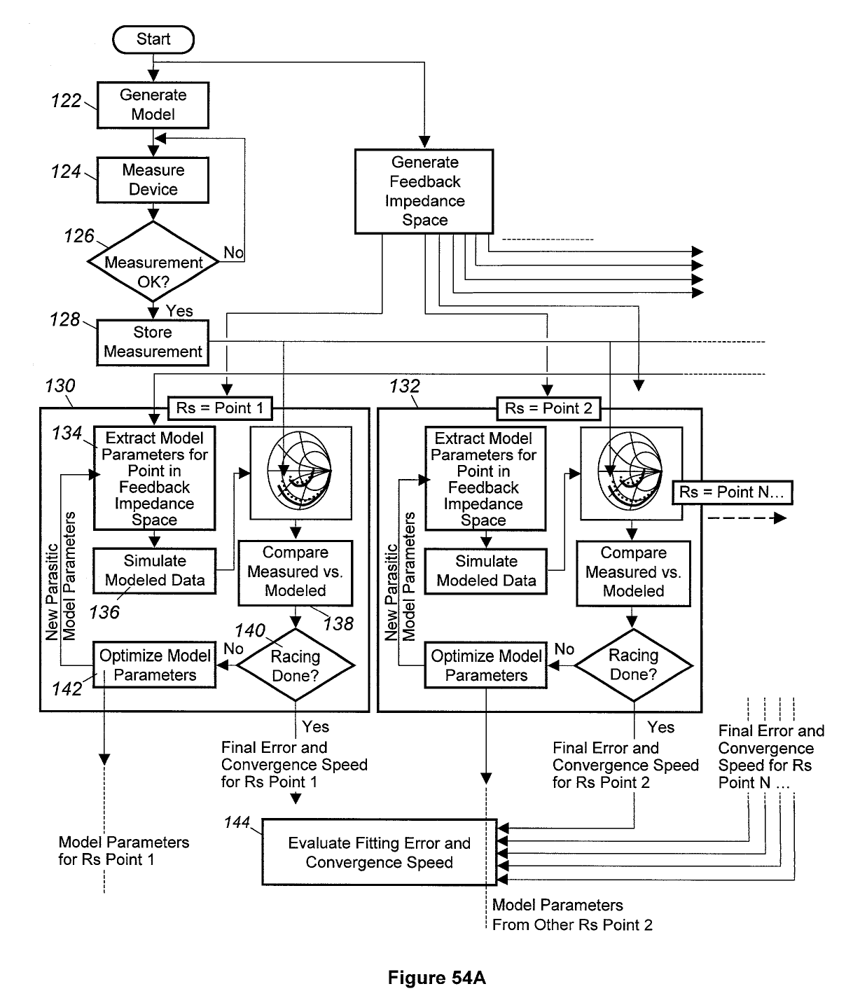

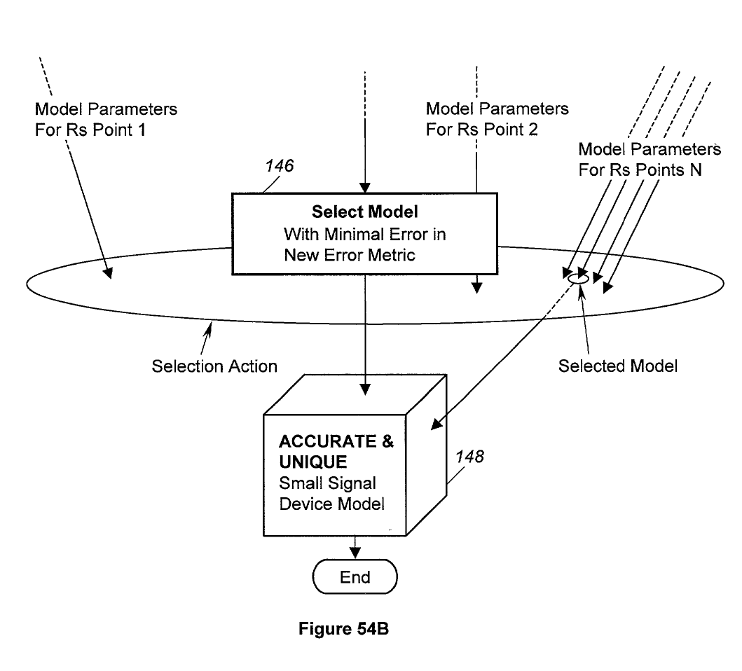

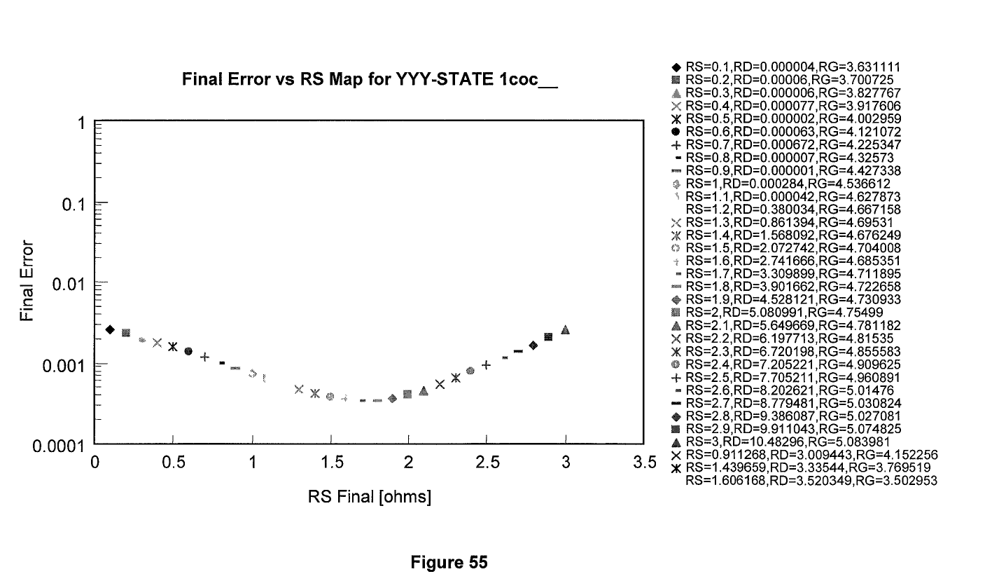

Initially, the four finger Pi-FET illustrated in FIG. 46A, is modeled as a single finger unit device cell 100 with an intrinsic model 102, as shown in FIGS. 47 and 48. In particular, the Pi-FET intrinsic FET model 104 is substituted for the block 102 defining a first level of embedding. As shown in FIG. 48, the parameter values for the Pi-FET intrinsic model are added together with the parameter values for the single fingered unit device cell intrinsic model. The intrinsic device model 104 may be developed by S-parameter microscopy as discussed above. Next, as illustrated in FIG. 49, the interconnect layout parasitic elements are added to the equivalent model by simply adding the model terms to the value of the appropriate circuit element to form a single unit device cell defining a second level of embedding. Once the single unit device cell is formulated, this device is used to construct models for multi-fingered devices. In this case, a Pi-FET with four gate fingers is modeled as four single finger device unit cells as shown in FIG. 50. Subsequently, the off-mesa layout parasitic elements are connected to the multi-fingered layout, defining a third level of embedding as illustrated in FIG. 51. These off-mesa layout parasitic elements, generally identified with the reference numerals 108 and 110, are implemented as new circuit elements connected at key outer nodes of the equivalent circuit structure. Subsequently, a fourth level of embedding is implemented as generally illustrated in FIG. 55. In particular, an inductor model is connected to the sources of each of the various unit device cells to represent the metallic bridge interconnection, as generally shown in FIG. 52. Lastly, as illustrated in FIG. 54, a fifth level of embedding is implemented in which the feed electrodes model 114 and 116 are modeled as lumped linear elements (i.e. capacitors inductors) as well as the distributive elements (i.e. microstrip lines and junctions) to form the gate feed and drain connections illustrated in FIG. 53. As shown, the distributive elements are distributed models for microstrip elements as implemented in LIBRA 6.1.

### EXTRACTION METHOD FOR UNIQUE DETERMINATION OF FET EQUIVALENT CIRCUIT MODELS

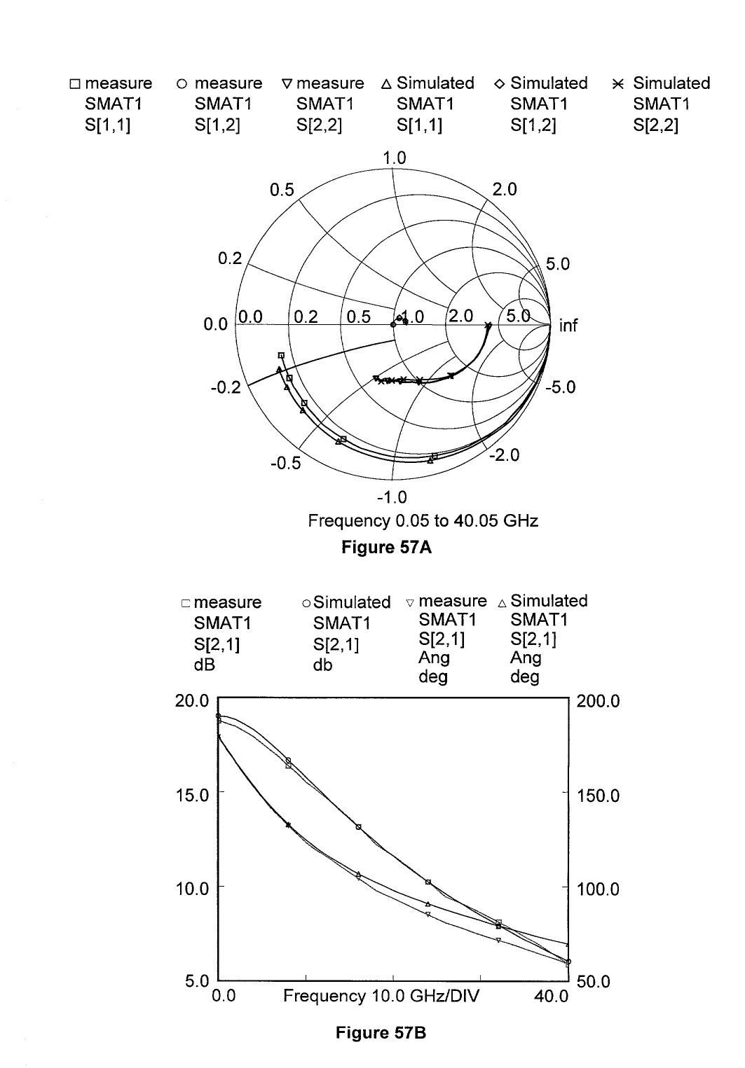

The method for determining FET equivalent circuit parameters as discussed above is illustrated in FIGS. 54-59. This method is based on an equivalent circuit model, such as the common source FET equivalent circuit model illustrated in FIG. 8. Referring to FIG. 54A, a model is initially generated in step 122. The model illustrated in FIG. 23 is used as a small signal model for the FET. In accordance with an important aspect of the algorithm, the equivalent circuit parameters are based upon measured FET S-parameters. Measurement of S-parameters of semiconductor devices is well known in the art. FIG. 57A is a Smith chart illustrating exemplary measured S-parameters S11, S12 and S22 for frequencies between 0.05 to 40 GHz. FIG. 42B represents a magnitude angle chart for the measured S-parameter S21 from frequencies from 0.05 to 40 GHz. After the S-parameters are measured, as set forth in step 124 (FIG. 54A), it is ascertained whether the measurements are suitable in step 126. This is either done by manually inspecting the test result for anomalies, or by algorithms to validate the test set. If the measurements are suitable, the S-parameter measurements are stored in step 128. A space of trial starting impedance point values, for example, as illustrated in Table 4 is chosen. Then, a direct model extraction algorithm, known as the Minasian algorithm, is used to generate preliminary values for the equivalent circuit model parameters, for each value of starting feedback impedance. Such extraction algorithms are well known in the art, for example, as disclosed “Broadband Determination of the FET Small Equivalent Small Signal Circuit” by M. Berroth, et al., IEEE-MTT, Vol. 38, No. 7, July 1990. Model parameter values are determined for each of the starting impedance point values illustrated in Table 4. In particular, referring to FIG. 54A, each impedance point in Table 4 is processed by the blocks 130, 132, etc. to develop model parameter values for each of the impedance point in order to develop an error metric, which, in turn, is used to develop a unique small signal device model, as will be discussed below. The processing in each of the blocks 130, 132 is similar. Thus, only a single block 130 will be discussed for an exemplary impedance point illustrated in Table 10. In this example, the feedback impedance point 17 which correlates to a source resistance Rₛ ohm of 1.7Ω and a source inductance Lₛ of 0.0045 pH is used.

TABLE 10
Trial Starting Feedback, Impedance Space Point Values

| Impedance | Resistance | Inductance |
|---|---|---|
| Point | (Rs) | (Ls) |
| 1 | 0.1 Ω | 0.0045 pH |
| 2 | 0.2 Ω | 0.0045 pH |
| 3 | 0.3 Ω | 0.0045 pH |
| 4 | 0.4 Ω | 0.0045 pH |
| 5 | 0.5 Ω | 0.0045 pH |
| 6 | 0.6 Ω | 0.0045 pH |
| 7 | 0.7 Ω | 0.0045 pH |
| 8 | 0.8 Ω | 0.0045 pH |
| 9 | 0.9 Ω | 0.0045 pH |
| 10 | 1.0 Ω | 0.0045 pH |
| 11 | 1.1 Ω | 0.0045 pH |
| 12 | 1.2 Ω | 0.0045 pH |
| 13 | 1.3 Ω | 0.0045 pH |
| 14 | 1.4 Ω | 0.0045 pH |
| 15 | 1.5 Ω | 0.0045 pH |
| 16 | 1.6 Ω | 0.0045 pH |
| 17 | 1.7 Ω | 0.0045 pH |
| 18 | 1.8 Ω | 0.0045 pH |
| 19 | 1.9 Ω | 0.0045 pH |
| 20 | 2.0 Ω | 0.0045 pH |
| 21 | 2.1 Ω | 0.0045 pH |
| 22 | 2.2 Ω | 0.0045 pH |
| 23 | 2.3 Ω | 0.0045 pH |
| 24 | 2.4 Ω | 0.0045 pH |
| 25 | 2.5 Ω | 0.0045 pH |
| 26 | 2.6 Ω | 0.0045 pH |
| 27 | 2.7 Ω | 0.0045 pH |
| 28 | 2.8 Ω | 0.0045 pH |
| 29 | 2.9 Ω | 0.0045 pH |
| 30 | 3.0 Ω | 0.0045 pH |

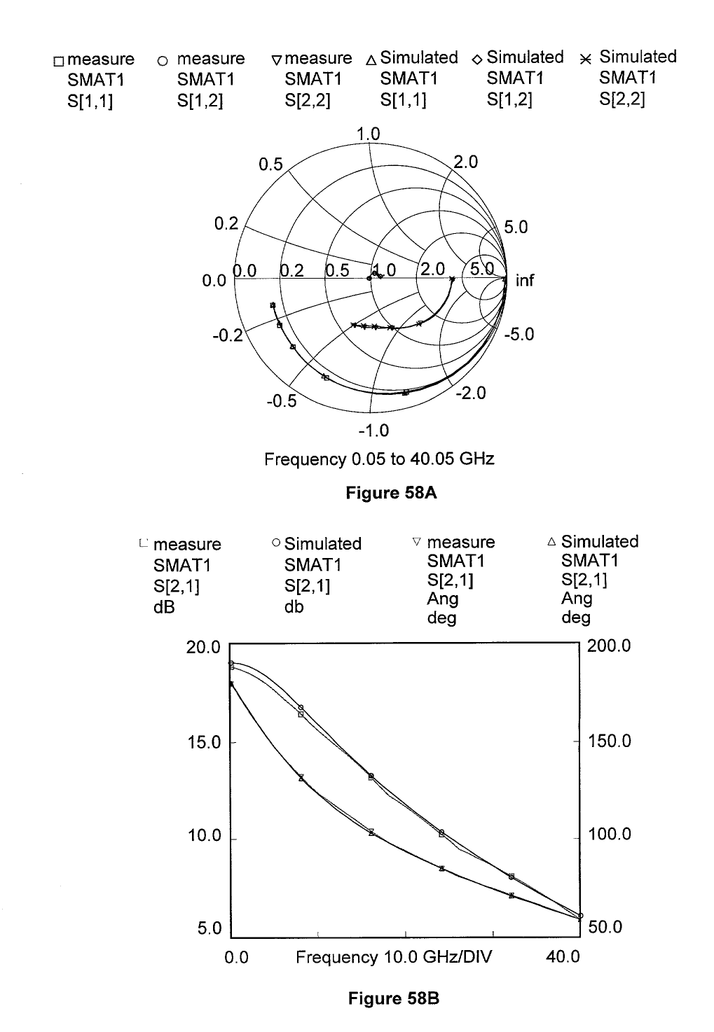

For the selected value, Rₛ=1.7 ohms, initial intrinsic equivalent circuit parameters and initial parasitic equivalent circuit parameter are determined, for example, by the Minasian algorithm discussed above and illustrated in Tables 11 and 12 as set forth in steps 134 and 136. In step 138 the simulated circuit parameters are compared with the measured S-parameters, for example, as illustrated in FIGS. 58A and 58B. Each of the processing blocks 130 and 132 etc. goes through a fixed number of complete cycles, in this example, six complete cycles. As such, the system determines in step 140 whether the six cycles are complete.

TABLE 11
Initial “Intrinsic” Equivalent Circuit Parameters

| | |
|---|---|
| Intrinsic Equivalent | |
| Circuit Parameter | Initial Solution |

| | | |
|---|---|---|
| Cgs | 0.23595 | pF |
| Rgs | 91826 | Ω |
| Cgd | 0.0177 | pF |
| Rgd | 100000 | Ω |
| Cds | 0.04045 | pF |
| Rds | 142.66 | Ω |
| Gm | 142.1025 | mS |
| Tau | 0.1 | pS |

TABLE 12
Initial “Parasitic” Equivalent Circuit Parameters

| | |
|---|---|
| Intrinsic Equivalent | |
| Circuit Parameter | Initial Solution |

| | | |
|---|---|---|
| Rg | 3.0 | Ω |
| Lg | 0.014 | nH |
| Rs | 1.7 | Ω |
| Ls | 0.0045 | nH |
| Rd | 2.5 | Ω |
| Ld | 0.024 | nH |

Each cycle of the processing block 130 consists of a direct extraction followed by an optimization with a fixed number of optimization iterations, for example 60. By fixing the number of extraction-optimization cycles along with the number of optimization iterations, a fixed “distance” or calculation time which the model solution must be derived is defined. As such, the algorithm implements a convergence speed requirement of the global error metric by setting up an environment where each trial model solution competes against each other by achieving the lowest fitting error over a fixed calculation time thus causing a “race” criteria to be implemented where “convergence speed” is implicitly calculated for each processing block 130, 132 etc. After the system determines whether the racing is done in step 140, the system proceeds to block 142 and optimizes model parameters. Various commercial software programs are available, for example, a commercially available, LIBRA 3.5 software as manufactured by HP-eesof may be used both for circuit simulation as well as optimizing functions. The optimization is performed in accordance with the restrictions set forth in Table 13 with the addition of fixing the feedback resistance Rₛ to a fixed value.

TABLE 13
Environment Used for Competitive Solution Strategy, as Implemented in
this Example

| Implementation Parameter | |
|---|---|
| Circuit Simulator and Optimizer | Libra 3.5 |
| Optimization Algorithm | Gradient |
| Optimization Error Metric | Mag and angle of |
| | S11,S21,S12,and S22 |
| | from 4 to 40 GHz |
| Number of Iterations | 60 |
| Number of Extraction/Optimization | 6 |
| Cycles | |

By fixing the value for Rₛ this segment of the algorithm confined to creating a trial model solution for only the trial feedback impendence point with which it started. Table 14 illustrates the optimized intrinsic equivalent parameter values using commercially available software, such as LIBRA 3.5. These values along with the optimized parasitic values, illustrated in Table 15, form the first optimized model solution for the first extraction-optimization cycle (i.e. one of six). The optimized model parameters are then fed back to the function block 134 and 136 (FIG. 54A) and used for a new initial model solution. These values are compared with the measured S-parameter value as illustrated in FIGS. 58A and 58B. The system repeats this cycle for six cycles in a similar fashion as discussed above. After the six extraction-optimization cycle, the final trial model solution for the trial impendence point 17 is complete along with its final fitting error to the measured data to form the new error metric 144. In accordance with an important aspect, the extraction-optimization algorithm makes the final optimization fitting error for each point implicitly carry information about both the measured to model fitting error and the speed of convergence. It does so by the fixed optimization time constraint which sets up a competitive race between the various trial model solutions.

TABLE 14
Optimized “Intrinsic” Equivalent Circuit Parameters

| Intrinsic Equivalent | | |
|---|---|---|
| Circuit Parameter | Initial Solution | |
| Cgs | 0.227785 | pF |
| Rgs | 65247 | Ω |
| Cgd | 0.017016 | pF |
| Rgd | 130820 | Ω |
| Cds | 0.047521 | pF |
| Rds | 160.18 | Ω |
| Gm | 135.74 | mS |
| Tau | 0.446 | pS |

TABLE 15
Optimized “Parasitic” Equivalent Circuit Parameters

| Intrinsic Equivalent | | |
|---|---|---|
| Circuit Parameter | Initial Solution | |
| Rg | 4.715 | Ω |
| Lg | 0.02903 | nH |
| Rs* | 1.7 | Ω |
| Ls | 0.002102 | nH |
| Rd | 3.2893 | Ω |
| Ld | 0.0317 | nH |

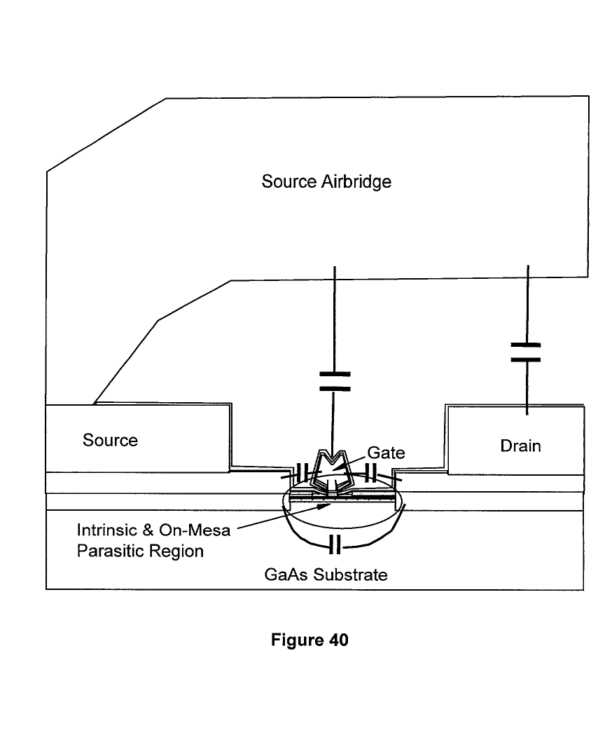

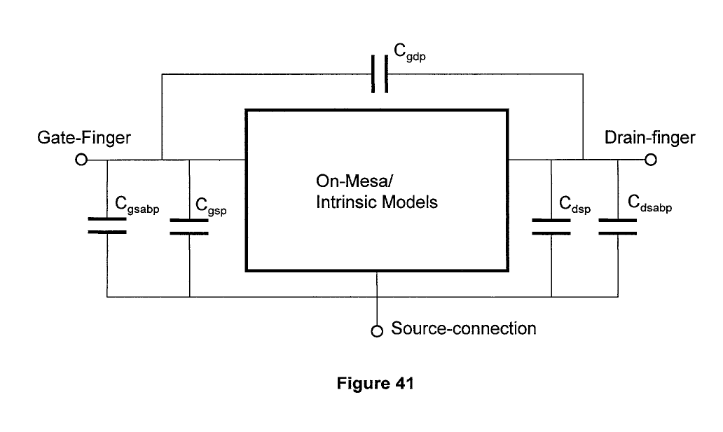

The implementation of the extraction optimization cycles makes the best and fastest solving solution appear as a global minima for the final fitting error in step 146 of all of the trial impedance points as generally shown in FIGS. 40 and 41. More specifically, referring to FIG. 58 the global minima solution using the new error metric is found around Rₛ=1.7 ohms. Tables 16 and 17 list the final model equivalent circuit parameters for this global solution, including the intrinsic and parasitic parameter as set forth in step 148 (FIG. 54B).

TABLE 16
Global Solution for “Intrinsic” Equivalent Circuit Parameters

| Intrinsic Equivalent Circuit | | |
|---|---|---|
| Parameter | Initial Solution | |
| Cgs | 0.227745 | pF |
| Rgs | 64242 | Ω |
| Cgd | 0.017019 | pF |
| Rgd | 133450 | Ω |
| Cds | 0.047544 | pF |
| Rds | 160.1791 | Ω |
| Gm | 135.7568 | mS |
| Tau | 0.443867 | pS |

TABLE 17
Global Solution “Parasitic” Equivalent Circuit Parameters

| Extrinsic Equivalent Circuit | | |
|---|---|---|
| Parameter | Initial Solution | |
| Rg | 4.711895 | Ω |
| Lg | 0.029314 | nH |
| Rs | 1.7 | Ω |
| Ls | 0.002104 | nH |
| Rd | 3.309899 | Ω |
| Ld | 0.031671 | nH |

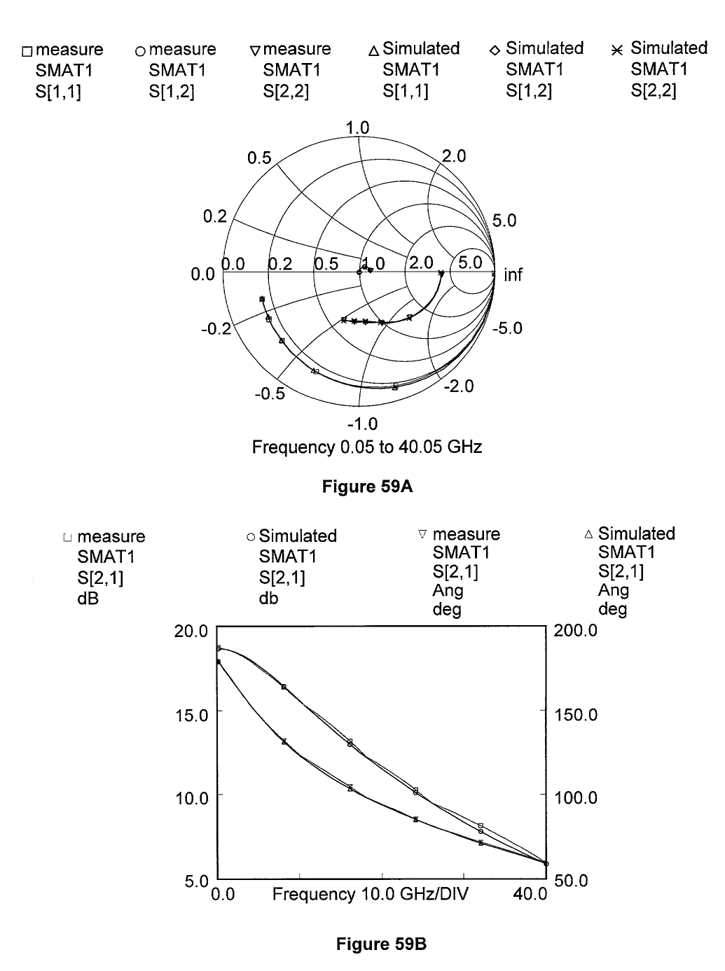

In order to test the accuracy of the solution, the final model for solutions are compared with the measured S-parameter values as shown in FIGS. 59A and 59B. As shown, there is good correlation between the simulated model values and the measured S-parameters values thus verifying that the simulated model values represent a relatively accurate and unique small signal device model.

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters Patent is as follows:

I claim:

1. A method for modeling semiconductor characteristics comprising the steps of:
a) forming a semi-physical model of a semiconductor which includes small signal and noise equivalent model elements.
b) modeling the noise characteristics of the semiconductor to obtain the noise equivalent model elements.

2. The method as recited in claim 1, wherein step (a) includes the step of deriving the model elements by way of small signal excitation analysis.

3. The method as recited in claim 1, wherein step (b) includes the step of deriving the noise equivalent model elements by way of a current/voltage perturbation analysis.

4. The method as recited in claim 1, wherein said semiconductor is a high electron mobility transistor (HEMT) and said semi-physical model is developed by incorporating one or more process parameters.

5. The method as recited in claim 4, wherein said semi-physical model is developed by incorporating one or more of the following: gate length recess itch depth, recess undercut dimensions and passivation nitrite thickness.

6. The method recited in claim 2, wherein step (b) includes the step of deriving the model elements by way of a small signal excitation analysis of the intrinsic charge of the device.

7. The method as recited in claim 6, wherein step (b) further includes the step of deriving the model elements by way of a small signal excitation analysis of the electric charge of the device.

8. The method as recited in claim 1, wherein step (a) includes the step (c): applying a current/voltage perturbation analysis to an analytically modeled intrinsic charge and conduction model in the linear conducting region of the device channel (region 1).

9. The method as recited in claim 8, wherein step (c) includes the following steps:
(1a) applying a current perturbation analysis to the current-control expression for drain current in Region 1; (1b) a relationship governing the magnitude of potential fluctuation as a function for position within Region 1, and magnitude of the current perturbation; (1c) applying a constraint forcing expression above to be consistent with voltage fluctuation boundary conditions at the boundary of Region 1 and the saturated electron transport region of the FET's channel (Region 2); (1d) solving for the final voltage fluctuation expression at the end of Region 1; finding the final RMS expression for noise voltage generation seen at the drain termination, after amplification factors of Region 2 are applied to 1d.

10. The method as recited in claim 9, wherein step (c) further includes the step (d) applying a current/voltage perturbation analysis to derive the noise voltage at the drain due to dipole generation within the saturated region (Region 2).

11. The method as recited in claim 10, wherein step (d) includes the following steps:
(2a) finding an expression for the potential and field of a dipole layer at any pint Region 2; (2b) matching potential and field boundary conditions at the beginning of Region 2 to yield a more exact expression for potential perturbation as a function of position in Region 2; (2c) incorporating non-quasistactic nature of the dipole drift by substituting in saturated drift velocity with time-dependence of the induced potential perturbation; (2d) calculating spectral density of the induces noise voltage by taking the Fourier transform of the expression in 1c; (2e) form iv find the final RMS expression for noise voltage generation seen at the drain terminal, after multiplying by two (for positive and negative current induced by the dipole) and integrating over Region 2.

12. The method as recited in claim 10, wherein step (c) further includes step (e): applying a current/voltage perturbation analysis to derive the noise current generated on the gate due to capacitive coupling with the channel.

13. The method as recited in claim 12, wherein step (e) includes the steps: (3a) finding an expression for induced charge in Region 1 from 1b above; (3b) adding the induced non-quasistatic charge in Region 2, which is equal to the magnitude of the total drain current fluctuation multipled by Region 2's length divided by saturated velocity; (3c) taking the mean square of the charge fluctuation given ιι; (3d) finding the total means square on the gate by integrating ιιι over Region 1; and (3e) finding the total gate noise by multiplying iv by ω², where ω=2πf and f=frequency.

14. The method as recited in claim 12, wherein step (c) further includes step (f): calculating the correlation coefficient.

15. The method as recited in claim 14, wherein step (f) includes the steps:
(4a) multiplying 3b with a conjugate of 1b expressed for current perturbation, to obtain Δq*i_{d}; (4b) multiplying 4a by ω to obtain i_{g}*i_{d}; (4c) finding the time average of 4b; (4d) finding correlation coefficient per standard definition, applying 4c, 3e and sum of 1e and 2e in noise current form.
